(19) United States
(12) Patent Application Publication
(10) Pub. No.: US 2004/0115573 A1
(43) Pub. Date: Jun. 17, 2004

(54) Photothermographic material

(76) Inventor: Kouta Fukui, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/730,143

(22) Filed: Dec. 9, 2003

(30) Foreign Application Priority Data
Dec. 13, 2002 (JP) 2002-361907
Dec. 13, 2002 (JP) 2002-361908

(51) Int. Cl. G03C 1/498

(52) U.S. Cl. 430/619; 430/363; 430/567; 430/568; 430/607; 430/965

(57) ABSTRACT

A photothermographic material containing a photosensitive silver halide, a non-photosensitive organic silver salt, a reducing agent, and a binder on at least one surface of a support, wherein silver iodide is contained in the photosensitive silver halide in an amount of 40% to 100% by mole, and the reducing agent contains a compound represented by the following formula (R-1).

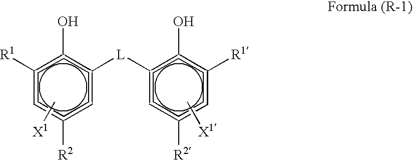

### CROSS-REFERENCE TO RELATED APPLICATION

This application claims priority under 35USC 119 from Japanese Patent Application Nos. 2002-361907 and 2002-361908, the disclosures of which are incorporated by reference herein.

### BACKGROUND OF THE INVENTION

1. Field of the Invention

The present invention relates to a photothermographic material. Especially, the invention relates to a photothermographic material suited for medical diagnosis applications.

2. Description of the Related Art

In recent years, in the field of films for medical diagnosis or the field of films for photomechanical process, it has been desired to reduce the quantity of treated waste liquids from the viewpoints of environmental protection and economy of space. Further, technologies regarding films for medical diagnosis and films for photomechanical processes that can be effectively exposed by a laser imagesetter or a laser imager and can form clear black images having high resolution and sharpness are required. Photothermographic materials meet these requirements as they do not need solution based treating chemicals and can provide customers with a simple heat development processing system without damaging the environment.

With respect to the thermal image forming system utilizing organic silver salts, dry silver type photothermographic materials are generally known (see, for example, U.S. Pat. Nos. 3,152,904 and 3,457,075 and D. Klosterboer, “Thermally Processed Silver Systems”, “Imaging Processes and Materials”, Neblette's 8th Ed., Chapter 9, page 279 (1989), edited by J. Sturge, V. Walworth, and A. Shepp).

In general, dry silver type photothermographic materials have a photosensitive layer in which a catalytic amount of a photocatalyst (such as silver halides), a reducing agent, a reducible silver salt (such as organic silver salts), and optionally, a color toning agent for controlling the color tone of silver are dispersed in a matrix of binder. After imagewise exposure, the photothermographic material is heated at high temperatures (for example, 80° C. or higher) and forms a black silver image upon redox reaction between the reducible silver salt (functioning as an oxidizing agent) and the reducing agent. The redox reaction is promoted by a catalytic action of latent image of a silver halide generated upon exposure. For that reason, the black silver image is formed in an exposed region.

In the field of general image forming materials, there are also similar material requirements. Especially, since images for medical diagnosis require fine depiction, it is important to have characteristics such excellent sharpness and graininess; it is further desirable to have an image color tone of high quality and cold black tone and that image gradation thereof is proper for the sake of enhancing diagnostic precision. In general, the image gradation is expressed by gamma as a gradient in the characteristic curve (plotting a logarithm of exposure amount and a density). In this application, the gamma is described by a gradient between optical densities of 2.0 and 0.25 expressed according to the following equation:

Gamma=[(optical density of 2.0)−(optical density of 0.25)]/{logarithm [(fog density)+(exposure amount giving an optical density of 2.0)]−logarithm [(fog density)+(exposure amount giving an optical density of 0.25)]}

As images for medical diagnosis, the gamma is preferably from 2 to 5, and especially preferably 2 to 4. If the gamma is too small, the image becomes unclear, whereas if it is too large, fine signals are lost. Accordingly, in any of these cases, the diagnostic precision is lowered.

Also, as compared with conventional silver halide photosensitive materials using processing liquids, dry silver type photothermographic materials are inferior in image storability of a sample after processing, and especially inferior in stability to light, and hence, improvements are required. As measures for improving the stability to light, a method utilizing silver iodide formed by conversion of an organic silver halide is disclosed. However, such a method was not practical because of low sensitivity (see, for example, U.S. Pat. No. 6,143,488, EP-A No. 0922995, and JP-A No. 2001-100356). Also, it is known that an organic polyhalogen compound is used as an antifoggant or an image stabilizer in the foregoing general photothermographic materials. However, in the case of using silver iodide emulsions, a sufficient amount of the polyhalogen compound could not be used because of low sensitivity.

For example, JP-A No. 8-297345 discloses photothermographic materials using a photosensitive silver halide having silver iodide content of from 6% by mole to 36% by mole. Photothermographic materials, the infrared light sensitivity of which is enhanced by infrared light sensitization, are disclosed.

In recent years, image forming systems in which image information is digitized, stored, optionally subjected to image processing, transmitted through a network, and laser outputted to photosensitive materials in a needed location are required especially in the medical field.

As laser light sources, coherent lights such as argon, helium-neon, and helium-cadmium are used. Recently, proliferation of semiconductor lasers is widespread. However, all of such laser tubes are short in life and often require an exclusive driver of high-voltage power source and hence, have a defect such that the size becomes inevitably large. For semiconductor lasers, there was a problem such that, until recently, the emitting wavelength was a long wavelength of 650 nm or more; silver halide photographic materials having sensitivity in such a region are unstable with respect to a spectral sensitizing dye, are inferior in storage stability, and likely cause fogging or desensitization during the storage. Now, modules having an SHG (Second Harmonic Generator) element and a semiconductor laser integrated with each other and blue semiconductor lasers have been developed, and laser outputting units of a short wavelength region are available. Blue semiconductor lasers result in image recording with high definition, are increased with respect to recording density, have a long life, and can obtain stable outputs, and therefore, expansion of their availability is expected in the future. Accordingly, high-speed photothermographic laser optical recording materials corresponding to blue lasers are demanded. For example, JP-A No. 2000-305213 discloses photothermographic materials. However, these materials are low in sensitivity so that they cannot satisfy the imaging requirements. Also, the photothermographic materials disclosed in the above-cited JP-A No. 8-297345 are quite low in sensitivity to blue laser exposure so that they are not useful for such imaging applications.

### SUMMARY OF THE INVENTION

An object of the present invention is to solve the foregoing problems of the related-art technologies. More specifically, the problem to be solved by the invention is to provide a photothermographic material to be used for medical images, etc., from which an optimum gradation to the diagnosis and a preferable color tone are obtained and whose image storability is improved. Especially, the problem to be solved by the invention is to provide a high-speed photothermographic material suited for exposure with blue laser light.

The foregoing object of the present inventor has been attained by the following photothermographic material of the invention.

A first aspect of the invention is to provide a photothermographic material comprising a photosensitive silver halide, a non-photosensitive organic silver salt, a reducing agent, and a binder on at least one surface of a support, wherein silver iodide is contained in the photosensitive silver halide in an amount of 40% to 100% by mole, and the reducing agent contains a compound represented by the following formula (R-1).

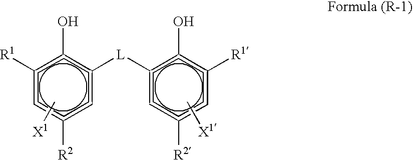

In formula (R-1), R¹ and R^{1′} each independently represent an alkyl group having 3 to 20 carbon atoms, in which the carbon atom bonding to the benzene ring is secondary or tertiary; R² and R^{2′} each represent a methyl group; L represents an —S— group or a —CHR³— group, in which R³ represents a hydrogen atom or an alkyl group having 1 to 20 carbon atoms; and X¹ and X^{1′} each independently represent a hydrogen atom or a group capable of being substituted on the benzene ring.

A second aspect of the invention is to provide a photothermographic material comprising at least one photosensitive silver halide, a non-photosensitive organic silver salt, a reducing agent, and a binder on a surface of a support, wherein silver iodide is contained in the photosensitive silver halide in an amount of 40% to 100% by mole, the reducing agent contains a compound represented by the following formula (R-4), and a compound represented by the following formula (H) is contained in the photothermographic material with a molar ratio of the compound represented by formula (H) to the compound represented by formula (R-4) being 0.2 or greater.

Q-(Y)ₙ—C(Z₁)(Z₂)X Formula (H)

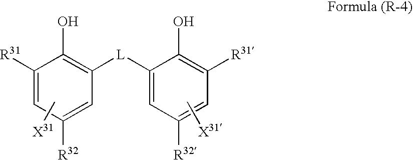

In formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group.

In formula (R-4), R³¹ and R^{31′} each independently represent an alkyl group having 1 to 20 carbon atoms; R³² and R^{32′} each independently represent an alkyl group having 2 to 20 carbon atoms; L represents an —S— group or a —CHR³³— group, in which R³³ represents a hydrogen atom or an alkyl group having 1 to 20 carbon atoms; and X³¹ and X^{31′} each independently represent a hydrogen atom or a group capable of being substituted on the benzene ring.

A third aspect of the invention is to provide a photothermographic material comprising at least one photosensitive silver halide, a non-photosensitive organic silver salt, a reducing agent, and a binder on a surface of a support, wherein silver iodide is contained in the photosensitive silver halide in an amount of 40% to 100% by mole, the reducing agent contains a compound represented by the following formula (R-5), and a compound represented by the following formula (H) is contained in the photothermographic material with a molar ratio of the compound represented by the formula (H) to the compound represented by the formula (R-5) being 0.15 or greater.

Q-(Y)ₙ—C(Z₁)(Z₂)X Formula (H)

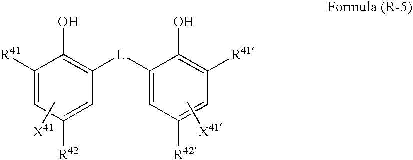

In the formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group.

In the formula (R-5), R⁴¹ and R^{41′} each independently represent a methyl group or an alkyl group having 2 to 20 carbon atoms, in which a carbon atom bonding to the benzene ring is primary; R⁴² and R^{42′} each independently represent a hydrogen atom or a group capable of being substituted on the benzene ring; L represents an —S— group or a —CHR⁴³-group, in which R⁴³ represents a hydrogen atom or an alkyl group having 1 to 20 carbon atoms; and X⁴¹ and X^{41′} each independently represent a hydrogen atom or a group capable of being substituted on the benzene ring.

### DETAILED DESCRIPTION OF THE INVENTION

The present invention is concerned with a photothermographic material comprising at least one photosensitive silver halide, a non-photosensitive organic silver salt, a reducing agent, and a binder on at least one surface of a support. Constituent materials of the photothermographic material will be hereunder described in detail.

1. Photothermographic material:

Organic Silver Salt

Organic silver salts that can be used in the invention are silver salts that are comparatively stable to light but when heated at 80° C. or higher in the presence of an exposed photocatalyst (such as latent images of photosensitive silver halides) and a reducing agent, form a silver image. The organic silver salts may be reducible arbitrary organic substances including silver ion sources.

Such non-photosensitive organic silver salts are described in JP-A No. 10-62899, paragraph Nos. 0048 to 0049, EP-A No. 0803764, page 18, line 24 to page 19, line 37, EP-A No. 0962812, and JP-A Nos. 11-349591, 2000-7683 and 2000-72711. Silver salts of organic acids are preferable, and silver salts of long chain aliphatic carboxylic acids (having 10 to 30 carbon atoms, and preferably 15 to 28 carbon atoms) are especially preferable.

Preferred examples of organic silver salts include silver behenate, silver arachidate, silver stearate, silver oleate, silver laurate, silver capronate, silver myristate, silver palmitate, and mixtures thereof. Of these organic silver salts, organic acid silvers having a silver behenate content of 40% by mole or more are preferable for use, and organic acid silvers having a silver behenate content of 75% by mole or more are more preferable for use.

The shape of the organic silver salts that can be used in the invention is not particularly limited but may be an acicular, rod-like, tabular, or scale-like shape, preferably an acicular or scale-like shape, and especially preferably a scale-like shape.

In this specification, the “organic silver salt in a scale-like shape” as referred to herein is defined in the following manner. That is, when organic silver salts are observed by an electron microscope, the shape of organic acid silver salt grains is approximated to a rectangular parallelopiped, and sides of this rectangular parallelopiped are designated as a, b and c from a short one (c may be the same as b), numeral values of the short ones a and b are calculated, and x is determined according to the following equation.

x=b/a

With respect to approximately 200 grains, the x values are determined in this manner, and their mean value is defined as “x (mean)”. At that time, one that is satisfied with the relationship of x (mean)≧1.5 is referred to as “scale-like shape”. 30≧x (mean)≧1.5 is preferable, and 20≧x (mean)≧1.5 is more preferable. Here, the “acicular shape” as referred to herein means 1≦x (mean)≦1.5.

In the scale-like grains, a can be considered the thickness of tabular grains in which a plane having b and c as sides is the principal plane. A mean value of a is preferably 0.01 μm to 0.23 μm, and more preferably 0.1 μm to 0.20 μm. A mean value of c/b is preferably from 1 to 6, more preferably from 1.05 to 4, further preferably from 1.1 to 3, and especially preferably from 1.1 to 2.

The grain size distribution of organic silver salts is preferably in a mono-dispersed state. The “mono-dispersed state” as referred to herein means that the percentage of a value obtained by dividing a standard deviation of each of lengths of the minor axis and the major axis by the minor axis and the major axis, respectively is preferably not more than 100%, more preferably not more than 80%, and further preferably not more than 50%. The shape of organic silver salts can be measured from transmission electron microscopic images of the organic silver salt dispersion. As another method of measuring the mono-dispersibility, there is known a method of determining a standard deviation of volume weighted mean diameter of organic silver salts. The percentage of a value obtained by dividing this standard deviation by the volume weighted mean diameter (coefficient of variation) is preferably not more than 100%, more preferably not more than 80%, and further preferably not more than 50%.

With respect to the measurement, the organic silver salts dispersed in a liquid can be measured using a commercially available laser light scattering grain size analyzer.

With respect to the production and dispersion methods of the organic acid silvers that are used in the invention, known methods can be employed. For example, the above-cited JP-A No. 10-62899, EP-A Nos. 0803764 and 0962812 and JP-A Nos. 11-349591, 2000-7683, 2000-72711, 2001-163889, 2001-163890, 2001-163827, 2001-33907, 2001-188313, 2001-83652, 2002-6442 and 2002-31870 can be made hereof by reference.

When a photosensitive silver salt is co-present upon dispersion of the organic silver salt, fogging increases, and the sensitivity is remarkably lowered. Accordingly, it is more preferable that the photosensitive silver salt is not substantially contained upon dispersion. In the invention, the amount of the photosensitive silver salt in the aqueous dispersion to be dispersed is not more than 0.1% by mole per mole of the organic acid silver salt in the liquid, and it is desired that positive addition of the photosensitive silver salt is not carried out.

Though the organic silver salt of the invention can be used in a desired amount, it is used preferably in an amount of 0.1 to 5 g/m², and more preferably 0.5 to 3 g/m² in terms of the silver amount.

Reducing Agent

The reducing agent that is used in the invention will be described below.

In the first aspect of the invention, a compound represented by formula (R-1) is used as the reducing agent. The reducing agent may further contain a compound represented by formula (R-2) or (R-3) in addition to the compound represented by formula (R-1).

In the second aspect of the invention, a compound represented by formula (R-4) is used as the reducing agent, and in the third aspect of the invention, a compound represented by formula (R-5) is used as the reducing agent.

First of all, the first aspect of the invention will be described below.

(1) Compound Represented by Formula (R-1):

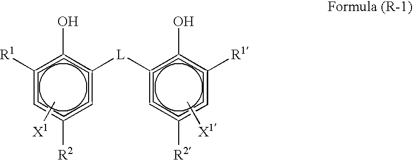

In the formula (R-1), R¹ and R^{1′} each independently represent an alkyl group having 3 to 20 carbon atoms, in which the carbon atom bonding to the benzene ring is secondary or tertiary; R² and R^{2′} each represent a methyl group; L represents an —S— group or a —CHR³— group; R³ represents a hydrogen atom or an alkyl group having 1 to 20 carbon atoms; and X¹ and X^{1′} each independently represent a hydrogen atom or a group capable of being substituted on the benzene ring.

The respective substituents will be described below in detail.

1) R¹ and R^{1′}:

In formula (R-1), R¹ and R^{1′} each independently represent a substituted or unsubstituted alkyl group having 3 to 20 carbon atoms, in which the carbon atom bonding to the benzene ring is secondary or tertiary. Though the substituent of the alkyl group is not particularly limited, it is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom.

2) R² and R^{2′}:

In formula (R-1), R² and R^{2′} each represent a methyl group.

3) X¹ and X^{1′}:

X¹ and X^{1′} each independently represent a hydrogen atom or a group capable of being substituted on the benzene ring. As groups that can be substituted on the benzene ring, an alkyl group, an aryl group, a halogen atom, an alkoxy group, and an acylamino group are preferably enumerated.

4) L:

L represents an —S— group or a —CHR³— group; and R³ represents a hydrogen atom or an alkyl group having 1 to 20 carbon atoms, which may have a substituent.

Specific examples of an unsubstituted alkyl group represented by R³ include a methyl group, an ethyl group, a propyl group, a butyl group, a heptyl group, an undecyl group, an isopropyl group, a 1-ethylpentyl group, and a 2,4,4-trimethylpentyl group.

Examples of substituents of the alkyl group are the same as in the substituent of R¹, such as a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, and a sulfamoyl group.

5) Preferred Substituents:

In the formula (R-1), R¹ and R^{1′} are each preferably a secondary or tertiary alkyl group having 3 to 15 carbon atoms. Specific examples include an isopropyl group, an isobutyl group, a t-butyl group, a t-amyl group, a t-octyl group, a cyclohexyl group, a cyclopentyl group, a 1-methylcyclohexyl group, and a 1-methylcyclopropyl group. R¹ and R^{1′} are each more preferably a tertiary alkyl group having 4 to 12 carbon atoms. Above all, a t-butyl group, a t-amyl group, and a 1-methylcyclohexyl group are further preferable, and a t-butyl group is most preferable.

X¹ and X^{1′} are each preferably a hydrogen atom, a halogen atom, or an alkyl group, and more preferably a hydrogen atom.

L is preferably a —CHR³— group.

R³ is preferably a hydrogen atom or an alkyl group having 1 to 15 carbon atoms; and the alkyl group is preferably a methyl group, an ethyl group, a propyl group, an isopropyl group, or a 2,4,4-trimethylpentyl group. R³ is particularly preferably a hydrogen atom, a methyl group, a propyl group, or an isopropyl group.

Specific examples of the compound represented by formula (R-1) of the invention will be given below, but it should not be construed that the invention is limited thereto.

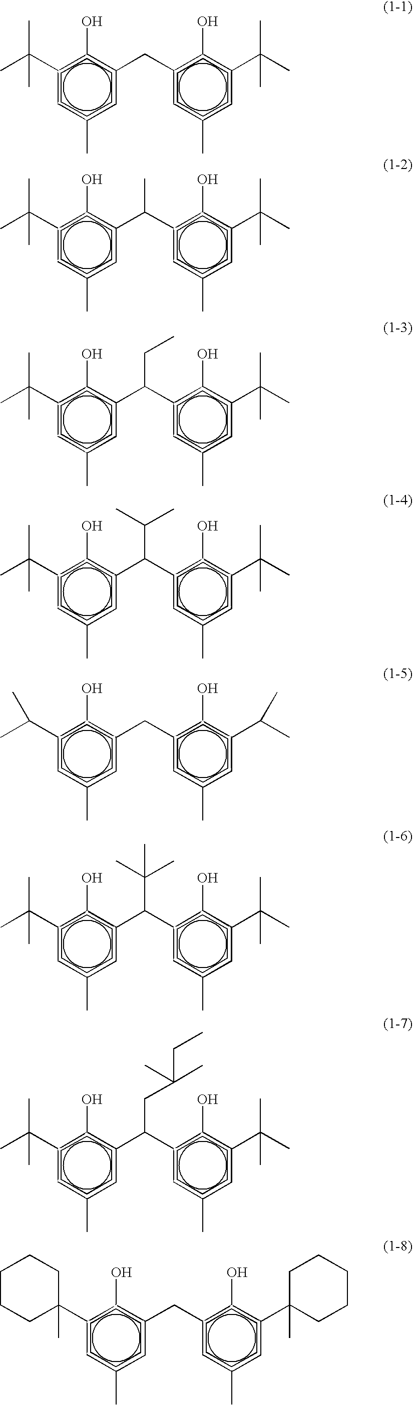

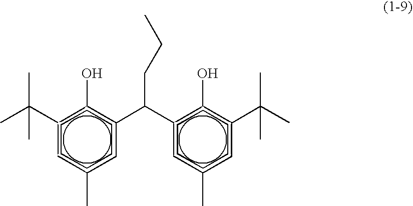

(2) Compound Represented by the Formula (R-2):

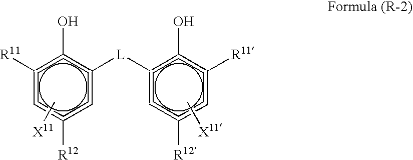

In the formula (R-2), R¹¹ and R^{11′} each independently represent an alkyl group having 3 to 20 carbon atoms, in which the carbon atom bonding to the benzene ring is secondary or tertiary; R¹² and R^{12′} each represent an alkyl group having 2 to 20 carbon atoms; L represents an —S— group or a —CHR¹³— group; R¹³ represents a hydrogen atom or an alkyl group having 1 to 20 carbon atoms; and X¹¹ and X^{11′} each independently represent a hydrogen atom or a group capable of being substituted on the benzene ring.

The respective substituents will be described below in detail.

1) R¹¹ and R^{11′}:

In the formula (R-2), R¹¹ and R^{11′} are synonymous with R¹ and R^{1′} in the formula (R-1).

2) R¹² and R^{12′}:

In the formula (R-2), R¹² and R^{12′} each independently represent a substituted or unsubstituted alkyl group having 2 to 20 carbon atoms.

3) X¹¹ and X^{11′}:

X¹¹ and X^{11′} are synonymous with X¹ and X^{1′} in the formula (R-1).

4) L:

In the formula (R-2), L represents an —S— group or —CHR₁₃— group; and R¹³ is synonymous with R³ in the formula (R-1).

5) Preferred Substituents:

In the formula (R-2), preferred examples of R¹¹ and R^{11′} are the same as in R¹ and R^{1′} in the formula (R-1).

In the formula (R-2), R¹² and R^{12′} are each preferably an alkyl group having 2 to 20 carbon atoms. Specific examples include an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. Of these groups, an ethyl group, a propyl group, an isopropyl group, and a t-butyl group are more preferable.

X¹¹ and X^{11′} are the same as X¹ and X^{1′} in the formula (R-1).

Specific examples of the compound represented by the formula (R-2) of the invention will be given below, but it should not be construed that the invention is limited thereto.

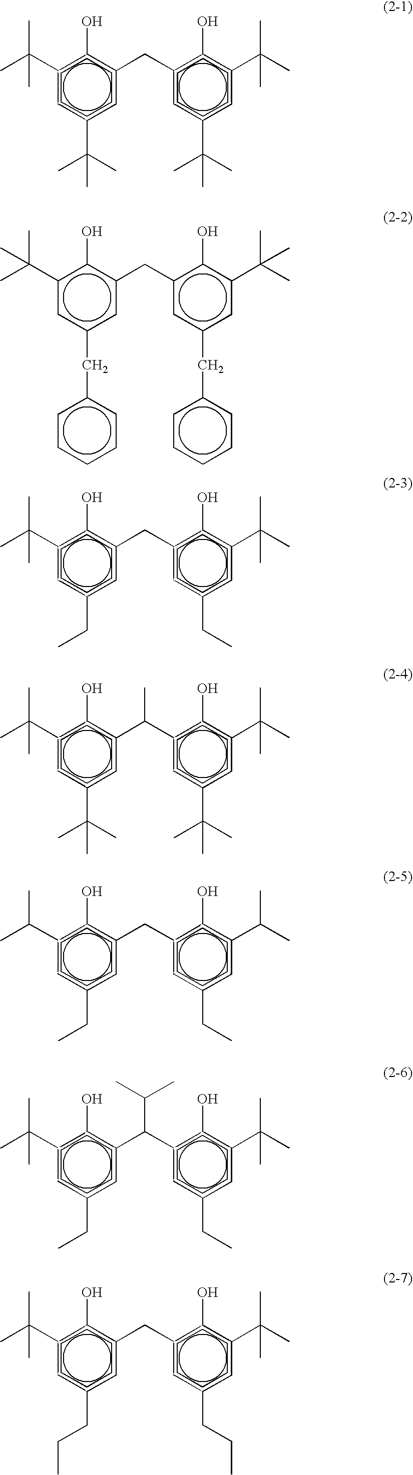

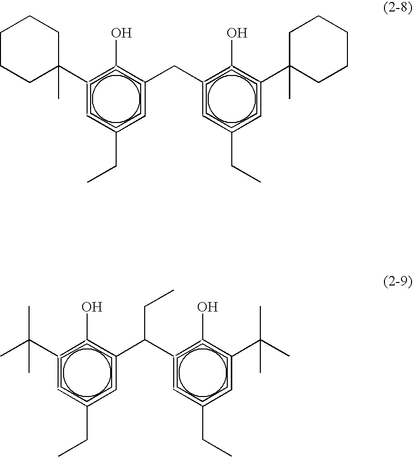

(3) Compound Represented by the Formula (R-3):

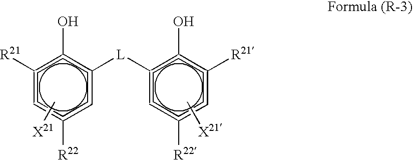

In the formula (R-3), R²¹ and R^{21′} each independently represent a methyl group or an alkyl group having 2 to 20 carbon atoms, in which a carbon atom bonding to the benzene ring is primary (a non-branched carbon); R²² and R^{22′} each independently represent an alkyl group having 1 to 20 carbon atoms; L represents an —S— group or a —CHR²³— group; R²³ represents a hydrogen atom or an alkyl group having 1 to 20 carbon atoms; and X²¹ and X^{21′} each independently represent a hydrogen atom or a group capable of being substituted on the benzene ring.

The respective substituents will be described below in detail.

1) R²¹ and R^{21′}:

In the formula (R-3), R²¹ and R^{21′} each independently represent a substituted or unsubstituted methyl group or a substituted or unsubstituted alkyl group having 2 to 20 carbon atoms, in which a carbon atom bonding to the benzene ring is primary (a non-branched carbon). Though the substituent of the alkyl group is not particularly limited, preferred examples of the substituent are the same as in the formula (R-1). Preferred examples of the substituent include an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom.

2) R²² and R^{22′}:

In the formula (R-3), R²² and R^{22′} each independently represent a substituted or unsubstituted alkyl group having 1 to 20 carbon atoms.

3) X²¹ and X^{21′}:

X²¹ and X^{21′} are synonymous with X¹ and X¹ in the formula (R-1).

4) L:

In the formula (R-3), L represents an —S— group or a —CHR²³ group; and R²³ is synonymous with R³ in the formula (R-1).

5) Preferred Substituents:

In the formula (R-3), R²¹ and R²¹ are each preferably a methyl group or an ethyl group.

In the formula (R-3), R²² and R^{22′} are each preferably an alkyl group having 1 to 20 carbon atoms. Specific examples include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. Of these groups, a methyl group, an ethyl group, a propyl group, an isopropyl group, and a t-butyl group are more preferable.

X²¹ and X^{21′} are synonymous with X¹ and X^{1′} in the formula (R-1).

Specific examples of the compound represented by the formula (R-3) of the invention will be given below, but it should not be construed that the invention is limited thereto.

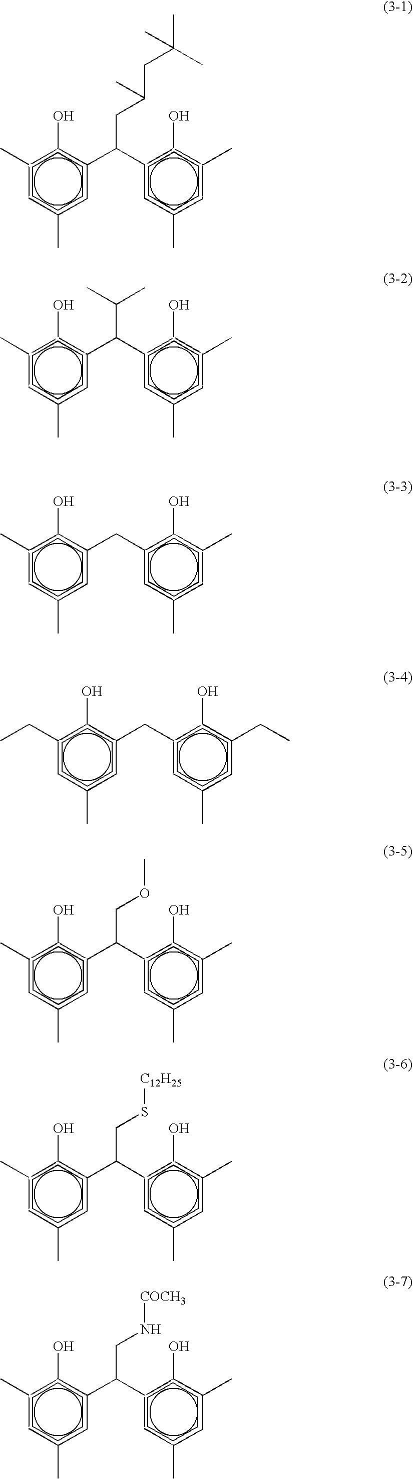

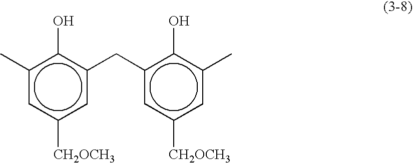

In the invention, the addition amount of the compound represented by the formula (R-1) is preferably 0.01 to 2.0 g/m², and more preferably 0.1 to 1.0 g/m², and the compound represented by the formula (R-1) is preferably contained in an amount of 5 to 50% by mole, and more preferably 10 to 40% by mole per mole of silver on the surface having the image forming layer.

In the invention, the addition amount of the compound represented by the formula (R-2) is preferably 0.01 to 2.0 g/m², and more preferably 0.1 to 1.0 g/m², and the compound represented by the formula (R-2) is preferably contained in an amount of 1 to 3,000% by mole, and more preferably 5 to 2,000% by mole based on the compound represented by the formula (R-1).

In the invention, the addition amount of the compound represented by the formula (R-3) is preferably 0.01 to 2.0 g/m², and more preferably 0.1 to 1.0 g/m², and the compound represented by the formula (R-3) is preferably contained in an amount of 1 to 3,000% by mole, and more preferably 5 to 2,000% by mole based on the compound represented by the formula (R-1).

Though the compounds represented by the formulae (R-1), (R-2) and (R-3) can be added to the image forming layer and an adjacent layer thereto, it is preferable to contain these compounds in the image forming layer.

The compounds represented by the formulae (R-1), (R-2) and (R-3) may be contained in a coating liquid by any method in a solution state, an emulsified dispersion state, or a solid fine grain dispersion state and contained in the photosensitive material.

As the well known emulsification and dispersion method, there is enumerated a method in which the compounds are dissolved using an oil such as dibutyl phthalate, tricresyl phosphate, glyceryl triacetate and diethyl phthalate, and a co-solvent such as ethyl acetate and cyclohexanone, thereby mechanically preparing an emulsified dispersion.

Also, as the solid fine grain dispersion method, there is enumerated a method in which powders of the compounds represented by the formulae (R-1), (R-2) and (R-3) are dispersed in a proper solvent such as water in a ball mill, a colloid mill, a vibration ball mill, a sand mill, a jet mill, or a roller mill or by ultrasonic wave, to prepare a solid dispersion. Above all, the dispersion method using a sand mill is preferable. Protective colloids (such as polyvinyl alcohol) or surfactants (such as anionic surfactants such as sodium triisopropylnaphthalenesulfonate (a mixture in which three isopropyl groups are substituted on a site different from each other)) may be used during the operations. The water dispersion can contain an antiseptic (such as benzoisothiazolinone sodium salt).

The solid grain dispersion method is especially preferable, and it is preferable to form the grains in fine grains having a mean grain size of 0.05 μm to 5.0 μm, and preferably 0.08 μm to 1.0 μm and then add them. In this application, it is preferable to disperse other solid dispersions into a grain size of this range and then use them.

Next, the reducing agents to be used in the second aspect and the third aspect will be described below.

The reducing agent to be used in the second aspect of the invention is a compound represented by the following formula (R-4), and the reducing agent to be used in the third aspect of the invention is a compound represented by the following formula (R-5).

The formulae (R-4) and (R-5) are expressed by the following formulae.

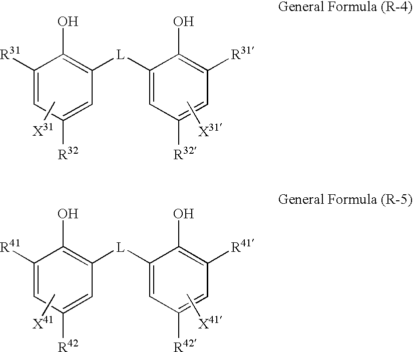

In the formula (R-4), R³¹ and R^{31′} each independently represent an alkyl group having 1 to 20 carbon atoms; R³² and R^{32′} each independently represent an alkyl group having 2 to 20 carbon atoms; L represents an —S— group or a —CHR³³— group; R³³ represents a hydrogen atom or an alkyl group having 1 to 20 carbon atoms; and X³¹ and X³¹ each independently represent a hydrogen atom or a group capable of being substituted on the benzene ring.

In the formula (R-5), R⁴¹ and R⁴¹ each represent a methyl group or an alkyl group having 2 to 20 carbon atoms, in which a carbon atom bonding to the benzene ring is primary (a non-branched carbon atom); R⁴² and R^{42′} each independently represent a hydrogen atom or a group capable of being substituted on the benzene ring; L represents an —S— group or a —CHR⁴³— group; R⁴³ represents a hydrogen atom or an alkyl group having 1 to 20 carbon atoms; and X⁴¹ and X^{41′} each independently represent a hydrogen atom or a group capable of being substituted on the benzene ring.

The respective substituents will be described below in detail.

1) R³¹ and R^{31′} and R⁴¹ and R^{41′}:

In the formula (R-4), R³¹ and R^{31′} each independently represent a substituted or unsubstituted alkyl group having 1 to 20 carbon atoms. Though the substituent of the alkyl group is not particularly limited, it is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom.

In the formula (R-5), R⁴¹ and R^{41′} each independently represent a substituted or unsubstituted methyl group or a substituted or unsubstituted alkyl group having 2 to 20 carbon atoms, in which a carbon atom bonding to the benzene ring is primary (a non-branched carbon). Though the substituent of the alkyl group is not particularly limited, preferred examples of the substituent are the same as in R³¹ and R^{31′} in the formula (R-4).

2) R³² and R³² and R⁴² and R^{42′}:

In the formula (R-4), R³² and R³² each independently represent an alkyl group having 2 to 20 carbon atoms, from which a methyl group is excluded.

In the formula (R-5), R⁴² and R^{42′} each independently represent a hydrogen atom or a group capable of being substituted on the benzene ring.

3) X³¹ and X^{31′} and X⁴¹ and X^{41′}:

In any of the formulae (R-4) and (R-5), X³¹ and X^{31′} and X⁴¹ and X^{41′} each independently represent a hydrogen atom or a group capable of being substituted on the benzene ring. Preferred examples of the group that can be substituted on the benzene ring include an alkyl group, an aryl group, a halogen atom, an alkoxy group, and an acylamino group.

4) L:

In the formula (R-4), L represents an —S— group or a —CHR³³— group; and in the formula (R-5), L represents an —S— group or a —CHR⁴³— group. R³³ and R⁴³ each represent a hydrogen atom or an alkyl group having 1 to 20 carbon atoms, which may have a substituent.

Specific examples of an unsubstituted alkyl group represented by R³¹ and R⁴³ include a methyl group, an ethyl group, a propyl group, a butyl group, a heptyl group, an undecyl group, an isopropyl group, a 1-ethylpentyl group, and a 2,4,4-trimethylpentyl group.

Examples of substituents of the alkyl group are the same as in the substituent of R³, such as a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, and a sulfamoyl group.

5) Preferred Substituents:

In the formula (R-4), R³¹ and R^{31′} are each preferably a secondary or tertiary alkyl group having 3 to 15 carbon atoms. Specific examples include an isopropyl group, an isobutyl group, a t-butyl group, a t-amyl group, a t-octyl group, a cyclohexyl group, a cyclopentyl group, a 1-methylcyclohexyl group, and a 1-methylcyclopropyl group. R³¹ and R³¹ are each more preferably a tertiary alkyl group having 4 to 12 carbon atoms. Of these groups, a t-butyl group, a t-amyl group, and a 1-methylcyclohexyl group are further preferable, and a t-butyl group is most preferable.

In the formula (R-4), R³² and R^{32′} are each preferably an alkyl group having 2 to 20 carbon atoms. Specific examples include an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group, and more preferably an ethyl group, a propyl group, an isopropyl group, and a t-butyl group.

In the formula (R-5), R⁴¹ and R^{41′} are each preferably a linear methyl group, ethyl group or propyl group, and especially preferably a methyl group.

In the formula (R-5), R⁴² and R^{42′} are each preferably an alkyl group having 1 to 20 carbon atoms. Specific examples include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. Of these groups, a methyl group, an ethyl group, a propyl group, an isopropyl group, and a t-butyl group are more preferable.

X³¹ and X^{31′} in the formula (R-4) and X⁴¹ and X⁴¹ in the formula (R-5) are each preferably a hydrogen atom, a halogen atom, or an alkyl group, and more preferably a hydrogen atom.

In the formula (R-4), L is preferably a —CHR³³— group; and in the formula (R-5), L is preferably a —CHR⁴³— group.

R³³ and R⁴³ are each preferably a hydrogen atom or an alkyl group having 1 to 15 carbon atoms; and the alkyl group is preferably a methyl group, an ethyl group, a propyl group, an isopropyl group, or a 2,4,4-trimethylpentyl group. R³³ and R⁴³ are each particularly preferably a hydrogen atom, a methyl group, a propyl group, or an isopropyl group.

In the case where R³³ is a hydrogen atom, R³² and R³² are each preferably an alkyl group having 2 to 5 carbon atoms, more preferably an ethyl group or a propyl group, and most preferably an ethyl group.

In the case where R⁴³ is a hydrogen atom, R⁴² and R^{42′} are each preferably an alkyl group having 2 to 5 carbon atoms, more preferably an ethyl group or a propyl group, and most preferably an ethyl group.

In the case where R³³ is a primary or secondary alkyl group having 1 to 8 carbon atoms, R³² and R^{32′} are each preferably a methyl group. As the primary or secondary alkyl group having 1 to 8 carbon atoms represented by R³³, a methyl group, an ethyl group, a propyl group, and an isopropyl group are more preferable, and a methyl group, an ethyl group, and a propyl group are further preferable.

In the case where R⁴³ is a primary or secondary alkyl group having 1 to 8 carbon atoms, R⁴² and R^{42′} are each preferably a methyl group. As the primary or secondary alkyl group having 1 to 8 carbon atoms represented by R⁴³, a methyl group, an ethyl group, a propyl group, and an isopropyl group are more preferable, and a methyl group, an ethyl group, and a propyl group are further preferable.

Specific examples of the compound represented by the formula (R-4) of the invention will be given below, but it should not be construed that the invention is limited thereto.

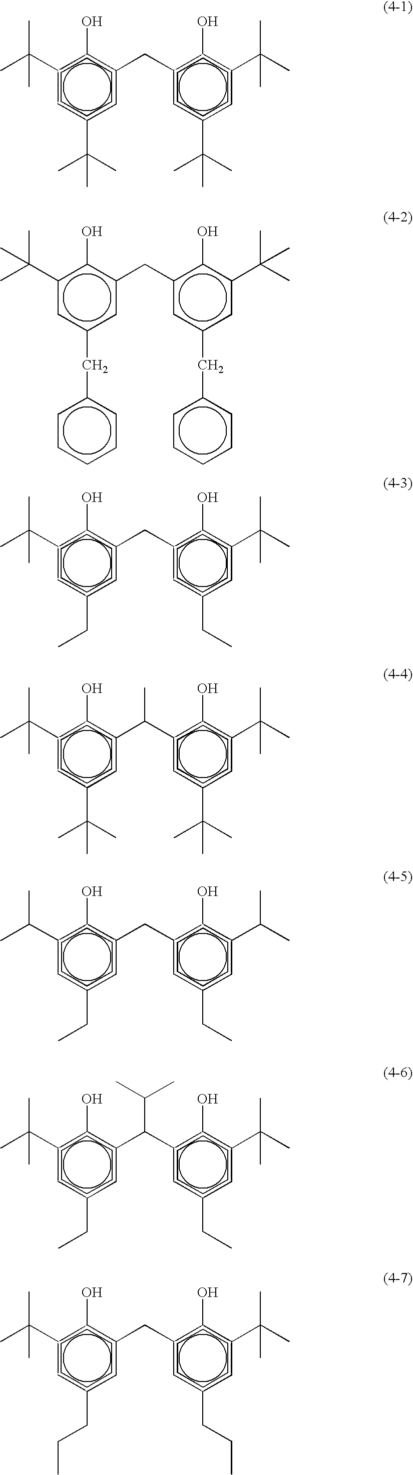

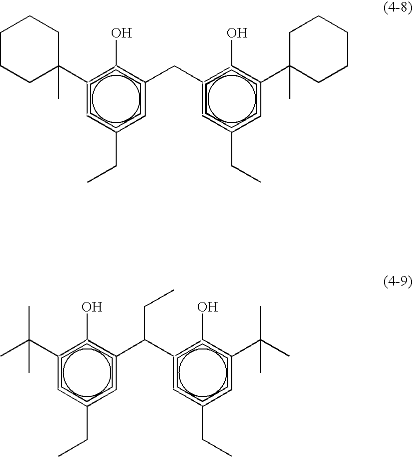

Specific examples of the compound represented by the formula (R-5) of the invention will be given below, but it should not be construed that the invention is limited thereto.

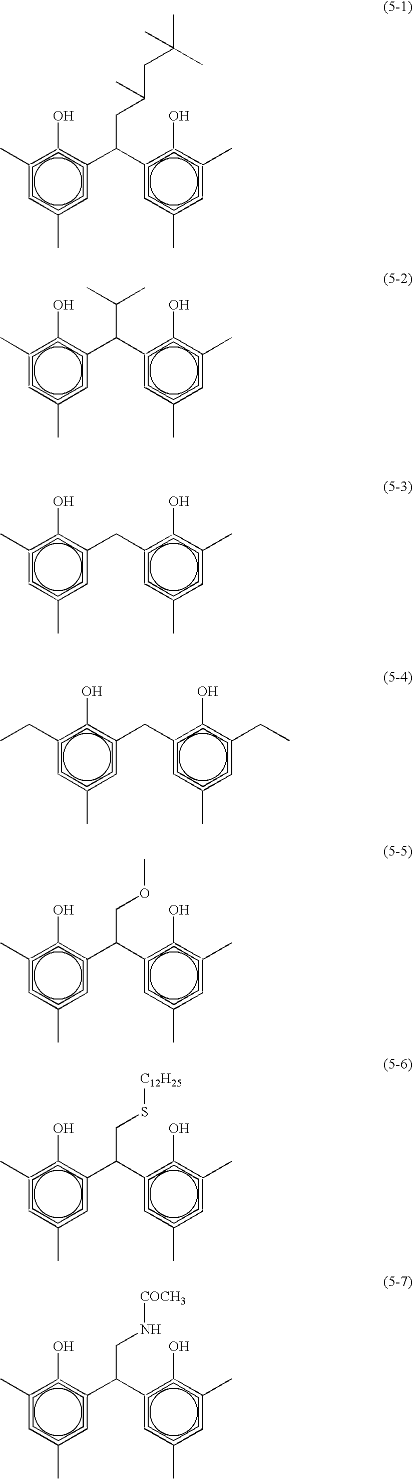

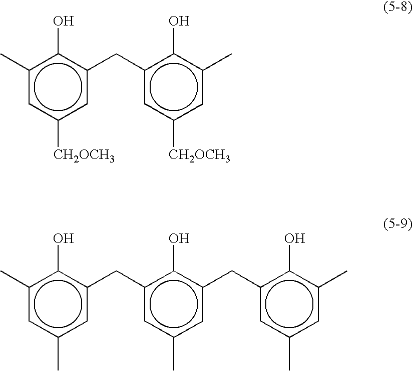

In the invention, the addition amount of the compound represented by the formula (R-4) is preferably 0.01 to 2.0 g/m², and more preferably 0.1 to 1.5 g/m².

The ratio of the addition amount of the compound represented by the formula (H) to the addition amount of the compound represented by the formula (R-4) is 0.2 or more, preferably 0.2 to 1.0, and more preferably 0.25 to 0.8 in terms of molar ratio. The compound represented by formula (H) will be described later as an antifoggant.

In the invention, the addition amount of the compound represented by the formula (R-5) is preferably 0.01 to 2.0 g/m², and more preferably 0.1 to 1.5 g/m².

The ratio of the addition amount of the compound represented by the formula (H) to the addition amount of the compound represented by the formula (R-5) is 0.15 or greater, preferably 0.15 to 1.0, and more preferably 0.2 to 0.8 in terms of molar ratio.

The compounds represented by the formulae (R-4) and (R-5) may be contained in a coating liquid by any method in a solution state, an emulsified dispersion state, or a solid fine grain dispersion state and contained in the photosensitive material.

As the well known emulsification and dispersion method, there is enumerated a method in which the compounds are dissolved using an oil such as dibutyl phthalate, tricresyl phosphate, glyceryl triacetate and diethyl phthalate, and a co-solvent such as ethyl acetate and cyclohexanone, thereby mechanically preparing an emulsified dispersion.

Also, as the solid fine grain dispersion method, there is enumerated a method in which powders of the compounds represented by the formulae (R-4) and (R-5) are dispersed in a proper solvent such as water in a ball mill, a colloid mill, a vibration ball mill, a sand mill, a jet mill, or a roller mill or by ultrasonic wave, to prepare a solid dispersion. Above all, the dispersion method using a sand mill is preferable. Protective colloids (such as polyvinyl alcohol) or surfactants (such as anionic surfactants such as sodium triisopropylnaphthalenesulfonate (a mixture in which three isopropyl groups are substituted on a site different from each other)) may be used during the operations. The water dispersion can contain an antiseptic (such as benzoisothiazolinone sodium salt).

The solid grain dispersion method is especially preferable, and it is preferable to form the grains in fine grains having a mean grain size of 0.05 μm to 5.0 μm, and preferably 0.08 μm to 1.0 μm and then add them. In this application, it is preferable to disperse other solid dispersions into a grain size of this range and then use them.

Development Accelerator

In the photothermographic material of the invention, sulfonamidophenol based compounds represented by the general formula (A) described in JP-A Nos. 2000-267222 and 2000-330234, hindered phenol based compounds represented by the formula (II) described in JP-A No. 2001-92075, hydrazine based compounds represented by the general formula (I) described in JP-A Nos. 10-62895 and 11-15116 or by the general formula (1) described in JP-A No. 2002-278017, and phenol based or naphthol based compounds represented by the general formula (2) described in JP-A No. 2001-264929 are preferably used as a development accelerator. These development accelerators are used in an amount of 0.1 to 20% by mole, preferably 0.5 to 10% by mole, and more preferably 1 to 5% by mole based on the reducing agent. As the introduction method into the photographic material, the same method as in the reducing agent can be employed, but it is especially preferable to add the development accelerator as a solid dispersion or an emulsified dispersion. In the case of adding it as an emulsified dispersion, it is preferable to add the development accelerator as an emulsified emulsion in which it is dispersed using a high-boiling solvent that is solid at normal temperature and a low-boiling co-solvent or to add the development accelerator as a so-called oil-less emulsified dispersion without using a high-boiling solvent.

In the invention, of the foregoing development accelerators, hydrazine based compounds represented by the general formula (1) described in JP-A No. 2002-278017 and phenol based or naphthol based compounds represented by the general formula (2) described in JP-A No. 2001-264929 are especially preferable.

Preferred specific examples of the development accelerator of the invention will be given below, but it should not be construed that the invention is limited thereto.

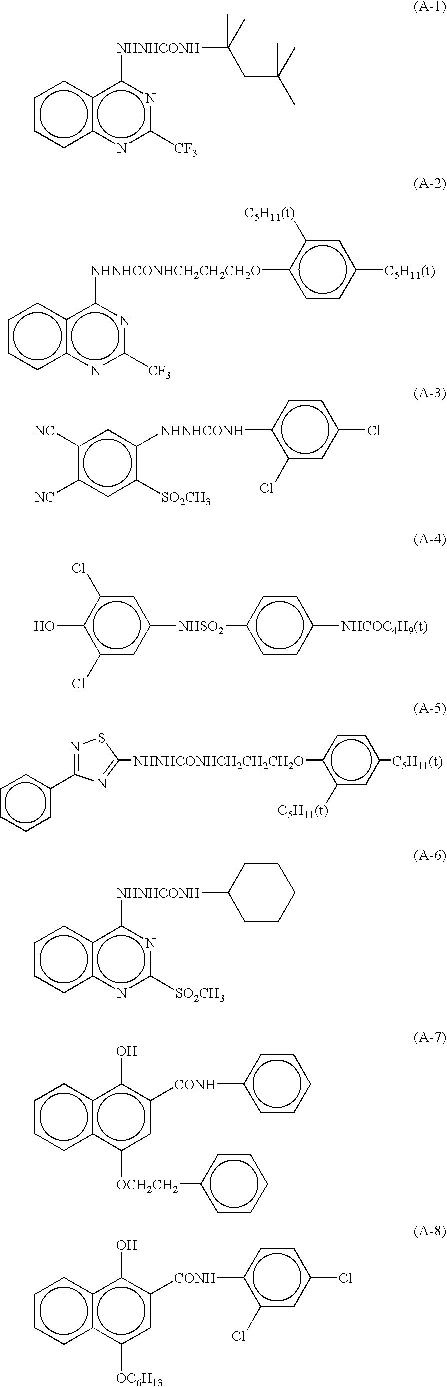

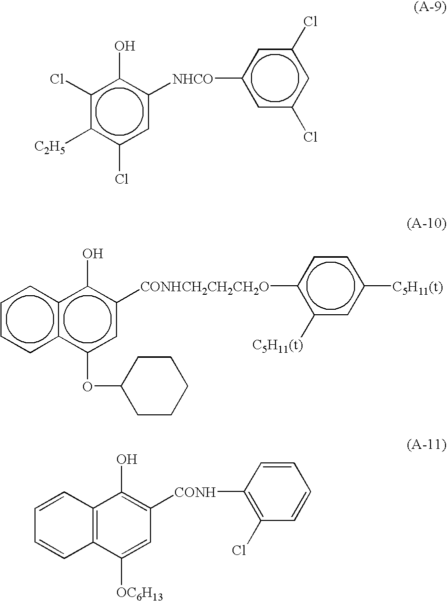

Hydrogen Bond-Forming Compound

In the invention, it is preferable to jointly use a non-reducible compound having a group capable of forming a hydrogen bond with an aromatic hydroxyl group (—OH) of the reducing agent.

Examples of the group capable of forming a hydrogen bond include a phosphoryl group, a sulfoxide group, a sulfonyl group, a carbonyl group, an amide group, an ester group, a urethane group, a ureido group, a tertiary amino group, and a nitrogen-containing aromatic group. Above all, compounds having a phosphoryl group, a sulfoxide group, an amide group (provided that it does not have an >N—H group and is blocked as in >N—Ra (Ra is a substituent other than H)), or a ureido group (provided that it does not have an >N—H group and is blocked as in >N—Ra (Ra is a substituent other than H)) are preferable.

In the invention, the hydrogen bond-forming compound is especially preferably a compound represented by the following formula (HB).

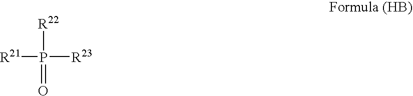

In the formula (HB), R²¹ to R²³ each independently represent an alkyl group, an aryl group, an alkoxy group, an aryloxy group, an amino group, or a heterocyclic group, each of which may be unsubstituted or substituted.

In the case where R²¹ to R²³ each has a substituent, examples of the substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group. As the substituent, an alkyl group and an aryl group are preferable, and specific examples include a methyl group, an ethyl group, an isopropyl group, a t-butyl group, a t-octyl group, a phenyl group, a 4-alkoxyphenyl group, and a 4-acyloxyphenyl group.

Specific examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Specific examples of the aryl group include a phenyl group, a cresyl group, a xylyl group, a naphthyl group, a 4-t-butylphenyl group, a 4-t-octylphenyl group, a 4-anisidyl group, and a 3,5-dichlorophenyl group.

Specific examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

Specific examples of the aryloxy group include a phenoxy group, a cresyloxy group, an isopropylphenoxy group, a 4-t-butylphenoxy group, a naphthoxy group, and a biphenyloxy group.

Specific examples of the amino group include a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

As R²¹ to R²³, an alkyl group, an aryl group, an alkoxy group, and an aryloxy group are preferable. From the standpoint of the effects of the invention, it is preferable that at least one of R²¹ to R²³ is an alkyl group or an aryl group, and it is more preferable that at least two of R²¹ to R²³ are each an alkyl group or an aryl group. Also, from the standpoint of easiness in availability at a low price, the case where R²¹ to R²³ represent the same group is preferable.

Specific examples of hydrogen bond-forming compounds including those represented by the formula (HB) of the invention will be given below, but it should not be construed that the invention is limited thereto.

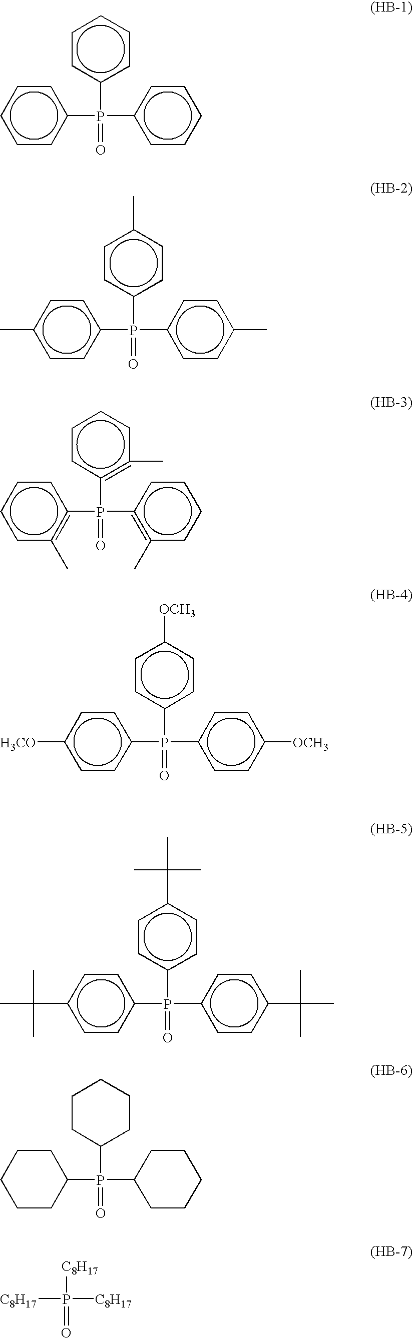

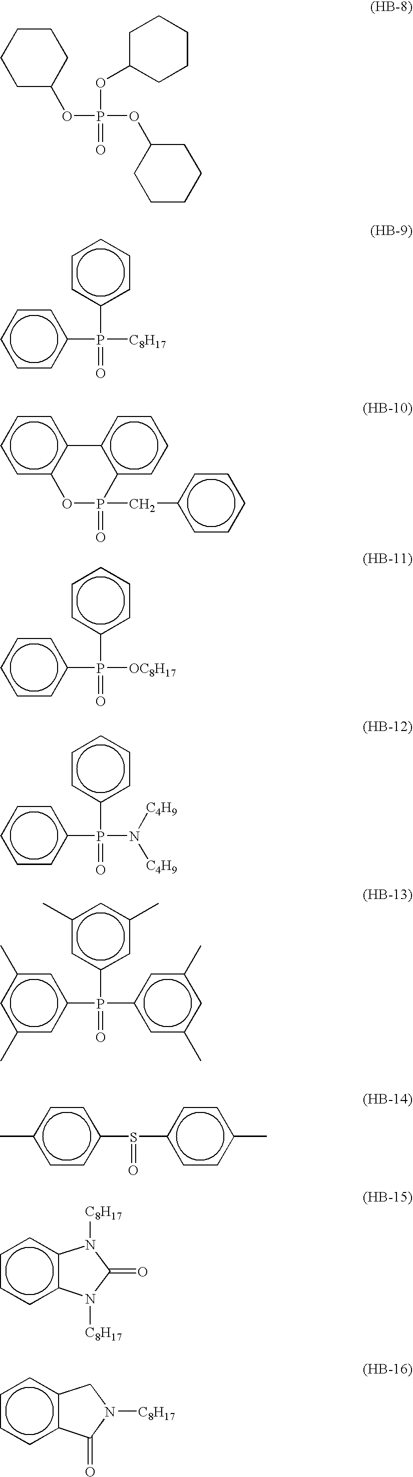

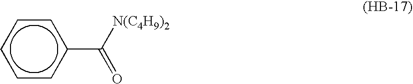

Specific examples of the hydrogen bond-forming compound other than those described above include those described in JP-A Nos. 2001-281793 and 2002-014438.

Likewise the reducing agent, the hydrogen bond-forming compound of the invention may be contained in a coating liquid in a solution state, an emulsified dispersion state, or a solid fine grain dispersion state and contained in the photosensitive material. The hydrogen bond-forming compound of the invention forms a complex with a phenolic hydroxyl group-containing compound in a solution state and can be isolated as the complex in a crystal state depending upon a combination of the reducing agent and the compound of the formula (HB) of the invention.

In obtaining a stable performance, it is preferable to use the thus isolated crystal powder as a solid fine grain dispersion. Also, a method in which the reducing agent and the hydrogen bond-forming compound of the invention are mixed in a powder state, and a complex is formed using a proper dispersant upon dispersion in a sand grinder mill, etc. can be preferably used.

The hydrogen bond-forming compound of the invention is preferably used in an amount of 1 to 200% by mole, more preferably 10 to 150% by mole, and further preferably 30 to 100% by mole based on the reducing agent.

Photosensitive Silver Halide

1) Silver Halide Formulation:

The photosensitive silver halide that is used in the invention is especially preferably a high silver iodide emulsion containing 40% by mole to 100% by mole of silver iodide as a halogen formation. It is preferable that a part of the silver halide of the invention has a phase that efficiently absorbs light by direct transition. In exposure wavelengths of 350 nm to 450 nm as a preferred embodiment of the invention, it was known that high silver iodide structures having a hexagonal system wurtzite structure or a cubic system zincblende structure efficiently absorbs light by direct transition. However, silver halides having such an absorption structure were hitherto considered low in value in use from the standpoint of photographic industry because of their low sensitivity and hence, were not substantially taken into account.

According to the present study, it has been noted that in photothermographic materials having a non-photosensitive organic acid silver salt and a heat developer, by exposure in a large exposure illuminance of 1 mW/mm² or more within a short period of time (not longer than 1 second, preferably not longer than 10⁻² seconds, and more preferably not longer than 10⁻⁴ seconds), even such high silver iodide photosensitive materials can attain high sensitivity and high sharpness.

Also, according to the present study, at that time, it is preferable that the silver halide has a mean grain size of not more than 80 nm. The mean grain size of the silver halide is preferably 5 nm to 80 nm, more preferably 5 nm to 60 nm, and most preferably 5 nm to 40 nm. The “grain size” as referred to herein means the diameter as reduced into a sphere having the same volume as the volume of the silver halide grain.

The silver iodide content of the silver halide of the invention is more preferably in the range of 70% by mole to 100% by mole, and further preferably in the range of 90% by mole to 100% by mole. As the silver iodide content increases, the effects of the invention are more distinctly revealed.

Whether or not the silver halide of the invention has light absorption by direct transition can be easily judged by the matter that exciton absorption caused by the direct transition is observed in the vicinity of 400 nm to 430 nm.

Such a direct transition light absorption type high silver iodide phase may be present singly. But ones joined to a silver halide exhibiting indirect transition absorption in a wavelength region of 350 nm to 450 nm, such as silver bromide emulsions, silver chloride emulsions, silver iodobromide emulsions, silver iodochloride emulsions, and mixed crystals thereof are also preferably used.

The exposure wavelength is preferably 350 nm to 450 nm, more preferably 370 nm to 440 nm, and especially preferably 390 nm to 430 nm.

The formation method of photosensitive silver halides is well known in the art, and for example, methods described in Research Disclosure No. 17029, June 1978 and U.S. Pat. No. 3,700,458 can be employed. Specific examples include a conversion method in which an organic acid silver is reacted with a water-soluble halogen salt to convert a part of the organic acid silver into a silver halide; a method in which a silver halide is mixing during reaction of an organic acid and a water-soluble silver salt to take the silver halide into organic acid silver grains; and a method in which organic acid silver grains and silver halide grains are previously prepared and then mixed. In the invention, it is preferable to employ a method in which a silver providing compound and a halogen providing compound are added to gelatin or other polymer solution to prepare a photosensitive silver halide, which is then mixed with an organic silver salt. Also, a method described in JP-A No. 11-119374, paragraph Nos. 0217 to 0224 and methods described in JP-A Nos. 11-352627 and 2000-347335 are preferable.

With respect to the shape of silver halide grains include cubic grains, octahedral grains, tabular grains, spherical grains, rod-like grains, and pebble-like grains can be enumerated. In the invention, cubic grains are especially preferable. Silver halide grains whose corners are in a round shape can also be preferably employed.

With respect to the plane index (Miller index) of the external surface of photosensitive silver halide grains, there are no particular limitations. However, it is preferable that the proportion of the {100} plane that has a high spectral sensitization efficiency in the case where a spectral sensitizing dye is adsorbed is high. That proportion is preferably 50% or more, more preferably 65% or more, and further preferably 80% or more. The ratio of the Miller index {100} plane can be determined by a method described in T. Tani, J. Imaging Sci., 29, 165 (1985) utilizing the absorption reliability between the {111} plane and the {100} plane in adsorption of sensitizing dye.

2) Heavy Metal:

In the invention, silver halide grains in which a hexacyano metal complex is present on the outermost surface of grain. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, a hexacyano Fe complex is preferable.

Since the hexacyano metal complex is present in the form of an ion in an aqueous solution thereof, counter cations are not important. But it is preferable to use ions that easily mix with water and adapt to a precipitation operation of silver halide emulsion, such as alkali metal ions (such as a sodium ion, a potassium ion, a rubidium ion, a cesium ion, and a lithium ion), an ammonium ion, and alkylammonium ions (such as a tetramethylammonium ion, a tetraethylammonium ion, a tetrapropylammonium ion, and a tetra(n-butyl)ammonium ion).

The hexacyano metal complex can be mixed with water or a mixed solvent of water and an organic solvent that can be mixed with water (such as alcohols, ethers, glycols, ketones, esters, and amides) or gelatin and then added.

The addition amount of the hexacyano metal complex is preferably 1×10⁻⁵ moles to 1×10⁻² moles, and more preferably 1×₁₀⁻⁴ moles to 1×10⁻³ moles per mole of silver.

In order that the hexacyano metal complex may be present on the outermost surface of silver halide grain, after completion of addition of a silver nitrate aqueous solution to be used for the grain formation, the hexacyano metal complex is directly added before completion of the charging step until the chemical sensitization step such as chalcogen sensitization (such as sulfur sensitization, selenium sensitization, and tellurium sensitization) and noble metal sensitization (such as gold sensitization), during the water wash step, during the dispersion step, or before the chemical sensitization step. In order that the silver halide fine grains may not grow, it is preferable to add the hexacyano metal complex rapidly after the grain formation, and it is preferable to add the hexacyano metal complex before completion of the charging step.

The addition of the hexacyano metal complex may be started after adding 96% by mass, more preferably 98% by mass, and especially preferably 99% by mass of the total amount of silver nitrate to be added for the grain formation.

When the hexacyano metal complex is added after addition of the silver nitrate aqueous solution but just before completion of the grain formation, it can be adsorbed on the outermost surface of silver halide grain, thereby forming salts, almost all of which are sparingly soluble in silver ions on the grain surface. Since a silver salt of hexacyano iron(II) is a salt more sparingly soluble than AgI, it is possible to prevent re-dissolution by fine grains. Thus, it has become possible to produce silver halide fine grains having a small grain size.

The photosensitive silver halide grains of the invention can contain a metal or a metal complex belonging to the groups 8 to 10 of the periodic table (showing the groups 1 to 18). Examples of central metals of the metal or metal complex belonging to the group 8 to 10 of the periodic table include rhodium, ruthenium, and iridium. The metal complex may be used singly or in admixture or two or more complexes of the same metal or different metals. The content of the metal or metal complex is preferably in the range of 1×10⁻⁹ moles to 1×10⁻³ moles per mole of silver. These heavy metals or metal complexes and the addition method thereof are described in JP-A No. 7-225449, JP-A No. 11-65021, paragraph Nos. 0018 to 0024, and JP-A No. 11-119374, paragraph Nos. 0227 to 0240.

Further, the metal atoms (such as [Fe(CN)₆]⁴⁻) that can be contained in the silver halide grains to be used in the invention and the desalting method and chemical sensitization method of silver halide emulsions are described in JP-A No. 11-84574, paragraph Nos. 0046 to 0050, JP-A No. 11-65021, paragraph Nos. 0025 to 0031, and JP-A No. 11-119374, paragraph Nos. 0242 to 0250.

3) Gelatin:

As gelatin that is contained in the photosensitive silver halide emulsion to be used in the invention, various gelatins can be used. For the sake of keeping the dispersion state of the photosensitive silver halide emulsion in the organic silver salt-containing coating liquid good, it is preferable to use a low molecular weight gelatin having a molecular weight of 500 to 60,000. Though such low molecular weight gelatin may be used upon the grain formation or upon dispersion after the desalting processing, it is preferable to use it upon dispersion after the desalting processing.

4) Sensitizing Dye:

The photosensitive silver halide of the invention may be sensitized with a sensitizing dye. As the sensitizing dye that can be applied in the invention, sensitizing dyes that when adsorbed on the silver halide grains, can spectrally sensitize the silver halide grains in a desired wavelength region and have spectral sensitivity suited for spectral characteristics of an exposure source can be advantageously selected. With respect to the sensitizing dye and the addition method thereof, compounds described in JP-A No. 11-65021, paragraph Nos. 0103 to 0109 and represented by the general formula (II) of JP-A No. 10-186572, dyes represented by the general formula (I) of JP-A No. 11-119374, dyes described in U.S. Pat. No. 5,510,236 and Example 5 of U.S. Pat. No. 3,871,887, dyes described in JP-A Nos. 2-96131, 59-48753, 2001-272747, 2001-290238 and 2002-23306 and descriptions of EP-A No. 0803764, page 19, line 38 to page 20, line 35 can be made hereof by reference. The sensitizing dye may be used singly or in admixture of two or more thereof. In the invention, the period when the sensitizing dye is added in the silver halide emulsion is preferably the period after the desalting step until coating, and more preferably the period after desalting until initiation of chemical ripening.

In the invention, the addition amount can be set to a desired amount depending upon sensitivity or fogging performance and is preferably 10⁻⁶ to 1 mole, and more preferably 10⁻⁴ to 10⁻¹ moles per mole the silver halide of the photosensitive layer.

For the sake of improving the spectral sensitization efficiency of the invention, a supersensitizer can be used. As the supersensitizer that is used in the invention, compounds described in EP-A No. 587,388, U.S. Pat. Nos. 3,877,943 and 4,873,184, and JP-A Nos. 5-341432, 11-109547 and 10-111543 can be enumerated.

5) Chemical Sensitization:

It is preferable that the photosensitive silver halide grains are subjected to chemical sensitization by sulfur sensitization, selenium sensitization, or tellurium sensitization. As compounds that are preferably used in the sulfur sensitization, selenium sensitization, or tellurium sensitization, known compounds such as compounds described in JP-A No. 7-128768 can be used. The tellurium sensitization is specially preferable in the invention, and compounds described in the documents cited in JP-A No. 11-65021, paragraph No. 0030 and compounds represented by the general formulae (II), (III) and (IV) of JP-A No. 5-313284 are more preferable.

In the invention, the chemical sensitization can be carried out in any period after the grain formation and before coating, such as (1) before spectral sensitization, (2) simultaneously with spectral sensitization, (3) after spectral sensitization, and (4) immediately before coating, after the desalting. It is especially preferable that the chemical sensitization is carried out after spectral sensitization.

The amount of a sulfur, selenium or tellurium sensitizer to be used in the invention varies depending upon the silver halide grains to be used, the chemical ripening condition, and the like but is usually about 10⁻⁸ to 10⁻² moles, and preferably about 10⁻⁷ to 10⁻³ moles per mole of the silver halide. In the invention, the chemical sensitization condition is not particularly limited, but the pH is from 5 to 8, the pAg is from 6 to 11, and the temperature is from about 40 to 95° C.

To the silver halide emulsion to be used in the invention, a thiosulfonic acid compound may be added by a method described in EP-A No. 293,917.

6) Compound in Which a One Electron Oxidant Formed Upon One Electron Oxidation can Further Release One or More Electrons by Subsequent Reaction:

It is preferable that photothermographic material of the invention contains a compound in which a one electron oxidant formed upon one electron oxidation can further release one or more electrons by subsequent reaction.

The compound in which a one electron oxidant formed upon one electron oxidation can further release one or more electrons by subsequent reaction as referred to herein is a compound selected from the following types 1 to 5.

(Type 1)

Compound in which a one electron oxidant formed upon one electron oxidation can further release two or more electrons while causing subsequent bond cleavage reaction.

(Type 2)

Compound in which a one electron oxidant formed upon one electron oxidation can further release another electron while causing subsequent bond cleavage reaction and which has two or more adsorptive groups onto silver halide in the same molecule.

(Type 3)

Compound in which a one electron oxidant formed upon one electron oxidation can further release one or more electrons after subsequent bond forming step.

(Type 4)

Compound in which a one electron oxidant formed upon one electron oxidation can further release one or more electrons after subsequent intramolecular ring cleavage reaction.

(Type 5)

Compound in which a one electron oxidant formed upon one electron oxidation of a reducible group represented by X in a compound represented by X—Y (wherein X represents a reducible group, and Y is a split-off group) splits off Y while causing subsequent cleavage reaction of X—Y bond, to form X radicals, from which another electron can be released.

Among the compounds of the type 1 and types 3 to 5, “compounds having an adsorptive group onto silver halide in the molecule” or “compounds having a partial structure of spectral sensitizing dye in the molecule” are preferable, and “compounds having an adsorptive group onto silver halide in the molecule” are more preferable.

The compounds of the types 1 to 5 will be described below in detail.

In the compound of the type 1, the “bond cleavage reaction” as referred to herein concretely means cleavage of bond between respective elements of carbon-carbon, carbon-silicon, carbon-hydrogen, carbon-boron, carbon-tin, or carbon-germanium, and cleavage of carbon-hydrogen bond may be accompanied therewith.

The compound of the type 1 is a compound in which a one electron oxidant formed upon one electron oxidation can first release two or more electrons (preferably three or more electrons) while causing bond cleavage reaction. In another word, this compound is a compound in which two or more electrons (preferably three or more electrons) can be oxidized.

Of compounds of the type 1, compounds represented by the formula (A), formula (B), formula (1), formula (2), and formula (3) are preferable.

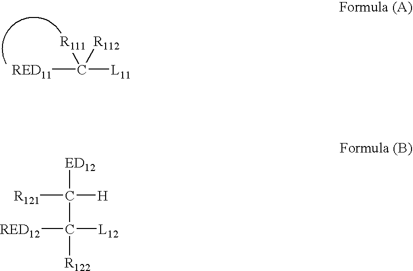

In the formula (A), RED₁₁ represents a reducible group capable of being subjected to one electron oxidation, and L₁₁ represents a split-off group.

R₁₁₂ represents a hydrogen atom or a substituent.

R¹¹¹ represents a non-metallic atomic group capable of forming a specific 5-membered or 6-membered cyclic structure together with the carbon atom (C) and RED₁₁.

The “specific 5-membered or 6-membered cyclic structure” as referred to herein means a cyclic structure corresponding to a tetrahydro body, hexahydro body or octahydro body of a 5-membered or 6-membered aromatic ring (including an aromatic heterocycle).

In the formula (B), RED₁₂ represents a reducible group that can be subjected to one electron oxidation, and L₁₂ represents a split-off group.

R₁₂₁ and R₁₂₂ each represent a hydrogen atom or a substituent, and ED₁₂ represents an electron donating group.

In the formula (B), R₁₂₁ and RED₁₂, R₁₂, and R₁₂₂, or ED₁₂ and RED₁₂ may be bonded to each other to form a cyclic structure.

These compounds are a compound in which by subjecting the reducible group represented by RED₁₁ or RED₁₂ of the formula (A) or formula (B) to one electron oxidation and then spontaneously splitting off L₁₁ or L₁₂ by bond cleavage reaction, i.e., cleavage of the C (carbon atom)-L₁₁ bond or C (carbon atom)-L₁₂ bond, two or more electrons, and preferably three or more electrons can be released.

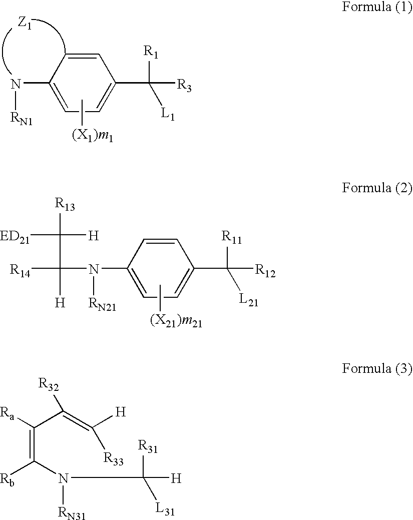

In the formula (1), Z₁ represents an atomic group capable of forming a 6-membered ring together with the nitrogen atom and the two carbon atoms of the benzene ring; R₁, R₂, and R_{N1} each represent a hydrogen atom or a substituent; X₁ represents a substituent capable of being substituted on the benzene ring; m₁ represents an integer from 0 to 3; and L₁ represents a split-off group.

In the formula (2), ED₂₁ represents an electron donating group; R₁₁, R₁₂, R_{N21}, R₁₃, and R₁₄ each represent a hydrogen atom or a substituent; X₂₁ represents a substituent capable of being substituted on the benzene ring; m₂₁ represents an integer from 0 to 3; and L₂₁ represents a split-off group.

R_{N21}, R₁₃, R₁₄, X₂₁, and ED₂₁ may be bonded to each other to form a cyclic structure.

In the formula (3), R₃₂, R₃₃, R₃₁, R_{N31}, Rₐ, and R_{b} each represent a hydrogen atom or a substituent, and L₃, represents a split-off group.

However, when R_{N3}, represents a group other than an aryl group, Rₐ and R_{b} are bonded to each other to form an aromatic ring.

These compounds are a compound in which by subjecting the reducible group represented by L₁, L₂₁, or L₃₁ to one electron oxidation and then spontaneously splitting off L₁, L₂₁, or L₃₁ by bond cleavage reaction, i.e., cleavage of the C (carbon atom)-L₁ bond, C (carbon atom)-L₂, bond, or C (carbon atom)-L₃, bond, two or more electrons, and preferably three or more electrons can be released.

First of all, compounds represented by the formula (A) will be described below in detail.

In the formula (A), the reducible group capable of being subjected to one electron oxidation as represented by RED₁₁ is a group capable of forming a specific ring by bonding to R₁₁₁ as described later. Specifically, divalent groups resulting from elimination of one hydrogen atom in a proper portion for forming a ring from the following monovalent group are enumerated.

Examples include an alkylamino group, an arylamino group (such as an anilino group and a naphthylamino group), a heterocyclic amino group (such as a benzthiazolylamino group and a pyrrolylamino group), an alkylthio group, an arylthio group (such as a phenylthio group), a heterocyclic thio group, an alkoxy group, an aryloxy group (such as a phenoxy group), a heterocyclic oxy group, an aryl group (such as a phenyl group, a naphthyl group, and an anthranyl group), and an aromatic or non-aromatic heterocyclic group (such as heterocycles containing at least one hetero atom of a nitrogen atom, a sulfur atom, an oxygen atom, and a selenium atom of a 5-membered to 7-membered single ring or fused ring; and specific examples include a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine, a benzothiazoline ring, a pyrrole ring, an imidazole ring, a thiazoline ring, a piperidine ring, a pyrrolidine ring, a morpholine ring, a benzoimidazole ring, a benzoimidazoline ring, a benzoxazoline ring, and a methylenedioxyphenyl ring) (RED₁₁ will be hereinafter described in terms of monovalent group name for the sake of convenience). These groups may have a substituent.

Examples of substituents include a halogen atom, an alkyl group (including an aralkyl group, a cycloalkyl group, and an active methine group), an alkenyl group, an alkynyl group, an aryl group, a heterocyclic group (irrespective of the substitution position), a quaternary nitrogen atom-containing heterocyclic group (such as a pyridinio group, an imidazolio group, a quinolinio group, and an isoquinolinio group), an acyl group, an alkoxycarbonyl group, an aryloxycarbonyl group, a carbamoyl group, a carboxyl group or salts thereof, a sulfonylcarbamoyl group, an acylcarbamoyl group, a sulfamoylcarbamoyl group, a carbazoyl group, an oxalyl group, an oxamoyl group, a cyano group, a carbonimidoyl group, a thiocarbamoyl group, a hydroxyl group, an alkoxy group (including groups repeatedly containing an ethyleneoxy group or a propyleneoxy group), an aryloxy group, a heterocyclic oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamide group, a ureido group, a thioureido group, an imido group, an (alkoxy or aryloxy)carbonylamino group, a sulfamoylamino group, a semicarbazide group, a thiosemicarbazide group, a hydrazino group, an ammonio group, an oxamoylamino group, an (alkyl or aryl)sulfonylureido group, an acylureido group, an acylsulfamoylamino group, a nitro group, a mercapto group, an (alkyl, aryl or heterocyclic)thio group, an (alkyl or aryl)sulfonyl group, an (alkyl or aryl)sulfinyl group, a sulfo group or salts thereof, a sulfamoyl group, an acylsulfamoyl group, a sulfonylsulfamoyl group or salts thereof, and groups containing a phosphoric acid amide or phosphoric acid ester structure. These substituents may further be substituted with these substituents.

In the formula (A), L₁₁ represents a split-off group capable of being split off first by bond cleavage after one electron oxidation of the reducible group represented by RED₁₁, and specifically respresents a carboxy group or salts thereof, a silyl group, a hydrogen atom, a triarylboron anion, a trialkylstannyl group, a trialkylgermyl group, or a —CR_{C1}R_{C2}R_{C3} group.

When L₁₁ represents a salt of carboxy group, specific examples of counter ions of forming a salt include alkali metal ions (such as Li⁺, Na⁺, K⁺, and Cs⁺), alkaline earth metal ions (such as Mg²⁺, Ca²⁺, and Ba²⁺), heavy metal ions (such as Ag+ and Fe^{2+/3+}), an ammonium ion, and a phosphonium ion.

When L₁₁ represents a silyl group, the “silyl group” as referred to herein specifically represents a trialkylsilyl group, an aryldialkylsilyl group, or a triarylsilyl group. The “alkyl group” as referred to herein includes methyl, ethyl, benzyl, and t-butyl groups, and the “aryl group” as referred to herein includes a phenyl group.

When L₁₁ represents a triarylboron anion, the aryl group is preferably a substituted or unsubstituted phenyl group. Examples of substituents include the same substituents that RED₁₁ may have.

When L₁₁ represents a trialkylstannyl group or a trialkylgermyl group, the “alkyl group” as referred to herein is a linear, branched or cyclic alkyl group having 1 to 24 carbon atoms, which may have a substituent. Examples of substituents include the same substituents that RED₁₁ may have.

When L₁₁ represents a —CR_{C1}R_{C2}R_{C3} group, R_{C1}, R_{C2}, and R_{C3} each independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group, or a hydroxyl group, and R_{C1}, R_{C2}, and R_{C3} may be bonded to each other to form a cyclic structure and may have a substituent.

Examples of substituents include the same substituents that RED₁₁ may have.

However, when one of R_{C1}, R_{C2}, and R_{C3} represents a hydrogen atom or an alkyl group, the remaining two do not represent a hydrogen atom or an alkyl group.

Preferably, R_{C1}, R_{C2}, and R_{C3} each independently represent an alkyl group, an aryl group (especially a phenyl group), an alkylthio group, an arylthio group, an alkylamino group, an arylamino group, a heterocyclic group, an alkoxy group, or a hydroxyl group. Specific examples include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, and a hydroxyl group.

Also, in the case where R_{C1}, R_{C2}, and R_{C3} are bonded to each other to form a cyclic structure, examples include a 1,3-dithiolan-2-yl group, a 1,3-dithian-2-yl group, an N-methyl-1,3-thiazolidin-2-yl group, and an N-benzyl-benzothiazolidin-2-yl group.

Preferred examples of the —CR_{C1}R_{C2}R_{C3} group include a trityl group, a tri-(p-hydroxyphenyl)methyl group, a 1, 1-diphenyl-1-(p-dimethylaminophenyl)methyl group, a 1,1-diphenyl-1-(methylthio)methyl group, a 1-phenyl-1,1-(dimethylthio)methyl group, a 1,3-dithiolan-2-yl group, a 2-phenyl-1,3-dithiolan-2-yl group, a 1,3-dithian-2-yl group, a 2-phenyl-1m3-dithian-2-yl group, a 2-methyl-1,3-dithian-2-yl group, an N-methyl-1,3-thiazolidin-2-yl group, a 2-methyl-3-methyl-1,3-thiazolidin-2-yl group, an N-benzyl-benzothiazolidin-2-yl group, a 1,1-diphenyl-1-dimethylaminomethyl group, and a 1,1-diphenyl-1-morpholinomethyl group.

Also, the case where as a result of selecting each of R_{C1}, R_{C2}, and R_{C3} within the foregoing range, the —CR_{C1}R_{C2}R_{C3} group represents the same group as the residue resulting from elimination of L₁₁ from the formula (A) is preferable.

In the formula (A), R₁₁₂ represents a hydrogen atom or a substituent capable of being substituted on the carbon atom. When R₁₁₂ represents a substituent capable of being substituted on the carbon atom, specific examples of the substituent are the same as in the substituent when RED₁₁ has a substituent.

However, R₁₁₂ does not represent the same group as in L₁₁.

In the formula (A), R₁₁₁ represents a non-metallic atomic group capable of forming a specific 5-membered or 6-membered cyclic structure together with the carbon atom (C) and RED₁₁.

The “specific 5-membered or 6-membered cyclic structure” formed by R₁₁₁ as referred to herein means a cyclic structure corresponding to a tetrahydro body, hexahydro body or octahydro body of a 5-membered or 6-membered aromatic ring (including an aromatic heterocycle).

The “hydro body” as referred to herein means a ring structure in which a carbon-carbon double bond (or a carbon-nitrogen double bond) inherent in an aromatic ring (including an aromatic heterocycle) is partially hydrogenated; the “tetrahydro body” as referred to herein means a structure in which two carbon-carbon double bonds (or carbon-nitrogen double bonds) are hydrogenated; the “hexahydro body” as referred to herein means a structure in which three carbon-carbon double bonds (or carbon-nitrogen double bonds) are hydrogenated; and the “octahydro body” as referred to herein means a structure in which four carbon-carbon double bonds (or carbon-nitrogen double bonds) are hydrogenated. When hydrogenated, the aromatic ring becomes a partially hydrogenated non-aromatic ring structure.

Concretely, in the case of a 5-membered single ring, examples include a pyrrolidine ring, an imidazolidine ring, a thiazolidine ring, a pyrazolidine ring, and an oxazolidine ring, corresponding to a tetrahydro body of an aromatic ring such as a pyrrole ring, an imidazole ring, a thiazole ring, a pyrazole ring, and an oxazole ring.

In the case of a 6-membered single ring, examples include a piperidine ring, a tetrahydropyridine ring, a tetrahydropyrimidine ring, and a piperazine ring, corresponding to a tetrahydro body or a hexahydro body of an aromatic ring such as a pyridine ring, a pyridazine group, a pyrimidine ring, and a pyrazine ring.

In the case of a 6-membered fused ring, examples include a tetraline ring, a tetrahydroquinoline ring, a tetrahydroisoquinoline ring, a tetrahydroquinazoline ring, and a tetrahydroquinoxaline ring, corresponding to a tetrahydro body of an aromatic ring such as a naphthalene ring, a quinoline ring, an isoquinoline ring, a quanozoline ring, and a quinoxaline ring. In the case of a tricyclic compound, examples include a tetrahydrocarbazole ring corresponding to a tetrahydro body of a carbazole ring and an octahydrophenanthridine ring corresponding to an octahydro body of a phenanthridine ring.

These ring structures may further be substituted. Examples of substituents include the same substituents that RED₁₁ may have.

In these ring structures, the substituents may further be connected to each other to form a ring. The ring newly formed herein is a non-aromatic carbocycle or heterocycle.

Next, preferred ranges of compounds represented by the formula (A) of the invention will be described below.

In the formula (A), L₁₁ is preferably a carboxy group or a salt thereof, or a hydrogen atom, and more preferably a carboxy group or a salt thereof.

As the counter ion of the salt, alkali metal ions and an ammonium ion are preferable, and alkali metal ions (especially Li⁺, Na⁺ and K⁺ ions) are most preferable.

When L₁₁ represents a hydrogen atom, it is preferable that the compound represented by the formula (A) has a base site inherent in the molecule.

By the action of this base site, the compound represented by the formula (A) is oxidized, and the hydrogen atom represented by L₁₁ is then deprotonated, from which electrons are further released.

The base as referred to herein is specifically a conjugated base of an acid exhibiting a pKa of about 1 to about 10. Examples include nitrogen-containing heterocycles (such as pyridines, imidazoles, benzoimidazoles, and thiazoles), anilines, trialkylamines, an amino group, carbon acids (such as an active methylene anion), a thioacetic acid anion, carboxylate (—COO⁻), sulfate (—SO₃⁻), and amine oxide (>N⁺(O⁻)—).

Conjugated bases of an acid exhibiting a pKa of about 1 to about 8 are preferable; carboxylate, sulfate, and amine oxide are more preferable; and carboxylate is most preferable.

When the base has an anion, the base may have a counter cation. Examples include alkali metal ions, alkaline earth metal ions, heavy metal ions, an ammonium ion, and a phosphonium ion.

Such a base is connected to the compound represented by the formula (A) at an arbitrary position. The position at which the base site is bound may be any of RED₁₁, R₁₁₁, and R₁₁₂ of the formula (A). Also, the base may be connected to a substituent of such a group.

When L₁₁ represents a hydrogen atom, it is preferable that the hydrogen atom and the base site are connected to each other via a group of not more than 8 atoms. Further, it is more preferable that the hydrogen atom and the base site are connected to each other via a group of 5 to 8 atoms.

Ones to be counted as the connecting atomic group are an atomic group connecting the central atom in the base site (that is, an atom having an anion or an atom having a lone electron pair) to the hydrogen atom via a covalent bond. For example, in the case of carboxylate, two atoms of —C—O⁻ are counted, and in the case of sulfate, two atoms of S—O⁻ are counted.

Also, the carbon atom represented by C of the formula (A) is included in that number.

In the formula (A), when L₁₁ represents a hydrogen atom, RED₁₁ represents an aniline, and the nitrogen atom thereof forms a 6-membered mono-cyclic saturated ring structure (such as a piperidine ring, a piperazine ring, a morpholine ring, a thiomorpholine ring, and a seleno-morpholine ring) together with R₁₁₁, it is preferable that the compound has an adsorptive group onto silver halide in the molecule. Also, it is more preferable that the compound simultaneously has a base site inherent in the molecule, and the base site is connected to the hydrogen atom via a group of not more than 8 atoms.

In the formula (A), RED₁₁ is preferably an alkylamino group, an arylamino group, a heterocyclic amino group, an aryl group, or an aromatic or non-aromatic heterocyclic group. As the heterocyclic group, a tetrahydroquinolinyl group, a tetrahydroquinoxalinyl group, a tetrahydroquinazolinyl group, an indolyl group, an indolenyl group, a carbazolyl group, a phenoxazinyl group, a phenothiazinyl group, a benzothiazolinyl group, a pyrrolyl group, an imidazolyl group, a thiazolidinyl group, a benzoimidazolyl group, a benzoimidazolinyl group, and a 3,4-methylenedioxyphenyl-1-yl group are preferable.

RED₁₁ is more preferably an arylamino group (especially an anilino group) or an aryl group (especially a phenyl group).

Here, when RED₁₁ represents an aryl group, it is preferable that the aryl group has at least one electron donating group (the number of electron donating groups is preferably not more than 4, and more preferably not more than 3).

The “electron donating group” as referred to herein means a hydroxyl group, an alkoxy group, a mercapto group, a sulfonamide group, an acylamino group, an alkylamino group, an arylamino group, a heterocyclic amino group, an active methine group, an electron excessive aromatic heterocyclic ring (such as an indolyl group, a pyrrolyl group, an imidazoyl group, a benzoimidazolyl group, a thiazolyl group, a benzthiazolyl group, and an imdazolyl group), or a nitrogen atom-substituted non-aromatic nitrogen-containing heterocyclic group (such as a pyrrolidinyl group, an indolynyl group, a piperidinyl group, a piperazinyl group, and a morpholino group).

The “active methine group” as referred to herein means a methine group substituted with two electron withdrawing groups. The “electron withdrawing group” as referred to herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. Here, the two electron withdrawing groups may be bonded to each other to form a cyclic structure.

When RED₁₁ represents an aryl group, the substituent of the aryl group is more preferably an alkylamino group, a hydroxyl group, an alkoxy group, a mercapto group, a sulfonamide group, an active methine group, or a nitrogen atom-substituted non-aromatic nitrogen-containing hetero-cyclic group; further preferably an alkylamino group, a hydroxyl group, an active methine group, or a nitrogen atom-substituted non-aromatic nitrogen-containing heterocyclic group; and most preferably an alkylamino group or a nitrogen atom-substituted non-aromatic nitrogen-containing heterocyclic group.

In the formula (A), R₁₁₂ is preferably a hydrogen atom, an alkyl group, an aryl group (such as a phenyl group), an alkoxy group (such as a methoxy group, an ethoxy group, and a benzyloxy group), a hydroxyl group, an alkylthio group (such as a methylthio group and a butylthio group), an amino group, an alkylamino group, an arylamino group, or a heterocyclic amino group, and more preferably a hydrogen atom, an alkyl group, an alkoxy group, a hydroxyl group, a phenyl group, or an alkylamino group.

In the formula (A), R₁₁₁ is a non-metallic atomic group capable of forming a specific 5-membered or 6-membered cyclic structure together with the carbon atom (C) and RED₁₁. Examples include a pyrrolidine ring or an imidazolidine ring, corresponding to a tetrahydro body of a pyrrole ring or an imidazole ring as a monocyclic 5-membered aromatic ring; a heterahydro body or hexahydro body (such as a piperidine ring, a tetrahydropyridine ring, a tetrahydropyrimidine ring, and a piperazine ring) of a pyridine ring, a pyridazine ring, a pyrimidine ring, or a pyrazine ring as a monocyclic 6-membered aromatic ring; a tetraline ring, a tetrahydroquinoline ring, a tetrahydroisoquinoline ring, a tetrahydroquinazoline ring, or a tetrahydroquinoxaline ring, corresponding to a tetrahydro body of a naphthalene ring, a quinoline ring, an isoquinoline ring, a quinazoline ring, or a quinoxaline ring as a fused 6-membered aromatic ring; and a tetrahydrocarbazole ring corresponding to a tetrahydro body of a carbazole ring or an octahydrophenanthridine ring corresponding to an octahydro body of a phenanthridine ring as a tricyclic aromatic ring.

The cyclic structure formed by R₁₁₁ is further preferably a pyrrolidine ring, an imidazolidine ring, a piperidine ring, a tetrahydropyridine ring, a tetrahydropyrimidine ring, a piperazine ring, a tetrahydroquinoline ring, a tetrahydroquinazoline ring, a tetrahydroquinoxaline ring, or a tetrahydrocarbazole ring; especially preferably a pyrrolidine ring, a piperidine ring, a piperazine ring, a tetrahydroquinoline ring, a tetrahydroquinazoline ring, a tetrahydroquinoxaline ring, or a tetrahydrocarbazole ring; and most preferably a pyrrolidine ring, a piperidine ring, or a tetrahydroquinoline ring.

Next, the formula (B) will be described below in detail.

In the formula (B), RED₁₂ and L₁₂ are respectively synonymous with RED₁₁ and L₁₁ in the formula (A), and preferred ranges thereof are also the same.

However, RED₁₂ is a monovalent group other than the case where it forms the following cyclic structure, and specific examples thereof include the groups of monovalent groups names described in RED₁₁.

R₁₂₁ and R₁₂₂ are synonymous with R₁₁₂ in the formula (A), and preferred ranges thereof are also the same. ED₁₂ represents an electron donating group.

R₁₂₁ and RED₁₂, R₁₂₁ and R₁₂₂, or ED₁₂ and RED₁₂ may be bonded to each other for a cyclic structure.

In the formula (B), examples of the electron donating group represented by ED₁₂ include a hydroxyl group, an alkoxy group, a mercapto group, an alkylthio group, an arylthio group, a heterocyclic thio group, a sulfonamide group, an acylamino group, an alkylamino group, an arylamino group, a heterocyclic amino group, an active methine group, an electron excessive aromatic heterocyclic ring (such as an indolyl group, a pyrrolyl group, and an indazolyl group), a nitrogen atom-substituted non-aromatic nitrogen-containing heterocyclic group (such as a pyrrolidinyl group, a piperidinyl group, an indolynyl group, a piperazinyl group, and a morpholino group), and an aryl group substituted with such an electron donating group (such as a p-hydroxyphenyl group, a p-dialkylaminophenyl group, an o,p-dialkoxyphenyl group, and a 4-hydroxynaphthyl group).

The “active methine group” as referred to herein is the same as that described above as the substituent when RED₁₁ represents an aryl group.

ED₁₂ is preferably a hydroxyl group, an alkoxy group, a mercapto group, a sulfonamide group, an alkylamino group, an arylamino group, an active methine group, an electron excessive aromatic heterocyclic group, a nitrogen atom-substituted non-aromatic nitrogen-containing heterocyclic group, or a phenyl group substituted with such an electron donating group; and more preferably a hydroxyl group, a mercapto group, a sulfonamide group, an alkylamino group, an arylamino group, an active methine group, a nitrogen atom-substituted non-aromatic nitrogen-containing heterocyclic group, or a phenyl group substituted with such an electron donating group (such as a p-hydroxyphenyl group, a p-dialkylaminophenyl group, and an o,p-dialkoxyphenyl group).

In the formula (B), R₁₂₁ and RED₁₂, R₁₂₁ and R₁₂₂, or ED₁₂ and RED₁₂ may be bonded to each other to form a cyclic structure.

The cyclic structure formed herein is a non-aromatic carbocycle or heterocycle, which is a 5-membered to 7-membered single ring or fused ring and is of a substituted or unsubstituted cyclic structure. When R₁₂₁ and RED₁₂ form a ring structure, examples include a pyrrolidine ring, a pyrroline ring, an imdazolidine group, an imidazoline group, a thiazolidine group, a thiazoline ring, a pyrazolidine ring, a pyrazoline ring, an oxazolidine ring, an oxazoline ring, an indane ring, a piperidine ring, a piperazine ring, a morpholine ring, a tetrahydropyridine ring, a tetra-hydropyrimidine ring, an indoline ring, a tetraline ring, a tetrahydroquinoline ring, a tetrahydroisoquinoline ring, a tetrahydroquinoxaline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, and a 2,3-dihydrobenzothiophene ring.

When ED₁₂ and RED₁₂ form a ring structure, ED₁₂ preferably represents an amino group, an alkylamino group, or an arylamino group, and specific examples of the ring structure to be formed include a tetrahydropyradine ring, a piperazine ring, a tetrahydroquinoxaline ring, and a tetrahydroisoquinoline ring.

When R₁₂₂ and R₁₂₁ form a ring structure, examples of the ring structure to be formed include a cyclohexane ring and a cyclopentane ring.

Of the compounds represented by the formula (A) of the invention, those represented by the following formulae (10) to (12) are preferable; and of the compounds represented by the formula (B), those represented by the following formulae (13) and (14) are preferable.

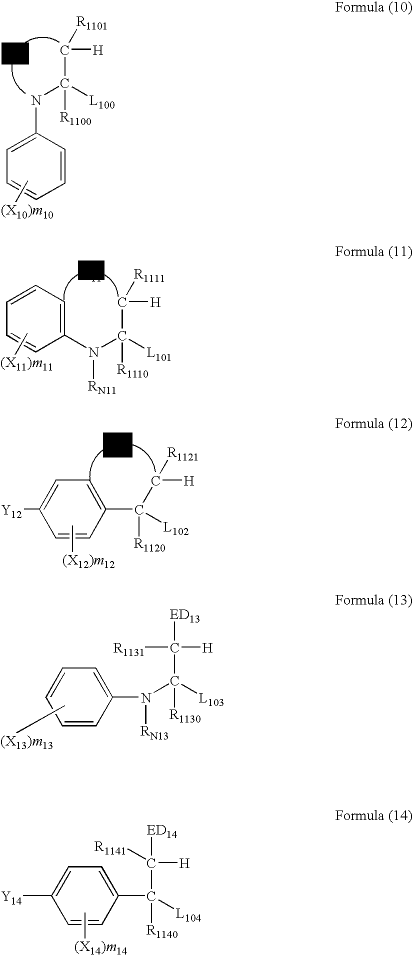

In the formulae (10) to (14), L₁₀₀, L₁₀₁, L₁₀₂, L₁₀₃, and L₁₀₄ each represent a group synonymous with L₁₁ in the formula (A), and preferred ranges thereof are also the same.

R₁₁₀₀ and R₁₁₀₁, R₁₁₁₀ and R₁₁₁₁, R₁₁₂₀ and R₁₁₂₁, R₁₁₃₀ and R₁₁₃₁, and R₁₁₄₀ and R₁₁₄₁ each represent a group synonymous with R₁₂₂ and R₁₂₁ in the formula (B), and preferred ranges thereof are also the same.

ED₁₃ and ED₁₄ each represent a group synonymous with ED₁₂ in the formula (B), and preferred ranges thereof are also the same.

X₁₀, X₁₁, X₁₂, X₁₃, and X₁₄ each represent a substituent capable of being substituted on the benzene ring; and m₁₀, m₁₁, m₁₂, m₁₃, and m₁₄ each represent an integer from 0 to 3, and when m₁₀, m₁₁, m₁₂, m₁₃, or m₁₄ represents 2 or 3, plural X₁₀, X₁₁, X₁₂, X₁₃, or X₁₄ are the same as or different from each other.

Y₁₂ and Y₁₄ each represent an amino group, an alkylamino group, an arylamino group, a nitrogen atom-substituted non-aromatic nitrogen-containing heterocyclic group (such as a pyrrolyl group, a piperidinyl group, an indolinyl group, a piperazino group, and a morpholino group), a hydroxyl group, or an alkoxy group.

Z₁₀, Z₁₁, and Z₁₂ each represent a non-metallic atomic group capable of forming a specific ring structure.

The specific ring structure formed by Z₁₀ is a ring structure corresponding to a tetrahydro body or hexahydro body of a 5-membered or 6-membered, monocyclic or fused nitrogen-containing aromatic heterocycle. Specific examples include a pyrrolidine ring, an imidazolidine ring, a thiazolidine ring, a pyrazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, and a tetrahydroquinoxaline ring.

The specific ring structure formed by Z₁₁ is a tetrahydroquinoline ring or a tetrahydroquinoxaline ring.

The specific ring structure formed by Z₁₂ is a tetraline ring, a tetrahydroquinoline ring, or a tetrahydroisoquinoline ring.

R_{N11} and R_{N13} each represent a hydrogen atom or a substituent capable of being substituted on the nitrogen atom. Specific examples of the substituent include an alkyl group, an alkenyl group, an alkynyl group, an aryl group, a heterocyclic group, and an acyl group, and of these groups, an alkyl group and an aryl group are preferable.

As the substituent capable of being substituted on the benzene ring represented by X₁₀, X₁₁, X₁₂, X₁₃, and X₁₄, the same examples of the substituent that RED₁₁ in the formula (A) may have can be enumerated as specific examples thereof.

Preferred examples include a halogen atom, an alkyl group, an aryl group, a heterocyclic group, an acyl group, an alkoxycarbonyl group, an aryloxycarbonyl group, a carbamoyl group, a cyano group, an alkoxy group (including groups repeatedly containing an ethyleneoxy group or a propyleneoxy group), an (alkyl, aryl or heterocyclic)amino group, an acylamino group, a sulfonamide group, a ureido group, a thioureido group, an imido group, an (alkoxy or aryloxy)carbonylamino group, a nitro group, an (alkyl, aryl or heterocyclic)thio group, an (alkyl or aryl)sulfonyl group, and a sulfamoyl group.

m₁₀, m₁₁, m₁₂, m₁₃, and m₁₄ are each preferably 0 to 2, and more preferably 0 or 1.

Y₁₂ and Y₁₄ each preferably an alkylamino group, an arylamino group, a nitrogen atom-substituted non-aromatic nitrogen-containing heterocyclic group, a hydroxyl group, or an alkoxy group; more preferably an alkylamino group, a nitrogen atom-substituted 5-membered or 6-membered non-aromatic nitrogen-containing heterocyclic group, or a hydroxyl group; and most preferably an alkylamino group (especially a dialkylamino group) or a nitrogen atom-substituted non-aromatic nitrogen-containing heterocyclic group.

In the formula (13), R₁₁₃, and X₁₃, R₁₁₃, and R_{N13}, R₁₁₃₀ and X₁₃, or R₁₁₃₀ and R_{N13} may be bonded to form a cyclic structure.

Also, in the formula (14), R₁₁₄, and X₁₄, R₁₁₄₁ and R₁₁₄₀, ED₁₄ and X₁₄, or R₁₁₄₀ and X₁₄ may be bonded to each other to form a cyclic structure.

Here, the cyclic structure to be formed is a non-aromatic carbocycle or heterocycle, which is a 5-membered to 7-membered single ring or fused ring and is of a substituted or unsubstituted cyclic structure. In the formula (13), the case where R₁₁₃₁ and X₁₃ are bonded to each other to form a cyclic structure and the case where R₁₁₃₁ and R_{N13} are bonded to each other to form a cyclic structure are preferred examples of the compound represented by the formula (13) likewise the case where no ring structure is formed.

In the formula (13), specific examples of the ring structure formed by R₁₁₃, and X₁₃ include an indoline ring (in that case, R₁₁₃₁ represents a single bond), a tetrahydroquinoline ring, a tetrahydroquinoxaline ring, a 2,3-dihydrobenzo-1,4-oxazine ring, and a 2,3-dihydrobenzo-1,4-thiazine ring.

Of these rings, an indoline ring, a tetrahydroquinoline ring, and a tetrahydroquinoxaline ring are especially preferable.

In the formula (13), specific examples of the ring structure formed by R₁₁₃₁ and R_{N13} include a pyrrolidine ring, a pyrroline ring, an imidazolidine ring, an imidazoline ring, a thiazolidine ring, a thiazoline ring, a pyrazolidine ring, a pyrazoline ring, an oxazolidine ring, an oxazoline ring, a piperidine ring, a piperazine ring, a morpholine ring, a tetrahydropyridine ring, a tetrahydropyrimidine ring, an indoline ring, a tetrahydroquinoline ring, a tetrahydroisoquinoline ring, a tetrahydroquinoxaline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, and a 2,3-dihydrobenzothiophene ring.

Of these rings, a pyrrolidine ring, a piperidine ring, a tetrahydroquinoline ring, and a tetrahydroquinoxaline ring are especially preferable.

In the formula (14), the case where R₁₁₄₁ and X¹⁴ are bonded to each other to form a cyclic structure and the case where ED₁₄ and X₁₄ are bonded to each other to form a cyclic structure are preferred examples of the compound represented by the formula (14) likewise the case where no ring structure is formed.

In the formula (14), examples of the cyclic structure formed when R₁₁₄₁ and X₁₄ are bonded to each other include an indane ring, a tetraline ring, a tetrahydroquinoline ring, a tetrahydroisoquinoline ring, and an indoline ring.

Examples of the cyclic structure formed when Ed₁₄ and X₁₄ are bonded to each other include a tetrahydroisoquinoline ring and a tetrahydrocinnoline ring.

Next, the formulae (1) to (3) will be described below.

In the formulae (1) to (3), R₁, R₂, R₁₁, R₁₂, and R₃, each independently represent a hydrogen atom or a substituent, which is a group synonymous with R₁₁₂ in the formula (A). Preferred ranges thereof are also the same.

L₁, L₂₁, and L₃, each independently represent a split-off group, which is a group the same as in the specific examples of L₁₁ in the formula (A). Preferred ranges thereof are also the same.

X₁ and X₂, each independently represent a substituent capable of being substituted on the benzene ring, and examples include the same as in the substituent when RED₁₁ in the formula (A) has a substituent.

m₁ and m₂, each represent an integer from 0 to 3, preferably from 0 to 2, and more preferably 0 or 1.

R_{N1}, R_{N21}, and R_{N31} each represent a hydrogen atom or a substituent capable of being substituted on the nitrogen atom. The substituent is preferably an alkyl group, an aryl group, or a heterocyclic group, which may further have a substituent. As the substituent, those the same as in the substituent that RED₁₁ in the formula (A) may have are enumerated.

R_{N1}, R_{N21}, and R_{N31} are each preferably a hydrogen atom, an alkyl group, or an aryl group, and more preferably a hydrogen atom or an alkyl group.

R₁₃, R₁₄, R₃₂, R₃₃, Rₐ, and R_{b} each independently represent a hydrogen atom or a substituent capable of being substituted on the carbon atom.

As the substituent, those the same as in the substituent that RED₁₁ in the formula (A) may have are enumerated.

The substituent is preferably an alkyl group, an aryl group, an acyl group, an alkoxycarbonyl group, a carbamoyl group, a cyano group, an alkoxy group, an acylamino group, a sulfonamide group, a ureido group, a thioureido group, an alkylthio group, an arylthio group, an alkylsulfonyl group, an arylsulfonyl group, or a sulfamoyl group.

In the formula (1), Z₁ represents an atomic group capable of forming a 6-membered ring together with the nitrogen atoms and the two carbon atoms of the benzene ring.

The 6-membered ring formed by Z₁ is a non-aromatic heterocyclic ring fused with the benzene ring in the formula (1). Concretely, examples of the ring structure containing the benzene ring to be fused include a tetrahydroquinoline ring, a tetrahydroquinoxaline ring, and a tetrahydroquinazoline ring, each of which may have a substituent.

As the substituent, the same groups when R₁₁₂ in the formula (A) has a substituent are enumerated. Preferred ranges thereof are also the same.

In the formula (1), Z₁ preferably represents an atomic group of forming a tetrahydroquinoline ring or a tetrahydroquinoxaline ring together with the nitrogen atom and the two carbon atoms of the benzene ring.

In the formula (2), ED₂₁ represents an electron donating group, which is a group synonymous with ED₁₂ in the formula (B). Preferred examples thereof are also the same.

In the formula (2), any two of R_{N21}, R₁₃, R₁₄, X₂₁, and ED₂₁ may be bonded to each other to form a cyclic structure.

The cyclic structure formed when R_{N21} and X₂₁ are bonded to each other is preferably a 5-membered to 7-membered non-aromatic carbocycle or heterocycle fused with a benzene ring. Specific examples include a tetrahydroquinoline ring, a tetrahydroquinoxaline ring, an indoline ring, and a 2,3-dihydro-5,6-benzo-1,4-thiazine ring.

Of these rings, a tetrahydroquinoline ring, a tetrahydroquinoxaline ring, and an indoline ring are preferable.

In the formula (3), when R_{N3}, represents a group other than an aryl group, Rₐ and R_{b} are bonded to each other to form an aromatic ring.

The aromatic ring as referred to herein is an aryl group (such as a phenyl group and a naphthyl group) or an aromatic heterocyclic group (such as a pyridine ring group, a pyrrole ring group, a quinoline ring group, and an indole ring group), and preferably an aryl group.

The aromatic ring group may have a substituent. As the substituent, the same substituents as enumerated when X₁ in the formula (1) represents a substituent are enumerated. Preferred ranges thereof are also the same.

In the formula (3), it is preferable that Rₐ and R_{b} are bonded to each other to form an aromatic ring (especially a phenyl group).

In the formula (3), R₃₂ is preferably a hydrogen atom, an alkyl group, an aryl group, a hydroxyl group, an alkoxy group, a mercapto group, or an amino group. Here, the case where when R₃₂ represents a hydroxyl group, R₃₃ simultaneously represents an electron withdrawing group is a preferred example, too.

The “electron withdrawing group” as referred to herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group, and preferably an acyl group, an alkoxycarbonyl group, a carbamoyl group, or a cyano group.

Next, the compound of the type 2 will be described below.

The compound of the type 2 is a compound in which a one electron oxidant formed upon one electron oxidation can further releases another electron while causing subsequent bond cleavage reaction, in another word can be further subjected to one electron oxidation.

The “bond cleavage reaction” as referred to herein concretely means cleavage of bond between respective elements of carbon-carbon, carbon-silicon, carbon-hydrogen, carbon-boron, carbon-tin, or carbon-germanium, and cleavage of carbon-hydrogen bond may be accompanied therewith.

However, the compound of the type 2 is a compound having two or more (preferably from 2 to 6, and more preferably from 2 to 4) adsorptive groups onto silver halide in the molecule.

A compound having two or more mercapto group-substituted nitrogen-containing heterocyclic groups as adsorptive groups is more preferable.

The number of adsorptive groups is preferably from 2 to 6, and more preferably from 2 to 4. The adsorptive group will be described later.

Of the compounds of the type 2, compounds represented by the formula (C) are preferable.

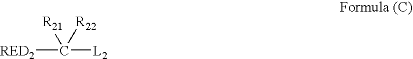

The compounds represented by the formula (C) are a compound in which by subjecting the reducible group represented by RED₂ to one electron oxidation and then spontaneously splitting off L₂ by bond cleavage reaction, i.e., cleavage of the C (carbon atom)-L₂ bond, one electron can further be released.

In the formula (C), RED₂ represents a group synonymous with RED₁₂ in the formula (B). Preferred ranges thereof are also the same.

L₂ represents a group synonymous with L₁₁ in the formula (A). Preferred ranges thereof are also the same.

When L₂ represents a silyl group, the resulting compounds are a compound having two or more mercapto group-substituted nitrogen-containing heterocyclic rings as adsorptive groups.

R₂₁ and R₂₂ each represent a hydrogen atom or a substituent, each of which is a group synonymous with R₁₁₂ in the formula (A). Preferred ranges thereof are also the same.

RED₂ and R₂₁ may be bonded to each other to form a ring structure.

Here, the ring structure to be formed is a 5-membered to 7-membered monocyclic or fused non-aromatic carbocycle or heterocycle, which may have a substituent.

However, the ring structure is not a ring structure corresponding to a tetrahydro body, hexahydro body or octahydro body of an aromatic ring or aromatic heterocycle.

As the substituent, the same groups when RED₁₁ in the formula (A) has a substituent are enumerated.

As the ring structure, ring structures corresponding to a dihydro body of an aromatic ring or aromatic heterocycle are preferable. Specific examples include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothazoline group, a benzoxazoline ring, a 2,3-dihydrobenzothiophene ring, a 2,3-dihydrobenzofuran ring, a benzo-2-α-pyran ring, a 1,2-dihydroquinoline ring, a 1,2-dihydroquinazoline ring, and a 1,2-dihydroquinoxaline ring.

Of these, a 2-imidazoline ring, a 2-thiazoline ring, an indoline ring, a benzoimidazoline ring, a benzothiazoline ring, a benzoxazoline ring, a 1,2-dihydropyridine ring, a 1,2-dihydroquinoline ring, a 1,2-dihydroquinazoline ring, and a 1,2-dihydroquinoxaline ring are preferable; an indoline ring, a benzoimidazoline ring, a benzothiazoline ring, and a 1,2-dihydroquinoline ring are more preferable; and an indoline ring is especially preferable.

Next, the compound of the type 3 will be described below.

The compound of the type 3 is a compound characterized in that a one electron oxidant formed upon one electron oxidation can further release one or more electrons after subsequent bond forming step. The “bond forming step” as referred to herein means formation of interatomic bond between carbon-carbon, carbon-nitrogen, carbon-sulfur, carbon-oxygen, etc.

The compound of the type 3 is preferably a compound characterized in that a one electron oxidant formed upon one electron oxidation subsequently reacts with a reactive group site co-present in the molecule (a carbon-carbon double bond site, a carbon-carbon triple bond site, an aromatic group site, or a non-aromatic heterocyclic group site of benzo fused ring) to form a bond, from which one or more electrons can be then released.

The one electron oxidant formed when the compound of the type 3 is subjected to one electron oxidation is a cation radical species but may possibly become a neutral radical species while causing splitting off of a proton therefrom.

This one electron oxidant (cation radical species or radical species) reacts with the carbon-carbon double bond site, carbon-carbon triple bond site, aromatic group site, or non-aromatic heterocyclic group site of benzo fused ring co-present in the same molecule to form an interatomic bond between carbon-carbon, carbon-nitrogen, carbon-sulfur, carbon-oxygen, etc., thereby forming a new ring structure in the molecule.

The compound of the type 3 has a characteristic such that simultaneously or thereafter, one or more electrons are further released.

The compound of the type 3 will be described in further detail. That is, the compound of the type 3 is characterized in that after one electron oxidation, a radical species having a ring structure is newly formed by this bond forming reaction, and a second electron is released directly from this radical species or while causing splitting off of a proton and oxidized.

The compound of the type 3 further includes one having an ability such that the thus formed two electron oxidant thereafter further releases one or more electrons, usually two or more electrons, or after subjecting to hydrolysis reaction as the case may be, or directly upon tautomerism reaction following the movement of proton as the case may be, whereby the compound is oxidized.

Alternatively, the compound of the type 3 includes one having an ability such that the two electron oxidant directly releases one or more electrons, usually two or more electrons without causing tautomerism reaction, whereby the compound is oxidized.

The compound of the type 3 is preferably represented by the formula (D).

Formula (D)

RED₃-L₃-Y₃

In the formula (D), RED₃ represents a reducible group capable of being subjected to one electron oxidation; and Y₃ represents a reactive group site that is reacted after RED₃ is subjected to one electron oxidation, specifically an organic group containing a carbon-carbon double bond site, a carbon-carbon triple bond site, an aromatic group site, or a non-aromatic heterocyclic group site of benzo fused ring.

L₃ represents a connecting group of connecting RED₃ to Y₃.

In the formula (D), RED₃ represents a group synonymous with RED₁₂ in the formula (B).

In the formula (D), RED₃ is preferably an arylamino group, a heterocyclic amino group, an aryloxy group, an arylthio group, an aryl group, or an aromatic or non-aromatic heterocyclic group (especially preferably a nitrogen-containing heterocyclic group), and more preferably an arylamino group, a heterocyclic amino group, an aryl group, or an aromatic or non-aromatic heterocyclic group. As the heterocyclic group, a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzoimidazole ring group, a benzoimidazoline ring group, a benzothiazoline ring group, and a 3,4-methylenedioxyphenyl-1-yl group are preferable.

RED₃ is especially preferably an arylamino group (especially an anilino group), an aryl group (especially a phenyl group), or an aromatic or non-aromatic heterocyclic group.

Here, when RED₃ represents an aryl group, it is preferable that the aryl group has at least one electron donating group.

The “electron donating group” as referred to herein means a hydroxyl group, an alkoxy group, a mercapto group, an alkylthio group, a sulfonamide group, an acylamino group, an alkylamino group, an arylamino group, a heterocyclic amino group, an active methine group, an electron excessive aromatic heterocyclic ring group (such as an indolyl group, a pyrrolyl group, and an indazolyl group), or a nitrogen atom-substituted non-aromatic nitrogen-containing heterocyclic group (such as a pyrrrolidinyl group, an indolinyl group, a piperidinyl group, a piperazinyl group, a morpholino group, and a thiomorpholino group).

The “active methine group” as referred to herein means a methine group substituted with two electron withdrawing groups. The “electron withdrawing group” as referred to herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group.

Here, the two electron withdrawing groups may be bonded to each other to form a cyclic structure.

When RED₃ represents an aryl group, the substituent of the aryl group is more preferably an alkylamino group, a hydroxyl group, an alkoxy group, a mercapto group, a sulfonamide group, an active methine group, or a nitrogen atom-substituted non-aromatic nitrogen-containing hetero-cyclic group; further preferably an alkylamino group, a hydroxyl group, an active methine group, or a nitrogen atom-substituted non-aromatic nitrogen-containing heterocyclic group; and most preferably an alkylamino group or a nitrogen atom-substituted non-aromatic nitrogen-containing heterocyclic group.

In the formula (D), when the reactive group represented by Y₃ represents a substituted organic group containing a carbon-carbon double bond or a carbon-carbon triple bond, the substituent is preferably an alkyl group (preferably ones having 1 to 8 carbon atoms), an aryl group (preferably ones having 6 to 12 carbon atoms), an alkoxycarbonyl group (preferably ones having 2 to 8 carbon atoms), a carbamoyl group, an acyl group, or an electron donating group.

The “electron donating group” as referred to herein means an alkoxy group (preferably ones having 1 to 8 carbon atoms), a hydroxyl group, an amino group, an alkylamino group (preferably ones having 1 to 8 carbon atoms), an arylamino group (preferably ones having 6 to 12 carbon atoms), a heterocyclic amino group (preferably ones having 2 to 6 carbon atoms), a sulfonamide group, an acylamino group, an active methine group, a mercapto group, an alkylthio group (preferably ones having 1 to 8 carbon atoms), an arylthio group (preferably ones having 6 to 12 carbon atoms), or an aryl group having such a group as the substituent (the aryl moiety thereof preferably has 6 to 12 carbon atoms).

The hydroxyl group may be protected by a silyl group. Examples include a trimethylsilyloxy group, a t-butyldimethylsilyloxy group, a triphenylsilyloxy group, a triethylsilyloxy group, and a phenyldimethylsilyloxy group.

Examples of the carbon-carbon double bond site and the carbon-carbon triple bond side include a vinyl group and an ethynyl group.

When Y₃ represents a substituted carbon-carbon double bond site-containing organic group, the substituent is more preferably an alkyl group, a phenyl group, an acyl group, a cyano group, an alkoxycarbonyl group, a carbamoyl group, or an electron donating group. Here, the electron donating group is preferably an alkoxy group, a hydroxyl group (which may be protected by a silyl group), an amino group, an alkylamino group, an arylamino group, a sulfonamide group, an active methine group, a mercapto group, an alkylthio group, or a phenyl group having such an electron donating group as the substituent.

When the carbon-carbon double bond site-containing organic group has a hydroxyl group as the substituent, Y₃ will contain a partial structure, >C₁═C₂(—OH)—. This partial structure may be subjected to tautomerism to become a partial structure, >C₁H—C₂(═O)—.

Further, in that case, the case where the substituent to be substituted on the C, carbon is an electron withdrawing group is also preferable. In that case, Y₃ will have “an active methylene group” or a partial structure of “an active methine group”.

The electron withdrawing group capable of giving an active methylene group or a partial structure of an active methine group is the same as that described above in the “active methine group”.

When Y₃ represents a substituted carbon-carbon triple bond site-containing organic group, the substituent is preferably an alkyl group, a phenyl group, an alkoxycarbonyl group, a carbamoyl group, or an electron donating group. Here, the electron donating group is preferably an alkoxy group, an amino group, an alkylamino group, an arylamino group, a heterocyclic amino group, a sulfonamide group, an acylamino group, an active methine group, a mercapto group, an alkylthio group, or a phenyl group having such an electron donating group as the substituent.

When Y₃ represents an aromatic group site-containing organic group, the aromatic group is preferably an aryl group (especially preferably a phenyl group) having an electron donating group as the substituent or an indole ring group. Here, the electron donating group is preferably a hydroxyl group (which may be protected by a silyl group), an alkoxy group, an amino group, an alkylamino group, an active methine group, a sulfonamide group, or a mercapto group.

When Y₃ represents an organic group containing a non-aromatic heterocyclic group site of benzo fused ring, the non-aromatic heterocyclic group of benzo fused ring is preferably one containing an aniline structure therein as the partial structure. Examples include an indoline ring group, a 1,2,3,4-tetrahydroquinoline ring group, a 1,2,3,4-tetrahydroquinoxaline ring group, and a 4-quinolone ring group.

In the formula (D), the reactive group represented by Y₃ is more preferably an organic group containing a carbon-carbon double bond site, an aromatic group site, or a non-aromatic heterocyclic group of benzo fused ring; and more preferably an organic group containing a carbon-carbon double bond site, a phenyl group having an electron donating group as the substituent, an indole ring group, or a non-aromatic heterocyclic group of benzo fused ring containing an aniline structure therein as the partial structure.

Here, it is more preferable that the carbon-carbon double site has at least one electron donating group as the substituent.

In the formula (D), the case where as a result of selecting the reactive group represented by Y₃ within the ranges described above, it has the same partial structure as the reducible group represented by RED₃ in the formula (D) is also a preferred example of the compound represented by the formula (D).

In the formula (D), L₃ represents a connecting group of connecting RED₃ to Y₃. Specifically, L₃ is a single bond, an alkylene group, an arylene group, a heterocyclic group, —O—, —S—, —NRN—, —C(═O)—, —SO₂—, —SO—, or —P(═O)— singly, or a group comprising a combination of these groups.

Here, RN represents a hydrogen atom, an alkyl group, an aryl group, or a heterocyclic group.

The connecting group represented by L₃ may have a substituent. As the substituent, those described above for the substituent that RED₁₁ in the formula (A) may have are enumerated.

The connecting group represented by L₃ can be connected at arbitrary positions of the groups represented by RED₃ and Y₃, respectively in the form where arbitrary one hydrogen atom of each group is substituted therewith.

With respect to the group represented by L₃ in the formula (D), it is preferable that when a cation radical species (X⁺.) formed upon oxidation of RED₃ in the formula (D), or a radical species (X.) formed therefrom while causing splitting off of a proton, reacts with the reactive group represented by Y₃ in the formula (D) to form a bond, an atomic group relating thereto can form a 3-membered to 7-membered cyclic structure containing L₃.

For that purpose, it is preferable that the radical species (X⁺. or X.), the reactive group presented by Y, and L are connected to each other via a group of 3 to 7 atoms.

Preferred examples of L₃ include a single bond, an alkylene group (especially a methylene group, an ethylene group, and a propylene group), an arylene group (especially a phenylene group), a —C(═O)— group, an —O— group, an —NH— group, an —N(alkyl group)- group, and a divalent connecting group comprising a combination of these groups.

Of the compounds represented by the formula (D), compounds represented by the following formulae (D-1) to (D-4) are preferable.

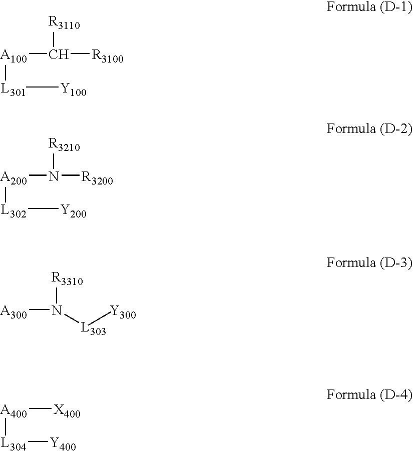

In the formulae (D-1) to (D-4), A₁₀₀, A₂₂₀, and A₄₀₀ each represent an arylene group or a divalent heterocyclic group; and A₃₀₀ represents an aryl group or a heterocyclic group. Preferred ranges of these ring groups are the same as the preferred range of RED₃ in the formula (D).

L₃₀₁, L₃₀₂, L₃₀₃, and L₃₀₄ each represent a connecting group, which is a group synonymous with L₃ in the formula (D). Preferred examples thereof are also the same.

Y₁₀₀, Y₂₀₀, Y₃₀₀, and Y₄₀₀ each represent a reactive group, which is a group synonymous with Y₃ in the formula (D). Preferred examples thereof are also the same.

R₃₁₀₀, R₃₁₁₀, R₃₂₀₀, R₃₂₁₀, and R₃₃₁₀ each represent a hydrogen atom or a substituent.

R₃₁₀₀ and R₃₁₁₀ are each preferably a hydrogen atom, an alkyl group, or an aryl group.

R₃₂₀₀ and R₃₃₁₀ are each preferably a hydrogen atom.

R₃₂₁₀ is preferably a substituent. The substituent is preferably an alkyl group or an aryl group.

R₃₁₁₀ and A₁₀₀, R₃₂₁₀ and A₂₀₀, and R₃₃₁₀ and A₃₀₀ may be each bonded to each other to form a ring structure.

The ring structure to be formed herein is preferably a tetraline ring, an indane ring, a tetrahydroquinoline ring, or an indoline ring.

X₄₀₀ represents a hydroxyl group, a mercapto group, or an alkylthio group; preferably a hydroxyl group or a mercapto group; and more preferably a mercapto group.

Of the compounds represented by the formulae (D-1) to (D-4), compounds represented by the formulae (D-2), (D-3) and (D-4) are preferable; and compounds represented by the formulae (D-2) and (D-3) are more preferable.

Next, the compound of the type 4 will be described below.

The compound of the type 4 is a compound having a ring structure substituted with a reducible group and a compound in which a one electron oxidant formed upon one electron oxidation can further release one or more electrons after subsequent intramolecular ring cleavage reaction.

The compound of the type 4 is subjected to one electron oxidation, and the ring structure is then cleaved. The “cleavage reaction” as referred to herein means the mode illustrated by the following scheme.

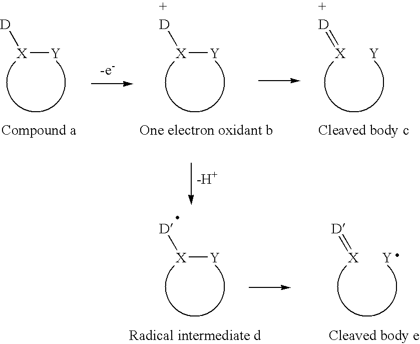

In the formulae, the compound A represents the compound of the type 4.

In the compound a, D represents a reducible group; and X and Y each represent an atom of forming a bond that is cleaved after one electron oxidation in the ring structure.

First of all, the compound a is subjected to one electron oxidation to form the one electron oxidant b, from which the D-X single bond becomes a double bond, and the X-Y bond is simultaneously cleaved to form the cleaved body c. Alternatively, there may be the case where the radical intermediate d is formed from the one electron oxidant b while causing splitting off of a proton, from which the cleaved body e is formed.

The compound of the invention is characterized in that one or more electrons are further released subsequently from the thus formed cleaved body c or e.

The ring structure that the compound of the type 4 has is a 3-membered to 7-membered carbocycle or heterocycle and represents a monocyclic or fused, saturated or unsaturated non-aromatic ring.

The ring structure is preferably a saturated ring structure, and more preferably a 3-membered or 4-membered ring. Preferred examples of the ring structure include a cyclopropane ring, a cyclobutane ring, an oxirane ring, an oxetane ring, an aziridine ring, an azetidine ring, an episulfide ring, and a thiethane ring.

The ring structure is more preferably a cyclopropane ring, a cyclobutane ring, an oxirane ring, an oxetane ring, or an azetidine ring; and especially preferably a cyclopropane ring, a cyclobutane ring, or an azetidine ring.

The ring structure may have a substituent.

The compound of the type 4 is preferably represented by the formula (E) or (F).

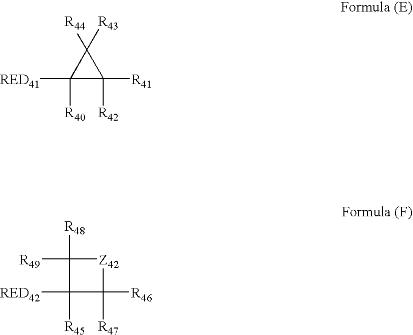

In the formulae (E) and (F), RED₄₁ and RED₄₂ each represent a group synonymous with RED₁₂ in the formula (B). Preferred ranges thereof are also the same. R₄₀ to R₄₄ and R₄, to R₄₉ each represent a hydrogen atom or a substituent. As the substituent, the same groups as in the substituent that RED₁₂ may have are enumerated.

In the formula (F), Z₄₂ represents —CR₄₂₀R₄₂₁—, —NR₄₂₃—, or —O—. Here, R₄₂₀ and R₄₂₁ each represent a hydrogen atom or a substituent; and R₄₂₃ represents a hydrogen atom, an alkyl group, an aryl group, or a heterocyclic group.

In the formula (E), R₄₀ is preferably a hydrogen atom, an alkyl group, an alkenyl group, an alkynyl group, an aryl group, a heterocyclic group, an alkoxy group, an amino group, an alkylamino group, an arylamino group, a heterocyclic amino group, an alkoxycarbonyl group, an acyl group, a carbamoyl group, a cyano group, or a sulfamoyl group; more preferably a hydrogen atom, an alkyl group, an aryl group, a heterocyclic group, an alkoxy group, an alkoxycarbonyl group, an acyl group, or a carbamoyl group; and especially preferably a hydrogen atom, an alkyl group, an aryl group, a heterocyclic group, an alkoxycarbonyl group, or a carbamoyl group.

In R₄₁ to R₄₄, the case where at least one of R₄₁ to R₄₄ is a donor group and the case where both R₄₁ and R₄₂, or both R₄₃ and R₄₄ are an electron withdrawing group are preferable. The case where at least one of R₄, to R₄₄ is a donor group is more preferable. The case where at least one of R₄₁ to R₄₄ is a donor group, and in R₄₁ to R₄₄, the group or groups that are not a donor group are a hydrogen atom or an alkyl group is further preferable.

The “donor group” as referred to herein means a hydroxyl group, an alkoxy group, an aryloxy group, a mercapto group, an acylamino group, a sulfonylamino group, an active methine group, or a group selected from the group of preferred groups as RED₄₁ or RED₄₂.

As the donor group, an alkylamino group, an arylamino group, a heterocyclic amino group, a 5-membred aromatic heterocyclic group having one nitrogen atom in the ring (the ring may be monocyclic or fused), a nitrogen atom-substituted non-aromatic nitrogen-containing heterocyclic ring, and a phenyl group substituted with at least one electron providing group (wherein the electron donating group represents a hydroxyl group, an alkoxy group, an aryloxy group, an amino group, an alkylamino group, an arylamino group, a heterocyclic amino group, or a nitrogen atom-substituted non-aromatic nitrogen-containing heterocyclic group) are preferably used.

As the donor group, an alkylamino group, an arylamino group, a 5-membred aromatic heterocyclic group having one nitrogen atom in the ring (wherein the aromatic heterocyclic group represents an indole ring, a pyrrole ring, or a carbazole ring), and a phenyl group substituted with at least one electron providing group (especially, the phenyl group represents a phenyl group substituted with three or more alkoxy groups or a phenyl group substituted with a hydroxyl group, an alkylamino group or an arylamino group) are more preferably used.

As the donor group, an arylamino group, a 5-membred aromatic heterocyclic group having one nitrogen atom in the ring (wherein the aromatic heterocyclic group represents a 3-indolyl group), and a phenyl group substituted with an electron providing group (especially, the phenyl group represents a trialkoxyphenyl group or a phenyl group substituted with an alkylamino group or an arylamino group) are especially preferably used.

The electron withdrawing group is the same as that described previously for the active methine group.

In the formula (F), the preferred range of R₄₅ is the same as that described above for R₄₀ in the formula (E).

As R₄₆ to R₄₉, a hydrogen atom, an alkyl group, an alkenyl group, an alkynyl group, an aryl group, a heterocyclic group, a hydroxyl group, an alkoxy group, an amino group, an alkylamino group, an arylamino group, a heterocyclic amino group, a mercapto group, an arylthio group, an alkylthio group, an acylamino group, and a sulfonamino group are preferable; and a hydrogen atom, an alkyl group, an aryl group, a heterocyclic group, an alkoxy group, an alkylamino group, an arylamino group, and a heterocyclic amino group are more preferable.

In the case where Z₄₂ represents —CR₄₂₀R₄₂₁—, R₄₆ to R₄₉ are each especially preferably a hydrogen atom, an alkyl group, an aryl group, a heterocyclic group, an alkylamino group, or an arylamino group; in the case where Z₄₂ represents —NR₄₂₃-, R₄₆ to R₄₉ are each especially preferably a hydrogen atom, an alkyl group, an aryl group, or a heterocyclic group; and in the case where Z₄₂ represents —O—, R₄₆ to R₄₉ are each especially preferably a hydrogen atom, an alkyl group, an aryl group, or a heterocyclic group.

Z₄₂ is preferably —CR₄₂₀R₄₂₁— or —NR₄₂₃—, and more preferably —NR₄₂₃—.

R₄₂₀ and R₄₂₁ are each preferably a hydrogen atom, an alkyl group, an alkenyl group, an alkynyl group, an aryl group, a heterocyclic group, a hydroxyl group, an alkoxy group, an amino group, a mercapto group, an acylamino group, or a sulfonamino group; and more preferably a hydrogen atom, an alkyl group, an aryl group, a heterocyclic group, an alkoxy group, or an amino group. R₄₂₃ is preferably a hydrogen atom, an alkyl group, an aryl group, or an aromatic heterocyclic group; and more preferably a methyl group, an ethyl group, an isopropyl group, a t-butyl group, a t-amyl group, a benzyl group, a diphenylmethyl group, an allyl group, a phenyl group, a naphthyl group, a 2-pyridyl group, a 4-pyridyl group, or a 2-thiazolyl group.

In the case where each of the groups of R₄₀ to R₄₉, R₄₂₀, R₄₂₁, and R₄₂₃ is a substituent, the total number of carbon atoms thereof is preferably not more than 40, more preferably not more than 30, and especially preferably not more than 15.

Also, these substituents may be bonded to each other or bonded to other site in the molecule (RED₄₁, RED₄₂, or Z₄₂) to form a ring.

It is preferable that the compounds of the types 1, 3 and 4 are each “a compound having an adsorptive group onto silver halide in the molecule” or “a compound having a partial structure of spectral sensitizing dye in the molecule”.

It is more preferable that the compounds of the types 1, 3 and 4 are each “a compound having an adsorptive group onto silver halide in the molecule”.

The compound of the type 2 is “a compound having two or more adsorptive groups onto silver halide in the molecule”.

It is further preferable that the compounds of the types 1 to 4 are each “a compound having two or more mercapto group-substituted nitrogen-containing heterocyclic groups as the adsorptive group”.

In the compounds of the types 1 to 4 of the invention, the adsorptive group onto silver halide is a group that adsorbs directly onto silver halide or a group that promotes adsorption onto silver halide. Specifically, the adsorptive group onto silver halide is a mercapto group (or a salt thereof), a thione group (—C(═S)—), a heterocyclic group containing at least one atom selected from a nitrogen atom, a sulfur atom, a selenium atom, and a tellurium atom, a sulfide group, a cationic group, or an ethynyl group.

However, in the compound of the type 2 of the invention, the sulfide group is not included as the adsorptive group.

The mercapto group (or its salt) as the adsorptive group means a mercapto group (or a salt thereof) itself and at the same time, more preferably represents a heterocyclic group, an aryl group or an alkyl group, each of which is substituted with at least one mercapto group (or a salt thereof).

The “heterocyclic ring” as referred to herein means a 5-membered to 7-membered monocyclic or fused aromatic or non-aromatic heterocyclic ring, examples of which include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group.

The heterocyclic ring may be a quaternary nitrogen atom-containing heterocyclic group. In that case, the substituted mercapto group may be dissociated into a meso ion. Examples of such a heterocyclic group include an imidazolium ring group, a pyrazolium ring group, a thiazolium ring group, a triazolium ring group, a tetrazolium ring group, a thiadiazolium ring group, a pyridinium ring group, a pyrimidinium group, and a triazinium ring group. Of these groups, a triazolium ring group (such as a 1,2,4-triazoilum-3-thiolate ring group) is preferable. Examples of the aryl group include a phenyl group and a naphthyl group.

Examples of the alkyl group include a linear, branched or cyclic alkyl group having 1 to 30 carbon atoms.

When the mercapto group forms a salt, examples of counter ions include cations of alkali metals, alkaline earth metals, and heavy metals (such as Li⁺, Na⁺, K⁺, Mg⁺, Ag⁺, and Zn²⁺), an ammonium ion, quaternary nitrogen atom-containing heterocyclic groups, and a phosphonium ion.

The mercapto group as the adsorptive group may further be subjected to tautomerism to become a thione group. Specific examples include a thioamide group (a —C(═S)—NH— group) and groups containing a partial structure of the thioamide group, that is, linear or cyclic thioamide group, thioureido group, thiourethane group, or dithiocarbamic acid ester group.

Examples of the term “cyclic” include a thiazolidin-2-thione group, an oxazolidin-2-thione group, a 2-thiohydantoin group, a rhodanine group, an isorhodanine group, a thiobarbituric acid group, and a 2-thioxo-oxazolidin-4-one group.

The thione group as the adsorptive group includes the case where the mercapto group is subjected to tautomerism to become a thione group and also includes linear or cyclic thioamide group, thioureido group, thiourethane group, or dithiocarbamic acid ester group, which cannot be subjected to tautomerism on the mercapto group (not having a hydrogen atom at the α-position of the thione group).

The heterocyclic group containing at least one atom selected from a nitrogen atom, a sulfur atom, a selenium atom, and a tellurium atom as the adsorptive group is a nitrogen-containing heterocyclic group having an —NH— group capable of forming imino silver (>NAg) as a partial structure of heterocycle, or a heterocyclic group having an —S— group, an —Se— group, a —Te— group, or an═N— group, each of which can be coordinated on silver ion via coordination bond, as a partial structure of heterocycle. Examples of the former include a benzotriazole group, a triazole group, an indazole group, a pyrazole group, a tetrazole group, a benzimidazole group, an imidazole group, and a purine group; and examples of the latter include a thiophene group, a thiazole group, an oxazole group, a benzothiazole group, a benzoxazole group, a thiadiazole group, an oxadiazole group, a triazine group, a selenoazole group, a benzselenoazole group, a tellurazole group, and a benztellurazole ring. Of these groups, the former groups are preferable.

The sulfide group as the adsorptive group includes all groups having a partial structure of —S—. The sulfide group is preferably a group having a partial structure of alkyl (or alkylene)-S-alkyl (or alkylene), aryl (or arylene)-S-alkyl (or alkylene), or aryl (or arylene)-S-aryl (or arylene).

Further, the sulfide group may form a cyclic structure or may become an —S—S— group.

Specific examples of the case of forming the cyclic structure include groups containing a thiorane ring, a 1,3-dithiorane ring or 1,2-dithiorane ring, a thiane ring, a dithiane ring, or a tetrahydro-1,4-thiazine ring (thiomorpholine ring).

As the sulfide group, groups having a partial structure of alkyl (or alkylene)-S-alkyl (or alkylene) are especially preferable.

The cationic group as the adsorptive group means a quaternary nitrogen atom-containing group, specifically a group containing an ammonio group or a quaternary nitrogen atom-containing nitrogen-containing heterocyclic group.

However, the cationic group does not become a part of an atomic group of forming a dye structure (such as a cyanine chromophore).

The “ammonio group” as referred to herein means a trialkylammonio group, a dialkylarylammonio group, an alkyldiarylammonio group, etc., examples of which include a benzyldimethylammonio group, a trihexylammonio group, and a phenyldiethylammonio group.

Examples of the quaternary nitrogen atom-containing nitrogen-containing heterocyclic group include a pyridinio group, a quinolinio group, an isoquinolinio group, and an imidazolio group. Of these groups, a pyridinio group and an imidazolio group are preferable, and a pyridinio group is especially preferable.

The quaternary nitrogen atom-containing nitrogen-containing heterocyclic group may have an arbitrary substituent. In the case of the pyridinio group and imidazolio group, preferred examples of the substituent include an alkyl group, an aryl group, an acylamino group, a chlorine atom, an alkoxycarbonyl group, and a carbamoyl group; and in the case of the pyridinio group, the substituent is especially preferably a phenyl group.

The ethynyl group as the adsorptive group means a —C═CH group, in which the hydrogen atom may be substituted.

The adsorptive group may have an arbitrary substituent.

As specific examples of the adsorptive group, those described in JP-A No. 11-95355, pages 4 to 7 are enumerated.

In the invention, mercapto-substituted nitrogen-containing heterocyclic groups (such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group, and a 1,5-dimethyl-1,2,4-triazolium-3-thiolate group) and nitrogen-containing heterocyclic groups having an —NH— group capable of forming imino silver (>NAg) as a partial structure of heterocycle (such as a benzotriazole group, a benzimidazole group, and an indazole group) are preferable as the adsorptive group.

Of these groups, a 5-mercaptotetrazole group, a 3-mercapto-1,2,4-triazole group, and a benzotriazole group are especially preferable; and a 3-mercapto-1,2,4-triazole group and a 5-mercaptotetrazole group are most preferable.

Of these compounds of the invention, compounds having two or more mercapto groups in the molecule as the partial structure are especially preferable.

In the case where tautomerism can be conducted, the mercapto group (—SH) may become a thione group.

Examples of such compounds include compounds having two or more adsorptive groups having a mercapto group or a thione group as the partial structure (such as a ring-forming thiamide group, an alkylmercapto group, an arylmercapto group, and a heterocyclic mercapto group) in the molecule and compounds having one or more adsorptive groups having two or more mercapto groups or thione groups as the partial structure (such as a dimercapto-substituted nitrogen-containing heterocyclic group).

Examples of the adsorptive group having two or more mercapto groups as the partial structure (such as a dimercapto-substituted nitrogen-containing heterocyclic group) include a 2,4-dimercarptopyrimidine group, a 2,4-dimercarptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)-pyrimidine group, a 2,6,8-trimercaptopurine group, a 6,8-dimercaptopurine group, a 3,5,7-trimercapto-s-triazolotriazine group, a 4,6-dimercaptopyrazolopyrimidine group, and a 2,5-dimercaptoimidazole group. Of these, a 2,4-dimercaptopyrimidine group, a 2,4-dimercaptotriazine group, and a 3,5-dimercapto-1,2,4-triazole group are especially preferable.

The adsorptive group may be substituted at any position in the formulae (A) to (F) and the formulae (1) to (3). It is preferable that in the formulae (A) to (D), the adsorptive group is substituted at RED₁₁, RED₁₂, RED₂, and RED₃; in the formulae (E) and (F), the adsorptive group is substituted at RED₄₁, R₄₁, RED₄₂, and R₄₆ to R₄₈; and in the formulae (1) to (3), the adsorptive group is substituted at any arbitrary position other than R₁, R₂, R₁₁, R₁₂, R₃₁, L₁, L₂₁, and L₃₁. It is more preferable that in all of the formulae (A) to (F), the adsorptive group is substituted at RED₁₁ to RED₄₂.

The partial structure of the spectral sensitizing dye is a group containing a chromophore of the spectral sensitizing dye, which is a residue resulting from elimination of an arbitrary hydrogen atom or substituent from the spectral sensitizing dye compound.

The partial structure of the spectral sensitizing dye may be substituted at any position in the formulae (A) to (F) and the formulae (1) to (3). It is preferable that in the formulae (A) to (D), the partial structure of the spectral sensitizing dye is substituted at RED₁₁, RED₁₂, RED₂, and RED₃; in the formulae (E) and (F), the partial structure of the spectral sensitizing dye is substituted at RED₄₁, R₄₁, RED₄₂, and R₄₆ to R₄₈; and in the formulae (1) to (3), the partial structure of the spectral sensitizing dye is substituted at any arbitrary position other than R₁, R₂, R₁₁, R₁₂, R₃₁, L₁, L₂₁, and L₃₁. It is more preferable that in all of the formulae (A) to (F), the adsorptive group is substituted at RED₁₁ to RED₄₂.

The spectral sensitizing dye is preferably a spectral sensitizing dye that is typically used in the color sensitization technology, examples of which include cyanine dyes, composite cyanine dyes, merocyanine dyes, composite merocyanine dyes, cyanine dyes with the same polarity, styryl dyes, and hemicyanine dyes.

Representative spectral sensitizing dyes are disclosed in Research Disclosure, Item 36544, September 1994.

Those skilled in the art can synthesize these dyes according to the procedures described in the above-cited Research Disclosure or F. M. Hamer, The Cyanine Dyes and Related Compounds, Interscience Publishers, New York, 1964.

Further, all of dyes described on pages 7 to 14 of JP-A No. 11-95355 (U.S. Pat. No. 6,054,260) fall within this scope as they are.

In the compounds of the types 1 to 4 of the invention, the total number of carbon atoms is preferably in the range of 10 to 60, more preferably 10 to 50, further preferably 11 to 40, and especially preferably 12 to 30.

In the compounds of the types 1 to 4 of the invention, the compound is subjected to one electron oxidation triggered by exposure of a silver halide photographic material using the same; and after subsequent reaction, one electron, or two or more electrons depending upon the type, are further released, whereby the compound is oxidized. The oxidation potential of the first electron is preferably not more than about 1.4 V, and more preferably not more than 1.0 V.

This oxidation potential is preferably higher than 0 V, and more preferably higher than 0.3 V. Accordingly, the oxidation potential is preferably in the range of about 0 to about 1.4 V, and more preferably about 0.3 to about 1.0 V.

The oxidation potential can be measured by the cyclic voltammetry technology. Concretely, the oxidation potential is one measured by dissolving a sample in a solution of acetonitrile/water (containing 0.1 M lithium perchlorate) of 80/20 (by volume), passing a nitrogen gas therethrough for 10 minutes, and then measuring the oxidation potential at 25° C. and at a potential scanning rate of 0.1 V/sec using a glassy carbon disk as a working electrode, a platinum wire as a counter electrode and a calomel electrode (SCE) as a reference electrode, respectively. A ratio of oxidation potential to SCE is taken upon the peak potential of cyclic voltammetry wave.

In the compounds of the types 1 to 4 of the invention, in the case where the compound is subjected to one electron oxidation and after subsequent reaction, further releases one electron, the oxidation potential of the latter stage is preferably −0.5 V to −2 V, more preferably −0.7 V to −2 V, and further preferably −0.9 V to −1.6 V.

In the compounds of the types 1 to 4 of the invention, in the case where the compound is subjected to one electron oxidation and after subsequent reaction, further releases two or more electrons, whereby the compound is oxidized, the oxidation potential of the latter stage is not particularly limited.

This is because in the point that the oxidation potential of the second electron and the oxidation potential of the third electron, et seq. cannot be distinctly distinguished from each other, it is often difficult to actually these oxidation potentials precisely and distinguish them from each other.

Specific examples of the compounds of the types 1 to 4 of the invention will be enumerated below, but it should not be construed that the invention is limited thereto.

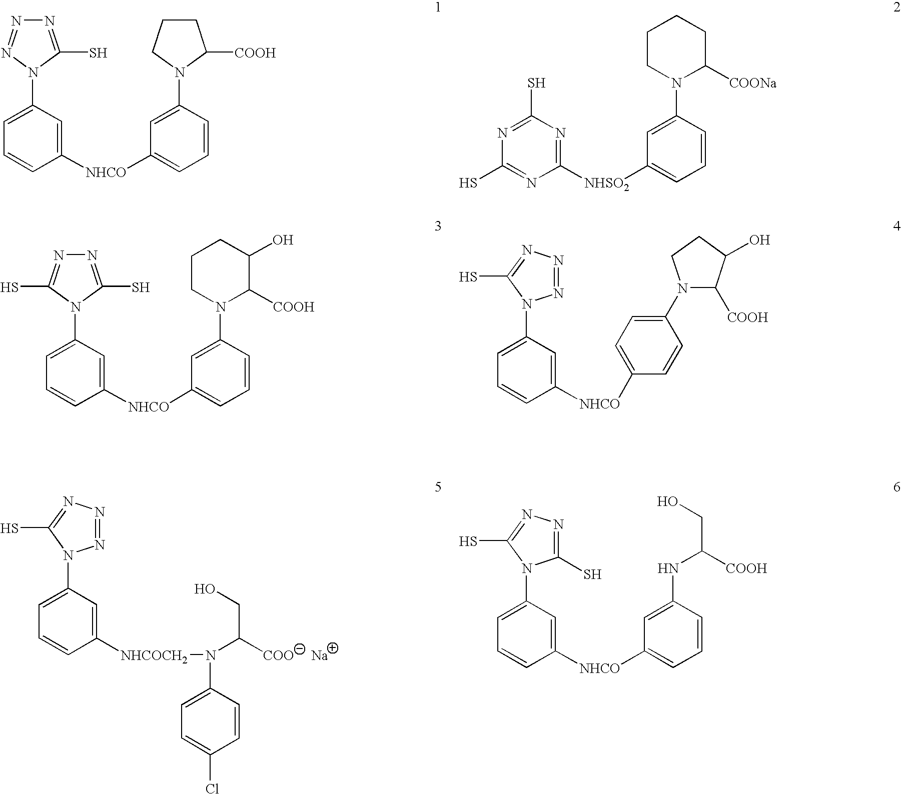

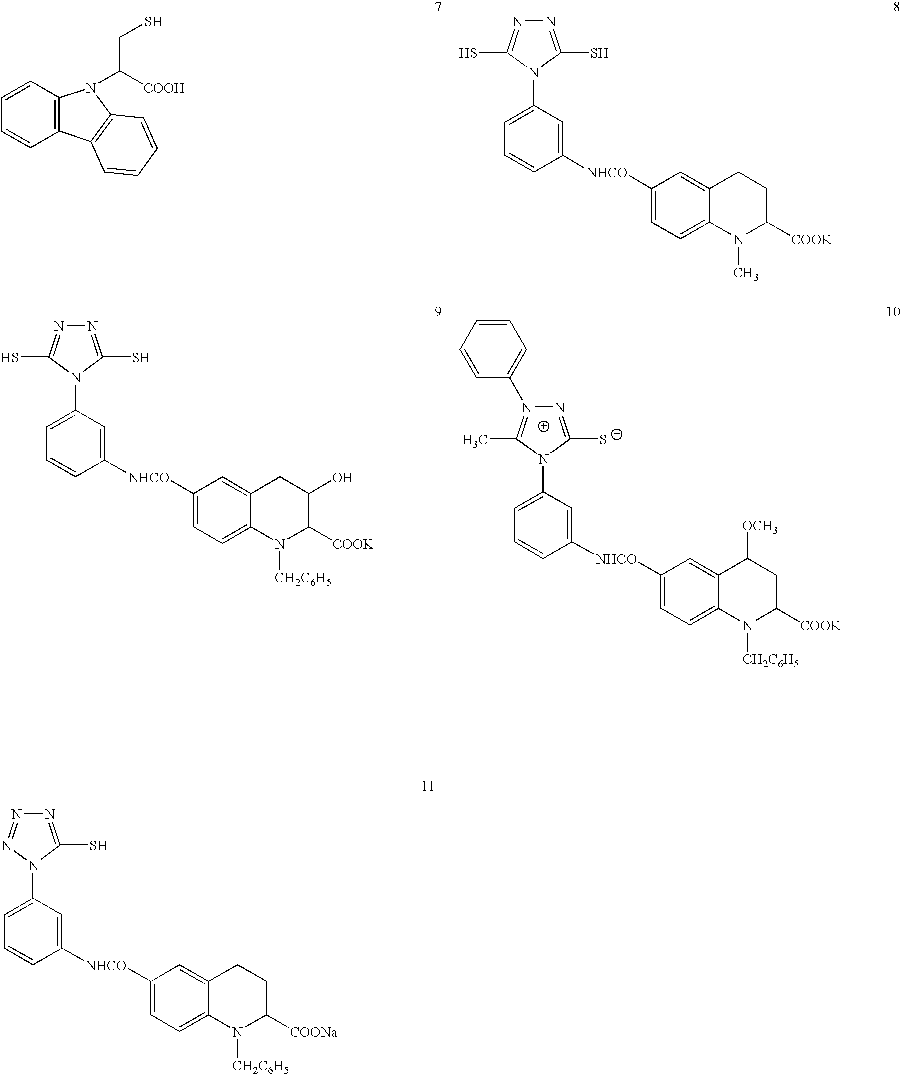

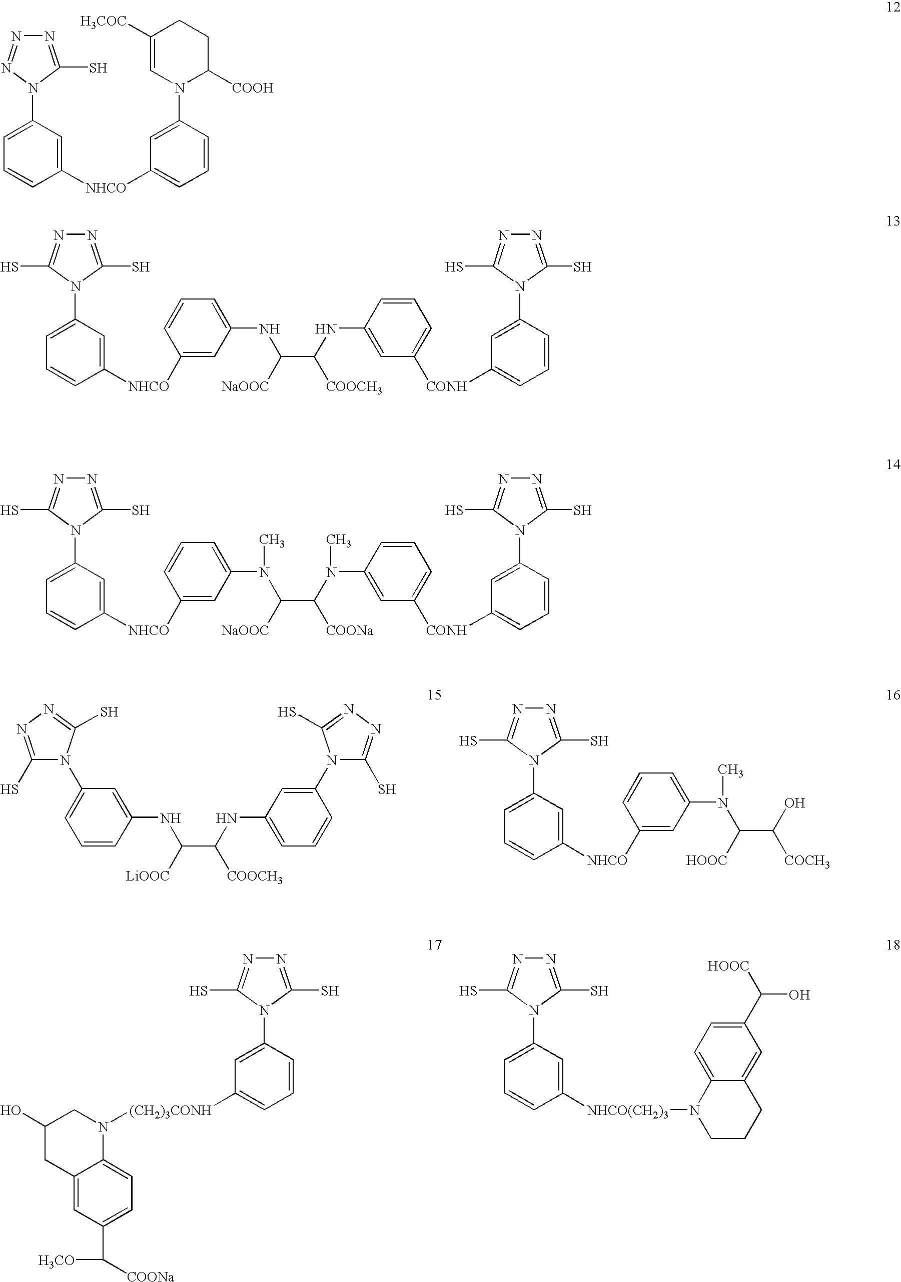

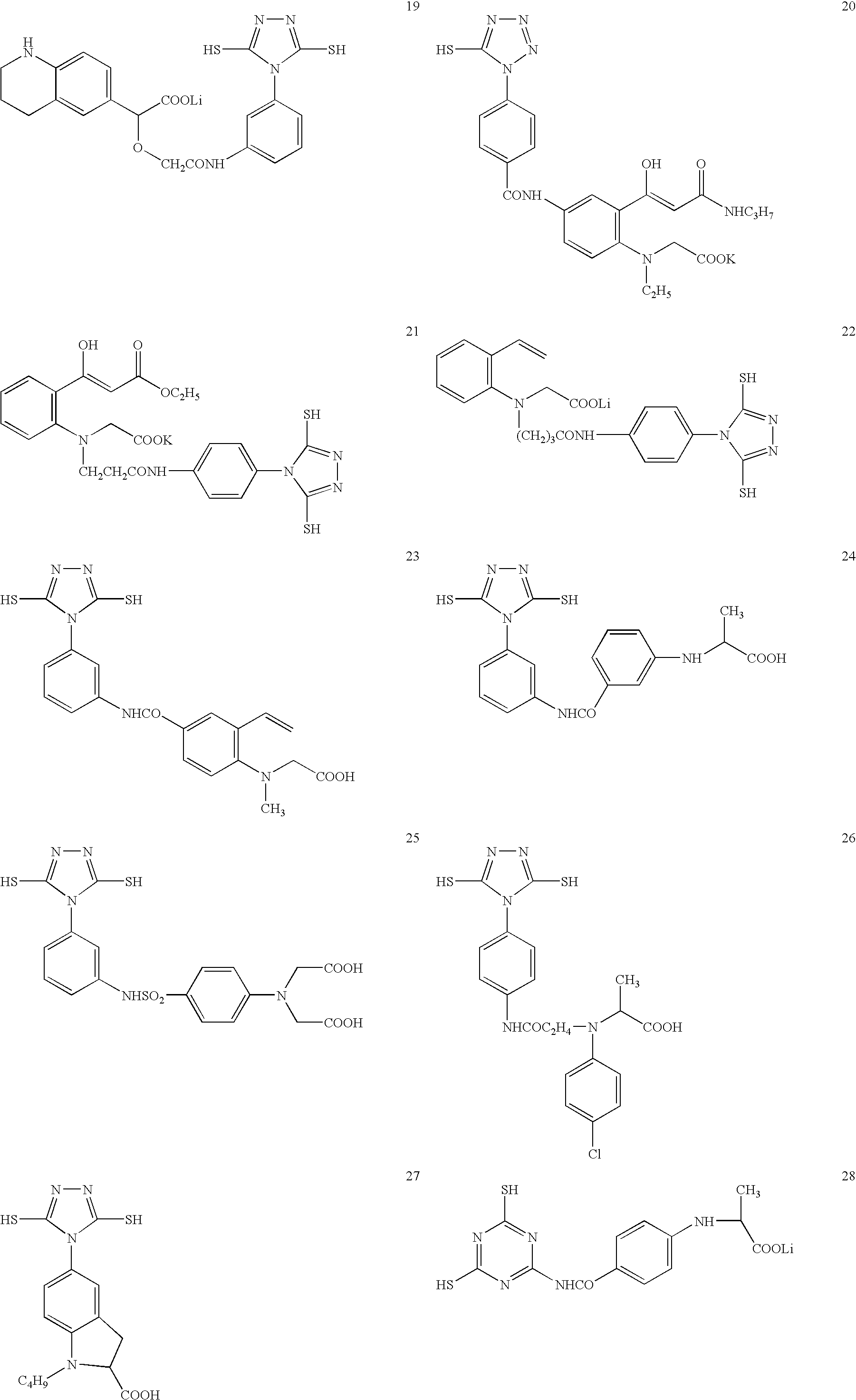

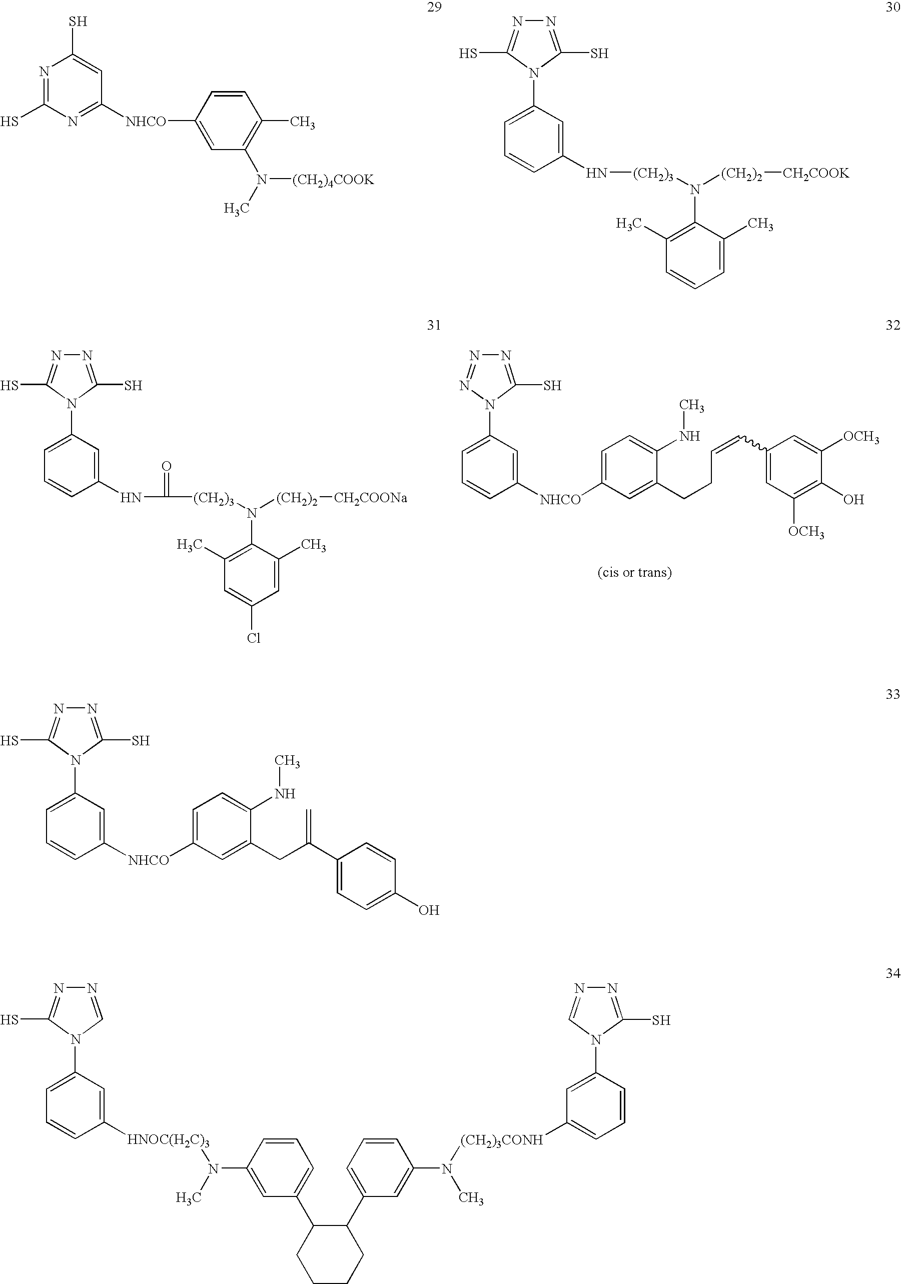

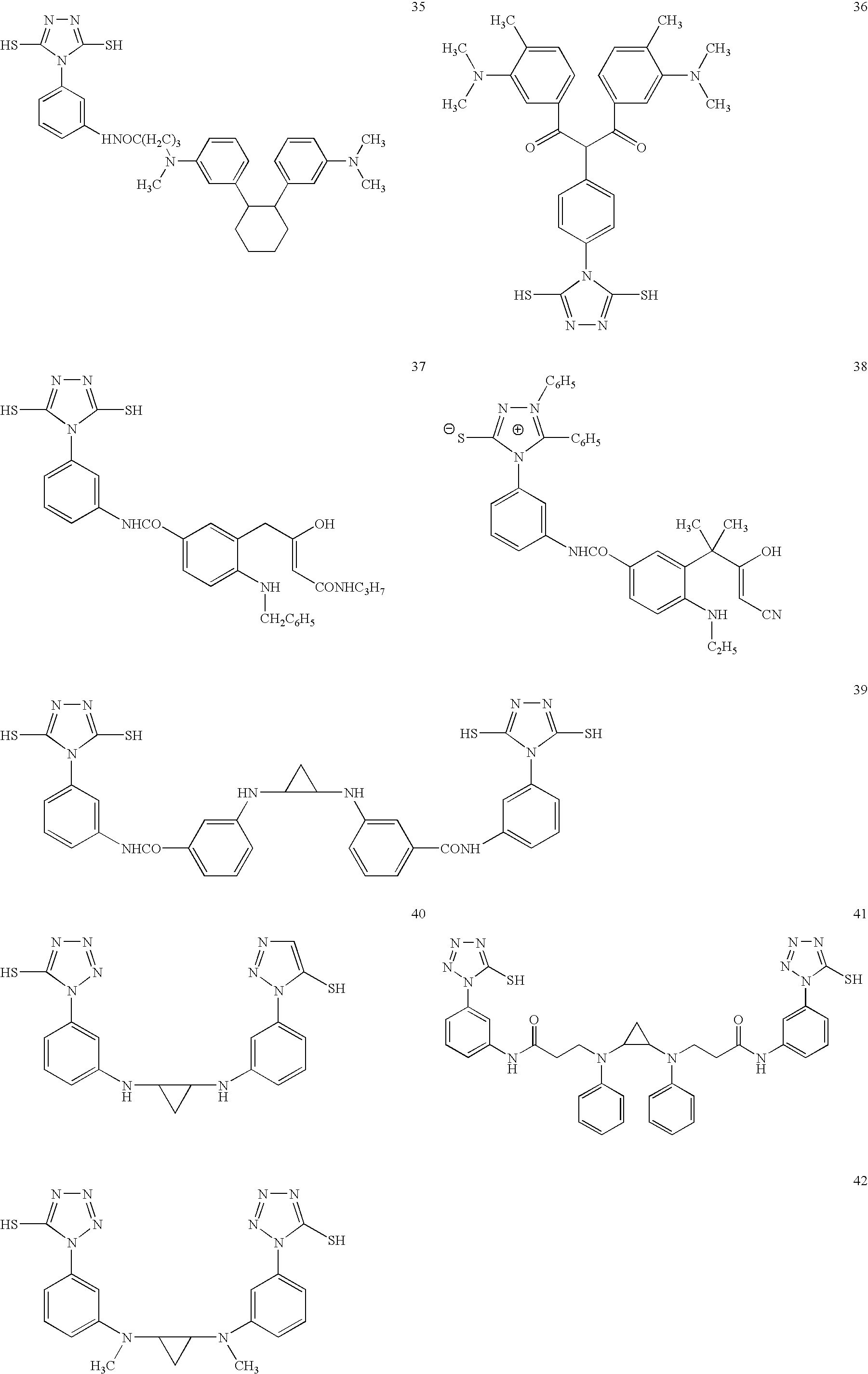

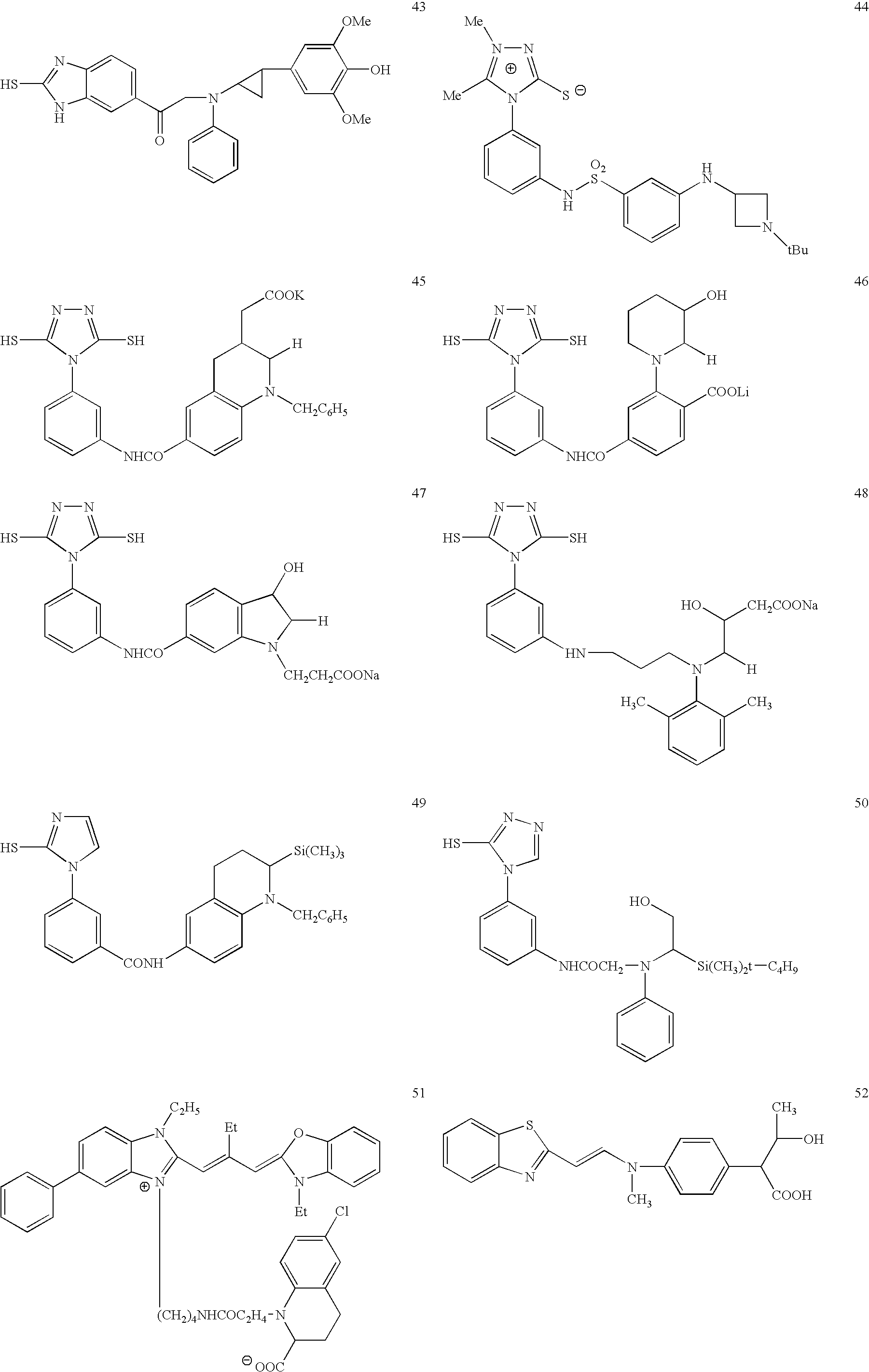

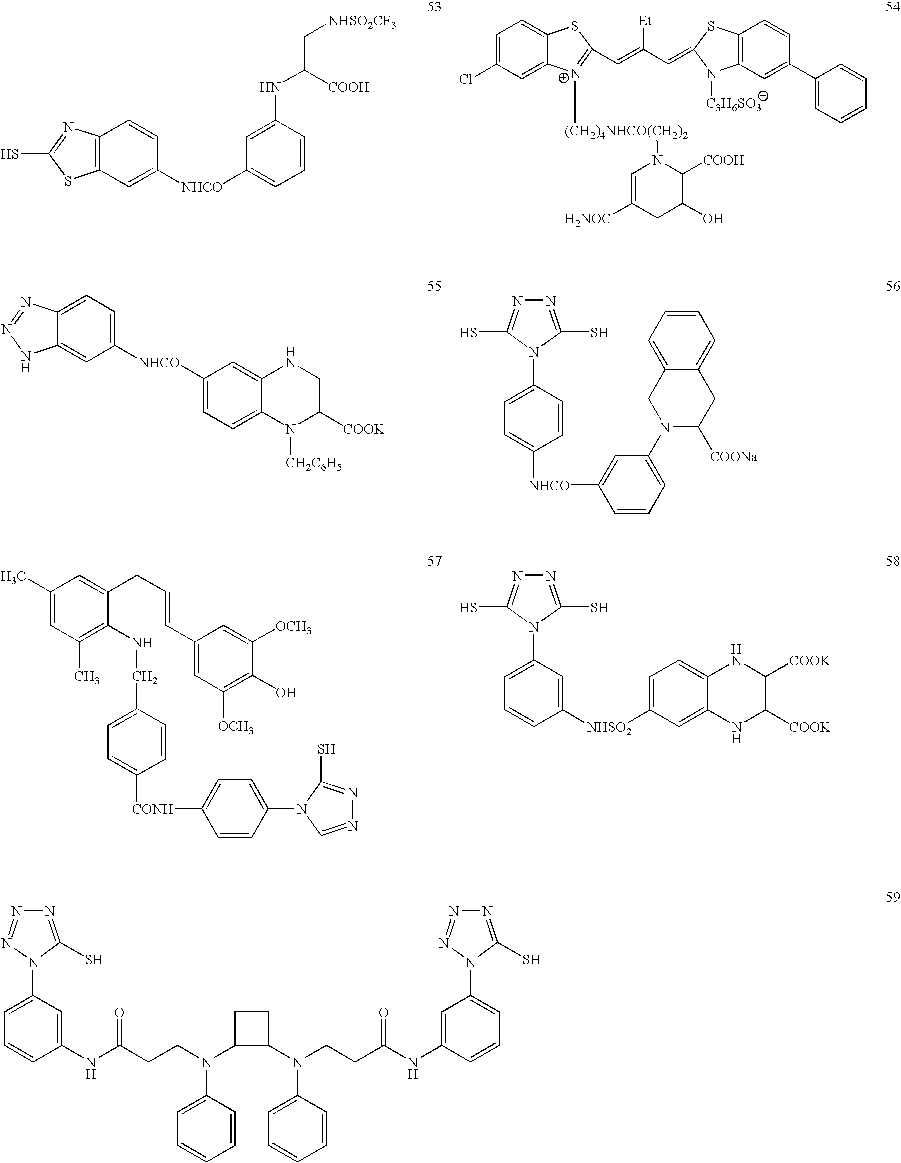

The compounds of the types 1 to 4 of the invention are the same as the compounds described in detail in JP-A Nos. 2003-114487, 2003-114486, 2003-140287 and 2003-75950 respectively.

Specific examples of compounds described in these patent documents are also enumerated as specific examples of the compounds of the types 1 to 4 of the invention.

Also, synthesis examples of the compounds of the types 1 to 4 of the invention are the same as those described in these patent documents.

Next, the compound of the type 5 will be described below.

The compound of the type 5 is a compound in which a one electron oxidant formed upon one electron oxidation of a reducible group represented by X in a compound represented by X-Y splits off Y while causing subsequent cleavage reaction of X-Y bond, to form X radicals, from which another electron can be released.

The reaction when the compound of the type 5 is oxidized can be expressed by the following scheme.

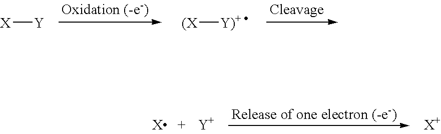

The oxidation potential of the compound of the type 5 is preferably 0 to 1.4 V, and more preferably 0.3 V to 1.0 V.

Also, the oxidation potential of the radical X formed in the foregoing reaction scheme is preferably −0.7 V to −2.0 V, and more preferably −0.9 V to −1.6 V.

The compound of the type 5 is preferably represented by the formula (G).

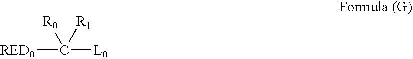

In the formula (G), RED₀ represents a reducible group; L₀ represents a split-off group; and R₀ to R₀₀ each represent a hydrogen atom or a substituent.

RED₀ and R₀, and R₀ and R₀₀ may be bonded to each other to form a ring structure.

RED₀ represents a group synonymous with RED₂ in the formula (C). Preferred ranges thereof are also the same.

R₀ and R₀₀ are each a group synonymous with R₂, and R₂₂ in the formula (C). Preferred ranges thereof are also the same. However, R₀ and R₀₀ do not represent a group synonymous with L₀ except for a hydrogen atom.

RED₀ and R₀ may be bonded to each other to form a ring structure. Examples of the ring structure include the same as in the case where RED₂ and R₂₁ in the formula (C) are connected to each other to form a ring structure. Preferred ranges thereof are also the same.

Examples of the ring structure formed when R₀ and R₀₀ are bonded to each other include a cyclopentane ring and a tetrahydrofuran ring.

In the formula (G), L₀ is a group synonymous with L₂ in the formula (C). Preferred ranges thereof are also the same.

It is preferable that the compound represented by the formula (G) has an adsorptive group onto silver halide or a partial structure of spectral sensitizing dye in the molecule. However, when L₀ represents a group other than a silyl group, two or more adsorptive groups cannot be present in the molecule at the same time.

However, two or more sulfide groups may be present as the adsorptive group regardless of L₀.

As the adsorptive group onto silver halide that the compound represented by the formula (G) has, the same examples as in the adsorptive group that the compounds of the types 1 to 4 of the invention may have are enumerated. Moreover, a selenoxo group (—C═Se—), a telluroxo group (—C═Te—), a seleno group (—Se—), a telluro group (—Te—), and an active methine group are enumerated.

Here, the selenoxo group (—C═Se—) and telluroxo group (—C═Te—) are Se or Te derivatives of compounds having a thione group (—C═S—), which may be a group containing a selenoamide group (—C═Se—NH—) or a telluramide group (—C═Te—NH—) as described previously about the thione group.

The seleno group (—Se—) and telluro group (—Te—) are also Se or Te derivatives of compounds having a sulfide group (—S—), examples of which include Se or Te substituted bodies of compounds having a sulfide group as they are. The active methine group means a methine group substituted with two electron withdrawing groups. The “electron withdrawing group” as referred to herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group.

Here, the two electron withdrawing groups may be bonded to each other to form a cyclic structure.

The adsorptive group that the compound represented by the formula (G) has is preferably a mercapto group (or a salt thereof), a thione group (—C═S—), a heterocyclic group containing at least one atom selected from a nitrogen atom, a sulfur atom, a selenium atom, and a tellurium atom, or a sulfide group; and more preferably a mercapto-substituted nitrogen-containing heterocyclic group or a nitrogen-containing heterocyclic group having an —NH— group capable of forming imino silver (>NAg) as a partial structure of heterocycle. These are the same as described previously with respect to the preferred ranges of the adsorptive group that the compounds of the types 1 to 4 may have.

The adsorptive group may be substituted at any position of the formula (G) but is substituted preferably on RED₀ or R₀, and more preferably on RED₀.

The partial structure of spectral sensitizing dye that the compound represented by the formula (G) may have is the same as the partial structure of spectral sensitizing dye that the compounds of the types 1 to 4 of the invention may have.

Specific examples of the compound represented by the formula (G) will be given below, but it should not be construed that the invention is limited thereto.

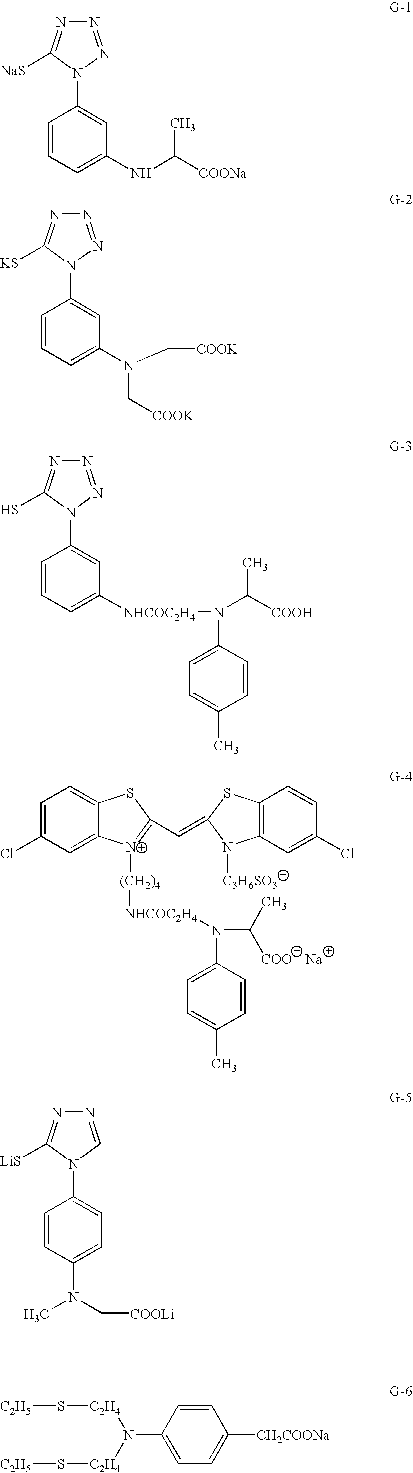

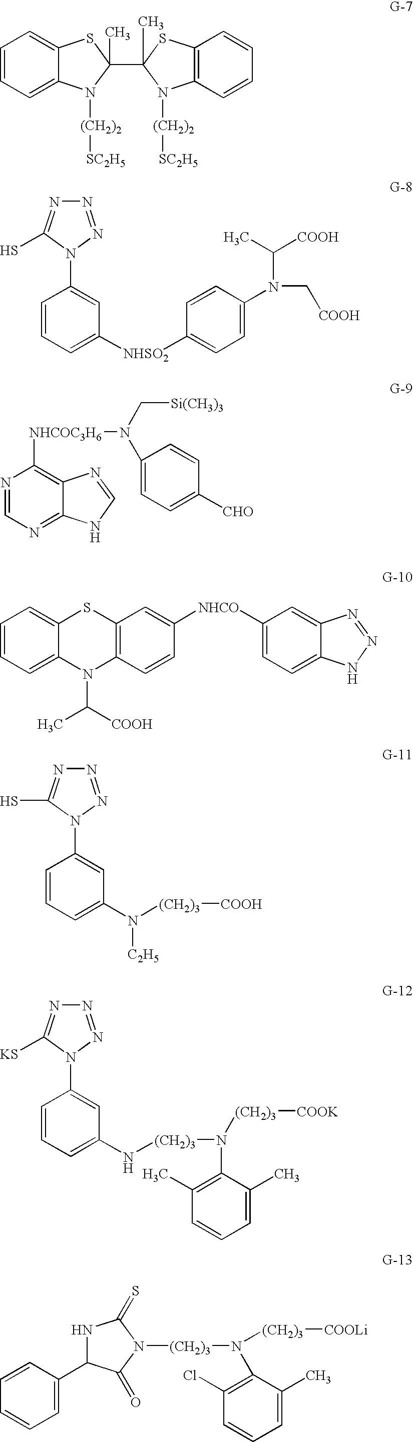

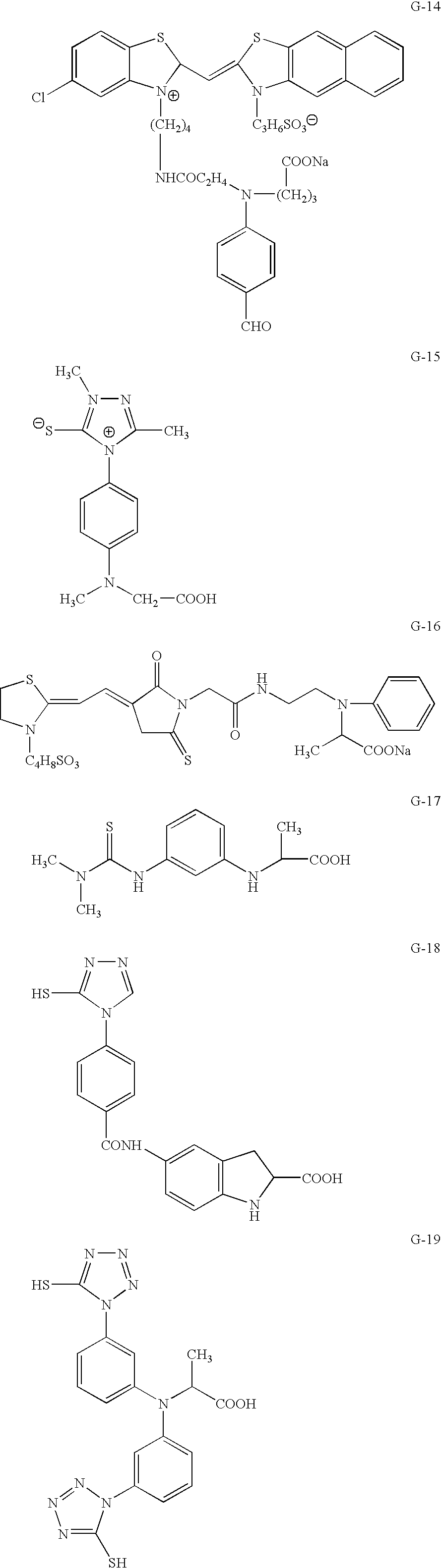

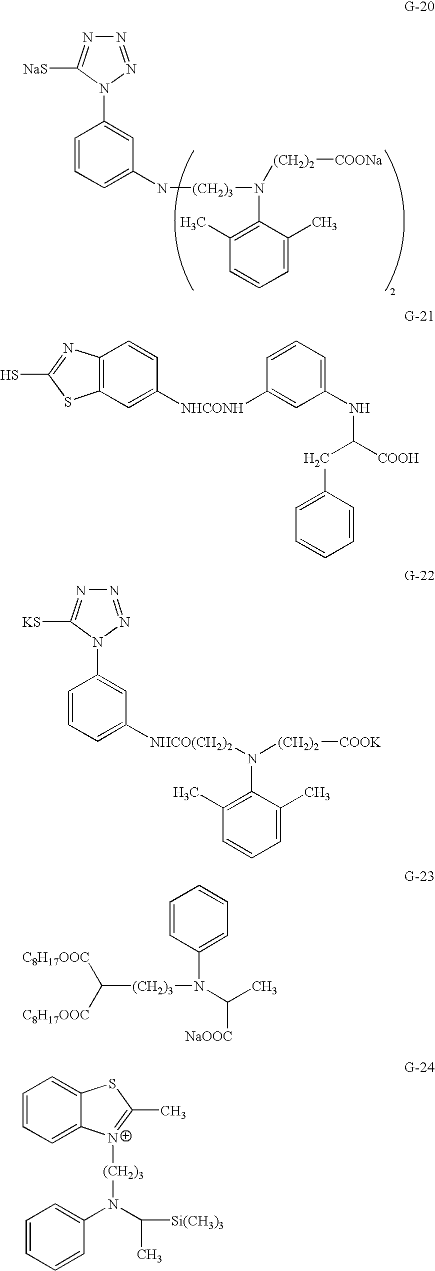

As specific examples of the compound represented by the formula (G), examples of compounds called “one photon two electron sensitizers” or “deprotonated electron donating sensitizers” as described in JP-A Nos. 9-211769 (Compounds PMT-1 to S-37 described in Tables E and F on pages 28 to 32), 9-211774 and 11-95355 (Compounds INV1 to 36), WO99/05570 (Compounds 1 to 74, 80 to 87 and 92 to 122), U.S. Pat. Nos. 5,747,235 and 5,747,236, EP-A Nos. 786692 (Compounds INV1 to 35) and 893732, and U.S. Pat. Nos. 6,054,260 and 5,994,051 are also enumerated as they are.

The compounds of the types 1 to 5 of the invention may be used in any case of the time of preparation of photosensitive silver halide emulsion or the time of production of photothermographic material, for example, the time of formation of photosensitive silver halide grains, the desalting step, the time of chemical sensitization, and before coating. Also, the compound may be added dividedly during such a step. The addition timing is preferably the time after completion of the formation of photosensitive silver halide grains and before the desalting step, the time of chemical sensitization (from just before start until just after completion of the chemical sensitization), or before coating, and more preferably from the time of chemical sensitization until mixing with a non-photosensitive organic silver salt.

It is preferable that the compounds of the types 1 to 5 of the invention are dissolved in water or a water-soluble solvent such as methanol and ethanol or a mixed solvent thereof and then added.

In the case where the compound is dissolved in water, with respect to a compound whose solubility increases if the pH is made high or low, the compound may be dissolved by increasing or decreasing the pH and then added.

It is preferable that the compounds of the types 1 to 5 of the invention are used in an emulsion layer containing a photosensitive silver halide and a non-photosensitive organic silver salt but may be added in the emulsion layer and also in a protective layer or intermediate layer and diffused at the time of coating.

The addition timing of the compound of the invention does not regard the addition timing of a sensitizing dye. The compound of the invention is contained in the silver halide emulsion layer preferably in an amount of 1×10⁻⁹ to 5×10⁻¹ moles, and more preferably 1×10⁻⁸ to 2×10⁻² moles per mole of the silver halide.

7) Compound Having an Adsorbing Group and a Reducing Group:

It is preferable that the photothermographic material of the invention contains a compound having an adsorbing group and a reducing group, which is represented by the following formula (I). This compound is used singly or in combination of the various chemical sensitizers described previously and can bring about an increase in sensitivity of the silver halide.

A-(W)ₙ-B Formula (I)

In the formula (I), A represents a group capable of adsorbing on silver halide (hereinafter referred to as “adsorbing group”); W represents a divalent connecting group; n is 0 or 1; and B represents a reducing group.

Next, the formula (I) will be described below in detail.

In the formula (I), the adsorbing group represented by A is a group of directly adsorbing on the silver halide or a group of accelerating adsorption onto the silver halide. Specific examples include a mercapto group (or a salt thereof), a thione group (—C(═S)—), a heterocyclic group containing at least one atom selected from a nitrogen atom, a sulfur atom, a selenium atom, and a tellurium atom, a sulfide group, a disulfide group, a cationic group, and an ethynyl group.

The mercapto group (or its salt) as the adsorbing group means a mercapto group (or a salt thereof) itself and at the same time, more preferably represents a heterocyclic group, an aryl group or an alkyl group, each of which is substituted with at least one mercapto group (or a salt thereof). The “heterocyclic group” as referred to herein means a 5-membered to 7-membered monocyclic or fused aromatic or non-aromatic heterocyclic group, examples of which include an imidazole ring group, a thiazole ring group, an oxazole ring group, a benzoimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, and a triazine ring group. Also, the heterocyclic ring may be a quaternary nitrogen atom-containing heterocyclic group. In that case, the substituted mercapto group may be dissociated into a meso ion. Examples of such a heterocyclic group include an imidazolium ring group, a pyrazolium ring group, a thiazolium ring group, a triazolium ring group, a tetrazolium ring group, a thiadiazolium ring group, a pyridinium ring group, a pyrimidinium group, and a triazinium ring group. Of these groups, a triazolium ring group (such as a 1,2,4-triazoilum-3-thiolate ring group) is preferable. Examples of the aryl group include a phenyl group and a naphthyl group. Examples of the alkyl group include a linear, branched or cyclic alkyl group having 1 to 30 carbon atoms. When the mercapto group forms a salt, examples of counter ions include cations of alkali metals, alkaline earth metals, and heavy metals (such as Li⁺, Na⁺, K⁺, Mg²⁺, Ag⁺, and Zn²⁺), an ammonium ion, quaternary nitrogen atom-containing heterocyclic groups, and a phosphonium ion.

The mercapto group as the adsorbing group may further be subjected to tautomerism to become a thione group. Specific examples include a thioamide group (a —C(═S)—NH— group) and groups containing a partial structure of the thioamide group, that is, linear or cyclic thioamide group, thioureido group, thiourethane group, or dithiocarbamic acid ester group. Examples of the term “cyclic” include a thiazolidin-2-thione group, an oxazolidin-2-thione group, a 2-thiohydantoin group, a rhodanine group, an isorhodanine group, a thiobarbituric acid group, and a 2-thioxo-oxazolidin-4-one group.

The thione group as the adsorbing group includes the case where the mercapto group is subjected to tautomerism to become a thione group and also includes linear or cyclic thioamide group, thioureido group, thiourethane group, or dithiocarbamic acid ester group, which cannot be subjected to tautomerism on the mercapto group (not having a hydrogen atom at the α-position of the thione group).

The heterocyclic group containing at least one atom selected from a nitrogen atom, a sulfur atom, a selenium atom, and a tellurium atom as the adsorbing group is a nitrogen-containing heterocyclic group having an —NH— group capable of forming imino silver (>NAg) as a partial structure of heterocycle, or a heterocyclic group having an —S— group, an —Se— group, a —Te— group, or an═N— group, each of which can be coordinated on silver ion via coordination bond, as a partial structure of heterocycle. Examples of the former include a benzotriazole group, a triazole group, an indazole group, a pyrazole group, a tetrazole group, a benzoimidazole group, an imidazole group, and a purine group; and examples of the latter include a thiophene group, a thiazole group, an oxazole group, a benzothiophene group, a benzothiazole group, a benzoxazole group, a thiadiazole group, an oxadiazole group, a triazine group, a selenoazole group, a benzoselenoazole group, a tellurazole group, and a benzotellurazole ring. Of these groups, the former groups are preferable.

The sulfide group or disulfide group as the adsorbing group includes all groups having a partial structure of —S— or —S—S—. The sulfide group or disulfide group is preferably a group having a partial structure of alkyl (or alkylene)-X-alkyl (or alkylene), aryl (or arylene)-X-alkyl (or alkylene), or aryl (or arylene)-X-aryl (or arylene). Here, X represents an —S— group or an —S—S— group. Further, the sulfide group or disulfide group may form a cyclic structure. Specific examples of the case of forming the cyclic structure include groups containing a thiorane ring, a 1,3-dithiorane ring, a 1,2-dithiorane ring, a thiane ring, a dithiane ring, or a thiomorpholine ring. As the sulfide group, groups having a partial structure of alkyl (or alkylene)-S-alkyl (or alkylene) are especially preferable; and as the disulfide group, a 1,2-dithiorane ring is especially preferable.

The cationic group as the adsorbing group means a quaternary nitrogen atom-containing group, specifically a group containing an ammonio group or a quaternary nitrogen atom-containing nitrogen-containing heterocyclic group. The “ammonio group” as referred to herein means a trialkylammonio group, a dialkylarylammonio group, an alkyldiarylammonio group, etc., examples of which include a benzyl-dimethylammonio group, a trihexylammonio group, and a phenyl-diethylammonio group. Examples of the quaternary nitrogen atom-containing nitrogen-containing heterocyclic group include a pyridinio group, a quinolinio group, an isoquinolinio group, and an imidazolio group. Of these groups, a pyridinio group and an imidazolio group are preferable, and a pyridinio group is especially preferable. The quaternary nitrogen atom-containing nitrogen-containing heterocyclic group may have an arbitrary substituent. In the case of the pyridinio group and imidazolio group, preferred examples of the substituent include an alkyl group, an aryl group, an acylamino group, a chlorine atom, an alkoxycarbonyl group, and a carbamoyl group; and in the case of the pyridinio group, the substituent is especially preferably a phenyl group.

The ethynyl group as the adsorbing group means a —CCH group, in which the hydrogen atom may be substituted.

The adsorbing group may have an arbitrary substituent. Examples of substituents include a halogen atom (such as a fluorine atom, a chlorine atom, a bromine atom, and an iodine atom), an alkyl group (linear, branched or cyclic alkyl groups including a bicycloalkyl group and an active methine group), an alkenyl group, an alkynyl group, an aryl group, a heterocyclic group (regardless of the substitution position), an acyl group, an alkoxycarbonyl group, an aryloxycarbonyl group, a heterocyclic oxycarbonyl group, a carbamoyl group, an N-hydroxycarbamoyl group, an N-acylcarbamoyl group, an N-sulfonylcarbamoyl group, an N-carbamoylcarbamoyl group, a thiocarbamoyl group, an N-sulfamoylcarbamoyl group, a carbazoyl group, a carboxy group or a salt thereof, an oxalyl group, an oxamoyl group, a cyano group, a carbonimidoyl group, a formyl group, a hydroxyl group, an alkoxy group (including groups repeatedly containing an ethyleneoxy group or a propyleneoxy group), an aryloxy group, a heterocyclic oxy group, an acyloxy group, an (alkoxy or aryloxy)carbonyloxy group, a carbamoyloxy group, a sulfonyloxy group, an amino group, an (alkyl, aryl or heterocyclic)amino group, an acylamino group, a sulfonamide group, a ureido group, a thioureido group, an N-hydroxyureido group, an imido group, an (alkoxy or aryloxy)carbonylamino group, a sulfamoylamino group, a semicarbazide group, a thiosemicarbazide group, a hydrazino group, an ammonio group, an oxamoylamino group, an N-(alkyl or aryl)sulfonylureido group, an N-acylureido group, an N-acyl-sulfamoylamino group, a hydroxyamino group, a nitro group, a quaternary nitrogen atom-containing heterocyclic group (such as a pyridinio group, an imidazolio group, a quinolio group, and an isoquinolio group), an isocyano group, an imino group, a mercapto group, an (alkyl, aryl or heterocyclic)thio group, an (alkyl, aryl or heterocyclic)dithione group, an (alkyl or aryl)sulfonyl group, an (alkyl or aryl)sulfinyl group, a sulfo group or salts thereof, a sulfamoyl group, an N-acylsulfamoyl group, an N-sulfonylsulfamoyl group or salts thereof, a phosphino group, a phosphinyl group, a phosphinyloxy group, a phosphinylamino group, and a silyl group. Here, the “active methine group” as referred to herein means a methine group substituted with two electron withdrawing groups; and the “electron withdrawing group” as referred to herein means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. The two electron withdrawing groups may be bonded to each other to form a cyclic structure. Also, the “salt” as referred to herein means a cation of an alkali metal, an alkaline earth metal or a heavy metal, an ammonium ion, or an organic cation such as a phosphonium ion.

Further, as specific examples of the adsorbing group, those described in JP-A No. 11-95355, pages 4 to 7 are enumerated.

In the formula (I), the adsorbing group represented by A is preferably a mercapto-substituted heterocyclic group (such as a 2-mercaptothiadiazole group, a 3-mercapto-1,2,4-triazole group, a 5-mercaptotetrazole group, a 2-mercapto-1,3,4-oxadiazole group, a 2-mercaptobenzthiazole group, a 2-mercaptobenzimidazole group, and a 1,5-dimethyl-1,2,4-triazolium-3-thiolate group), a dimercapto-substituted heterocyclic group (such as a 2,4-dimercaptopyrimidine group, a 2,4-dimercaptotriazine group, a 3,5-dimercapto-1,2,4-triazole ring, and a 2,5-dimercapto-1,3-thiazole group), or a nitrogen-containing heterocyclic group having an —NH— group capable of forming imino silver (>NAg) as a partial structure of heterocycle (such as a benzotriazole group, a benzimidazole group, and an imidazole group); and especially preferably a dimercapto-substituted heterocyclic group.

In the formula (I), W represents a divalent connecting group. Any connecting group is employable so far as it does not adversely affect photographic properties. For example, divalent connecting groups constituted of a carbon atom, a hydrogen atom, an oxygen atom, a nitrogen atom, or a sulfur atom can be utilized. Specific examples include an alkylene group having 1 to 20 carbon atoms (such as a methylene group, an ethylene group, a trimethylene group, a tetramethylene group, and a hexamethylene group), an arylene group having 6 to 20 carbon atoms (such as a phenylene group and a naphthylene group), —CONR₁—, —SO₂NR₂—, —O—, —S—, —NR₃—, —NR₄CO—, —NR₅SO₂—, —NR₆CONR₇—, —COO—, —OCO—, and combinations of these connecting groups. Here, R₁, R₂, R₃, R₄, R₅, R₆, and R₇ each represent a hydrogen atom, an aliphatic group, or an aryl group. The aliphatic group represented by R₁, R₂, R₃, R₄, R₅, R₆, or R₇ is preferably one having 1 to 30 carbon atoms; and especially preferably a linear, branched or cyclic alkyl group, alkenyl group, alkynyl group or aralkyl group having 1 to 20 carbon atoms (such as a methyl group, an ethyl group, an isopropyl group, a t-butyl group, an n-octyl group, an n-decyl group, an n-hexadecyl group, a cyclopropyl group, a cyclopentyl group, a cyclohexyl group, an allyl group, a 2-butenyl group, a 3-pentenyl group, a propargyl group, a 3-pentynyl group, and a benzyl group). In the formula (I), the aryl group represented by R₁, R₂, R₃, R₄, R₅, R₆, or R₇ is preferably a monocyclic or fused aryl group having 6 to 30 carbon atoms, and more preferably 6 to 20 carbon atoms, examples of which include a phenyl group and a naphthyl group. The foregoing substituent represented by R₁, R₂, R₃, R₄, R₅, R₆, or R₇ may further have other arbitrary substituent. This arbitrary substituent is synonymous with the substituent of the adsorbing group described previously.

In the formula (I), the reducing group represented by B represents a group capable of reducing a silver ion. Examples include residues of compounds selected from hydroxylamines, hydroxamic acids, hydroxyureas, hydroxyurethanes, hydroxysemicarbazides, reductoins (including reducton derivatives), anilines, phenols (chroman-6-ols, 2,3-dihydrobenzofuran-5-ols, aminophenols, sulfonamidophenols, hydroquinones, catechols, resorcinols, benzenetriols, and polyphenols such as bisphenols), hydrazines, hydrazides, and phenidones.

The hydroxylamines are a compound represented by the formula (B1); the hydroxamic acids are a compound represented by the formula (B2); the hydroxyureas are a compound represented by the formula (B3); the hydroxyurethanes are a compound represented by the formula (B4); the hydroxysemicarbazides are a compound represented by the formula (B5); the reductoins are a compound represented by the formula (B6); the anilines are a compound represented by the formula (B7); the phenols are a compound represented by the formula (B8), (B9) or (B10); the hydrazines are a compound represented by the formula (B11); the hydrazides are a compound represented by the formula (B12); and the phenidones are a compound represented by the formula (B13).

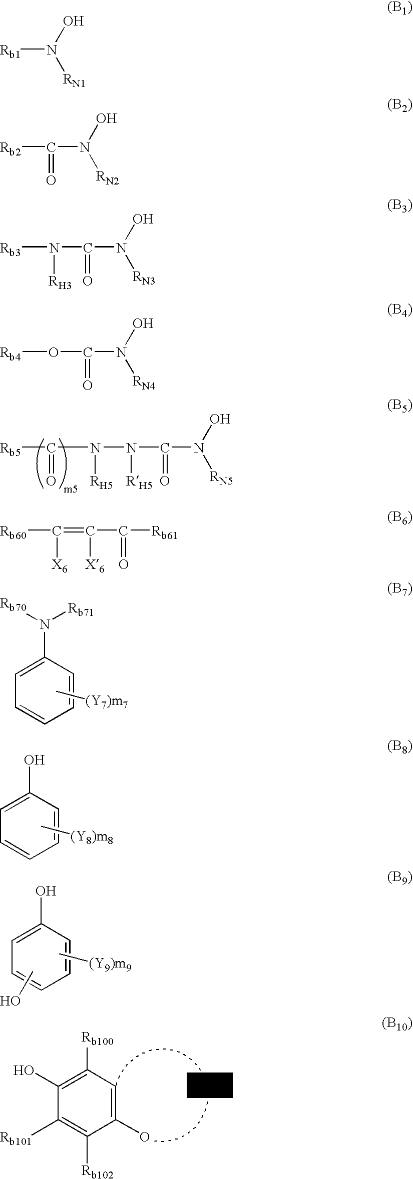

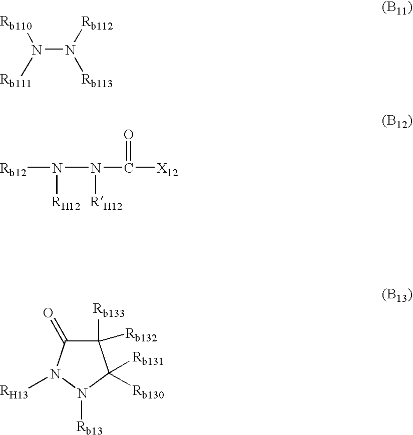

In the formulae (B1) to (B13), R_{b1}, R_{b2}, R_{b3}, R_{b4}, R_{b5}, R_{b70}, R_{b71}, R_{b110}, R_{b111}, R_{b112}, R_{b113}, R_{b12}, R_{b13}, R_{N1}, R_{N2}, R_{N3}, R_{N4}, and R_{N5} each represent a hydrogen atom, an alkyl group, an aryl group, or a heterocyclic group; R_{H3}, R_{H5}, R′_{H5}, R_{H12}, and R_{H13} each represent a hydrogen atom, an alkyl group, an aryl group, an acyl group, an alkylsulfonyl group, or an arylsulfonyl group; and of these groups, R_{H3} may further be a hydroxyl group. R_{b110}, R_{b101}, R_{b102}, and R_{b130} to R_{b33} each represent a hydrogen atom or a substituent. Y₇ and Y₈ each represent a substituent other than a hydroxyl group; Y₉ represents a substituent; m₅ is 0 or 1; m₇ represents an integer from 0 to 5; m₈ represents an integer from 1 to 5; and m₉ represents an integer from 0 to 4. Each of Y₇, Y₈, and Y₉ may be an aryl group fused with the benzene ring (such as a benzene fused ring) and may further have a substituent. Z₁₀ represents a non-metallic atomic group capable of forming a ring; and X₁₂ represents a hydrogen atom, an alkyl group, an aryl group, a heterocyclic group, an alkoxy group, an amino group (including an alkylamino group, an arylamino group, a heterocyclic amino group, and a cyclic amino group), or a carbamoyl group.

In the formula (B6), X₆ and X′₆ each represent a hydroxyl group, an alkoxy group, a mercapto group, an alkylthio group, an amino group (including an alkylamino group, an arylamino group, a heterocyclic amino group, and a cyclic amino group), an acylamino group, a sulfonamide group, an alkoxycarbonylamino group, a ureido group, an acyloxy group, an acylthio group, an alkylaminocarbonyloxy group, or an arylaminocarbonyloxy group. R_{b60} and R_{b61} each represent an alkyl group, an aryl group, an amino group, an alkoxy group, or an aryloxy group; and R_{b60} and R_{b61} may be bonded to each other to form a cyclic structure.

In the foregoing description regarding each of the groups in the formulae (B1) to (B13), the alkyl group means a linear, branched or cyclic, substituted or unsubstituted alkyl group having 1 to 30 carbon atoms; the aryl group means a monocyclic or fused, substituted or unsubstituted aromatic hydrocarbon ring such as a phenyl group and a naphthyl group; and the heterocyclic group means an aromatic or non-aromatic, monocyclic or fused, substituted or unsubstituted heterocyclic group containing at least one hetro atom.

Also, in the description regarding each of the groups in the formulae (B1) to (B13), the substituent is synonymous with the substituent of the adsorbing group as described previously. The substituent may be further substituted with such a substituent.

In the formulae (B1) to (B5), R_{N1}, R_{N2}, R_{N3}, R_{N4}, and R_{N5} are each preferably a hydrogen atom or an alkyl group. The alkyl group as referred to herein is preferably a linear, branched or cyclic, substituted or unsubstituted alkyl group having 1 to 12 carbon atoms, and more preferably a linear or branched substituted or unsubstituted alkyl group having 1 to 6 carbon atoms, specific examples of which include a methyl group, an ethyl group, a propyl group, and a benzyl group.

In the formula (B1), R_{b1} is preferably an alkyl group or a heterocyclic group. The alkyl group as referred to herein is preferably a linear, branched or cyclic, substituted or unsubstituted alkyl group having 1 to 30 carbon atoms, and more preferably an alkyl group having 1 to 18 carbon atoms. The heterocyclic group as referred to herein is a 5-membered or 6-membered, monocyclic or fused, aromatic or non-aromatic heterocyclic group, which may have a substituent. The heterocyclic group is preferably an aromatic heterocyclic group, examples of which include a pyridine ring group, a pyrimidine ring group, a triazine ring group, a thiazole ring group, a benzothiazole ring group, an oxazole ring group, a benzoxazole ring group, an imidazole ring group, a benzimidazole ring group, a pyrazole ring group, an indazole ring group, an indole ring group, a purine ring group, a quinoline ring group, an isoquinoline ring group, and a quinazoline ring group. Of these groups, a triazine ring group and a benzothiazole ring group are especially preferable. The case where the alkyl group or heterocyclic group represented by R_{b1} additionally has one or two or more —N(R_{N1})OH groups as the substituent is also a preferred example of the compound represented by the formula (B1).

In the formula (B2), R_{b2} is preferably an alkyl group, an aryl group, or a heterocyclic group, and more preferably an alkyl group or an aryl group. Preferred ranges of the alkyl group are the same as in R_{b1}. The aryl group is preferably a phenyl group or a naphthyl group, and especially preferably a phenyl group, which may have a substituent. The case where the group represented by R_{b2} additionally has one or two or more —CON(R_{N2})OH groups as the substituent is also a preferred example of the compound represented by the formula (B2).

In the formula (B3), R_{b3} is preferably an alkyl group or an aryl group, and preferred ranges thereof are the same as in R_{b1} and R_{b2}. R_{H3} is preferably a hydrogen atom, an alkyl group, or a hydroxyl group, and more preferably a hydrogen atom. The case where the group represented by R_{b3} additionally has one or two or more —N(R_{H3})CON(R_{N3})OH groups as the substituent is also a preferred example of the compound represented by the formula (B3). Also, R_{b3} and R_{N3} may be bonded to each other to form a ring structure (preferably a 5-membered or 6-membered saturated heterocycle).

In the formula (B4), R_{b4} is preferably an alkyl group, and preferred ranges thereof are the same as in R_{b1}. The case where the group represented by R_{b4} additionally has one or two or more —OCON(R_{N4})OH groups as the substituent is also a preferred example of the compound represented by the formula (B4).

In the formula (B5), R_{b5} is preferably an alkyl group or an aryl group, and more preferably an aryl group. Preferred ranges thereof are the same as in R_{b1} and R_{b2}. R_{H5} and R′_{H5} are each preferably a hydrogen atom or an alkyl group, and more preferably a hydrogen atom.

In the formula (B6), the case where R_{b60} and R_{b61} are bonded to each other to form a ring structure is preferable. The cyclic structure as formed herein is a 5-membered to 7-membered non-aromatic carbocycle or heterocycle, which may be monocyclic or fused. Preferred specific examples of the ring structure include a 2-cyclopenten-1-one ring, a 2,5-dihydrofuran-2-one ring, a 3-pyrrolin-2-one ring, a 4-pyrazolin-3-one ring, a 2-cyclohexen-1-one ring, a 5,6-dihydro-2H-pyran-2-one ring, a 5,6-dihydro-2-pyridone ring, a 1,2-dihydrophthalen-2-one ring, a coumalin ring (a benzo-α-pyran-2-one ring), a 2-quinolone ring, a 1,4-dihydronaphthalen-1-one ring, a chromone ring (a benzo-γ-pyran-4-one ring), a 4-quinolone ring, an inden-1-one ring, a 3-pyrrolin-2,4-dione ring, a uracil ring, a thiouracil ring, and a dithiouracil ring; more preferably a 2-cyclopenten-1-one ring, a 2,5-dihydrofuran-2-one ring, a 3-pyrrolin-2-one ring, a 4-pyrazolin-3-one ring, a 1,2-dihydronaphthalen-2-one ring, a coumalin ring (a benzo-α-pyran-2-one ring), a 2-quinolone ring, a 1,4-dihydronaphthalen-1-one ring, a chromone ring (a benzo-γ-pyran-4-one ring), a 4-quinolone ring, an inden-1-one ring, and a dithiouracil ring; and further preferably a 2-cyclopenten-1-one ring, a 2,5-dihydrofuran-2-one ring, a 3-pyrrolin-2-one ring, an inden-1-one ring, and a 4-pyrazolin-3-one ring.

When X₆ and X′₆ each represent a cyclic amino group, the cyclic amino group is a non-aromatic nitrogen-containing heterocyclic ring to be bonded at the nitrogen atom, and examples include a pyrrolidino group, a piperidino group, a piperazino group, a morpholino group, a 1,4-thiazin-4-yl group, a 2,3,5,6-tetrahydro-1,4-thiazin-4-yl group, and an indolyl group.

X₆ and X′₆ are each preferably a hydroxyl group, a mercapto group, an amino group (including an alkylamino group, an arylamino group, and a cyclic amino group), an acylamino group, a sulfonamide group, an acyloxy group, or an acylthio group; more preferably a hydroxyl group, a mercapto group, an amino group, an alkylamino group, a cyclic amino group, a sulfonamide group, an acylamino group, or an acyloxy group; and especially preferably a hydroxyl group, an amino group, an alkylamino group, or a cyclic amino group. Further, it is preferable that at least one of X₆ and X′₆ is a hydroxyl group.

In the formula (B7), R_{b70} and R_{b71} are each preferably a hydrogen atom, an alkyl group, or an aryl group; and more preferably an alkyl group. Preferred ranges of the alkyl group are the same as in R_{b1}. R_{b70} and R_{b71} may be bonded to each other to form a cyclic structure (such as a pyrrolidine ring, a piperidine group, a morpholino ring, and a thiomorpholino ring). As the substituent represented by Y₇, an alkyl group (preferred ranges thereof are the same as in R_{b1}), an alkoxy group, an amino group, an acylamino group, a sulfonamide group, a ureido group, an acyl group, an alkoxycarbonyl group, a carbamoyl group, a sulfamoyl group, a chlorine atom, a sulfo group or a salt thereof, and a carboxy group or a salt thereof are preferable; and m₇ preferably represents 0 to 2.

In the formula (B8), m₈ is preferably from 1 to 4; and plural Y₈s′ may be the same or different. Y₈ when m₈ is 1, or at least one of plural Y₈s′ when m₈ is 2 or more, is preferably an amino group (including an alkylamino group and an arylamino group), a sulfonamide group, or an acylamino group. When m₈ is 2 or more, it is preferable that the remaining Y₈ or Y₈s′ represent a sulfonamide group, an acylamino group, a ureido group, an alkyl group, an alkylthio group, an acyl group, an alkoxycarbonyl group, a carbamoyl group, a sulfo group or a salt thereof, a carboxy group or a salt thereof, or a chlorine atom. In the case where the ortho- or para-position of the hydroxyl group is substituted with an o′- (or p′-)hydroxyphenylmethyl group (which may further have a substituent) as the substituent represented by Y₈, the compound represents a group of compounds generally called a bisphenol. That case is also a preferred example of the compound represented by the formula (B8). Further, the case where Y₈ represents a benzene fused ring, and as a result, the formula (B8) represents a naphthol is also very preferable.

In the formula (B9), the substitution positions of the two hydroxyl groups may be the ortho-position (catechols), meta-position (resorcinols) or para-position (hydroquinones) each other. m₉ is preferably from 1 to 2, and plural Y₉s′ may be the same or different. As the substituent represented by Y₉, a chlorine atom, an acylamino group, a ureido group, a sulfonamide group, an alkyl group, an alkylthio group, an alkoxy group, an acyl group, an alkoxycarbonyl group, a carbamoyl group, a sulfo group or a salt thereof, a carboxy group or a salt thereof, a hydroxyl group, an alkylsulfonyl group, and an arylsulfonyl group are preferable. The case where Y₉ represents a benzene fused ring, and as a result, the formula (B9) represents a 1,4-naphthohydroquinone is also preferable. When the formula (B9) represents a catechol, it is especially preferable that Y₉ is a sulfo group or a salt thereof or a hydroxyl group.

In the formula (B10), when R_{b100}, R_{b101}, and R_{b102} each represent a substituent, preferred examples of the substituents are the same as those in Y₉. Of these groups, an alkyl group (especially a methyl group) is preferable. As the ring structure formed by Z₁₀, a chromane ring and a 2,3-dihydrobenzofuran ring are preferable. The ring structure may have a substituent or may form a spiro ring.

In the formula (B11), R_{b110}, R_{b111}, R_{b112}, and R_{b113} are each preferably an alkyl group, an aryl group, or a heterocyclic group. Preferred ranges thereof are the same as in R_{b1} and R_{b2}. Of these groups, an alkyl group is preferable, and two alkyl groups in R_{b110} to R_{b113} may be bonded to each other to form a cyclic structure. The “cyclic structure” as referred to herein means a 5-membered or 6-membered non-aromatic heterocycle, examples of which include a pyrrolidine ring, a piperidine ring, a morpholino ring, a thiomorpholino ring, and a hexahydropyridazine ring.

In the formula (B12), R_{b12} is preferably an alkyl group, an aryl group, or a heterocyclic group, and preferred ranges thereof are the same as in R_{b1} and R_{b2}. X₁₂ is preferably an alkyl group, an aryl group (especially a phenyl group), a heterocyclic group, an alkoxy group, an amino group (including an alkylamino group, an arylamino group, a heterocyclic amino group, and a cyclic amino group), or a carbamoyl group; and more preferably an alkyl group (especially an alkyl group having 1 to 8 carbon atoms), an aryl group (especially preferably a phenyl group), or an amino group (including an alkylamino group, an arylamino group, and a cyclic amino group). R_{H12} and R′_{H12} are each preferably a hydrogen atom or an alkyl group, and more preferably a hydrogen atom.

In the formula (B13), R_{b13} is preferably an alkyl group or an aryl group, and preferred ranges thereof are the same as in R_{b1} and R_{b2}. R_{b130}, R_{b131}, R_{b132}, and R_{b133} are each preferably a hydrogen atom, an alkyl group (especially preferably an alkyl group having 1 to 8 carbon atoms), or an aryl group (especially preferably a phenyl group). R_{H13} is preferably a hydrogen atom or an acyl group, and more preferably a hydrogen atom.

In the formula (I), B represents a reducing group, preferred examples of which include hydroxylamines, hydroxamic acids, hydroxyureas, hydroxysemicarbazides, phenols, hydrazines, hydrazides, and phenidones. Of these, hydroxyureas, hydroxysemicarbazides, phenols, hydrazides, and phenidones are especially preferable.

In the formula (I), the oxidation potential of the reducing group represented by B can be measured using the measurements described in Akira Fujishima, Denkikagaku Sokuteiho (Electrochemical Measurement), pages 150 to 208, Gihodo Shuppan and The Chemical Society of Japan ed., Jikken Kagaku Koza (Course of Experimental Chemistry), 4^{th} Ed., Vol. 9, pages 282 to 344, Maruzen. The oxidation potential can be measured by the rotary disk voltammetry technology. Concretely, the oxidation potential is one measured by dissolving a sample in a solution of methanol/a Britton-Robinson buffer having pH of 6.5 of 10/90 (by volume), passing a nitrogen gas therethrough for 10 minutes, and then measuring the oxidation potential at 25° C., at 1,000 rpm and at a sweep rate of 20 mV/sec using a glassy carbon-made rotary disk electrode (RDE) as a working electrode, a platinum wire as a counter electrode and a saturated calomel electrode as a reference electrode, respectively. A half-wave potential (E1/2) can be determined from the resulting voltammogram.

It is preferable that the reducing group represented by B of the invention has an oxidation potential, as measured according to the foregoing measurement, ranging from about −0.3 V to about 1.0V. The oxidation potential is more preferably in the range of about −0.1 V to about 0.8 V, and especially preferably about 0 to about 0.7 V.

With respect to the reducing group represented by B of the invention, the major part thereof is known, examples of which are described in patent documents such as JP-A Nos. 2001-42466, 8-114884, 8-314051, 8-333325, 9-133983, 11-282117, 10-246931, 10-90819, 9-54384, 10-171060, and 7-77783. Also, as the phenols, compounds described in U.S. Pat. No. 6,054,260 (the general formulae and compound examples thereof described in columns 60 to 63) are enumerated.

The compound of the formula (I) of the invention may be incorporated with a ballast group or a polymer chain commonly employed in immobile photographic additives such as couplers. Also, as the couplers, those described in, for example, JP-A No. 1-100530 are enumerated.

The compound of the formula (I) of the invention may be a bis body or a tris body. The compound of the formula (I) of the invention preferably has a molecular weight of 100 to 10,000, more preferably 120 to 1,000, and especially preferably 150 to 500.

Specific examples of the compound of the formula (I) of the invention will be given below, but it should not be construed that the invention is limited thereto.

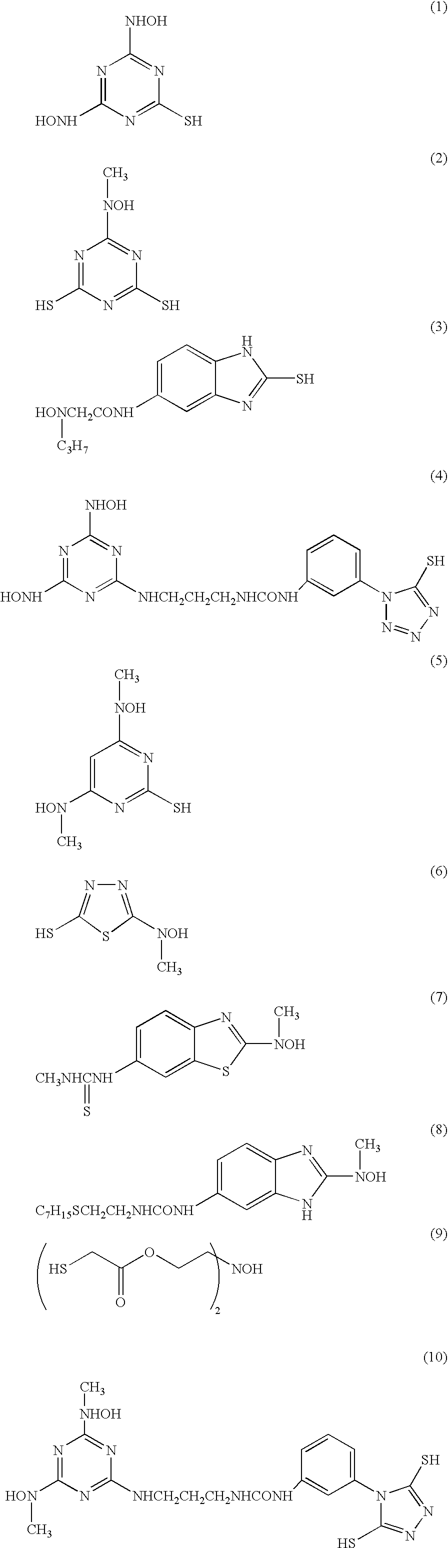

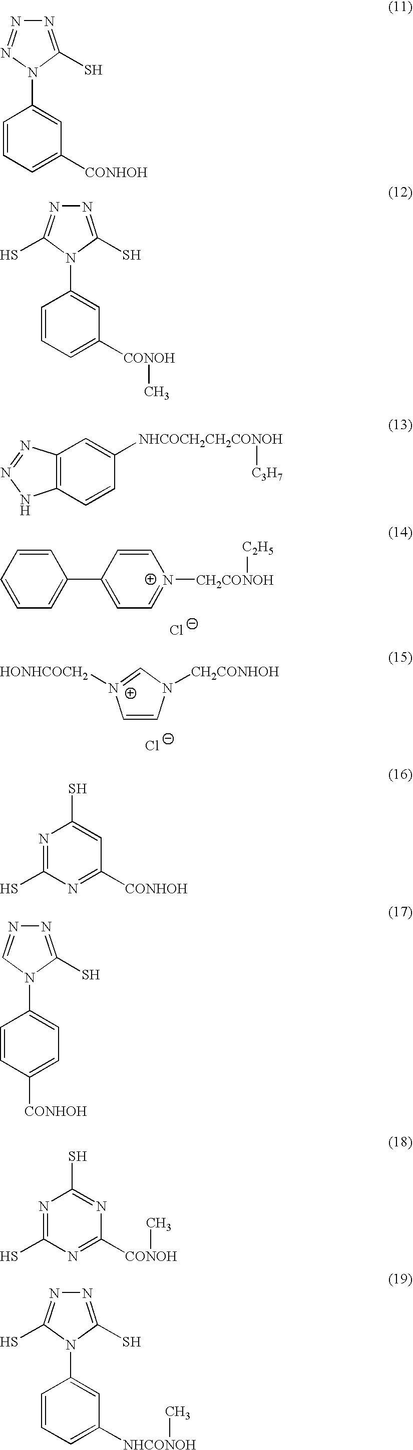

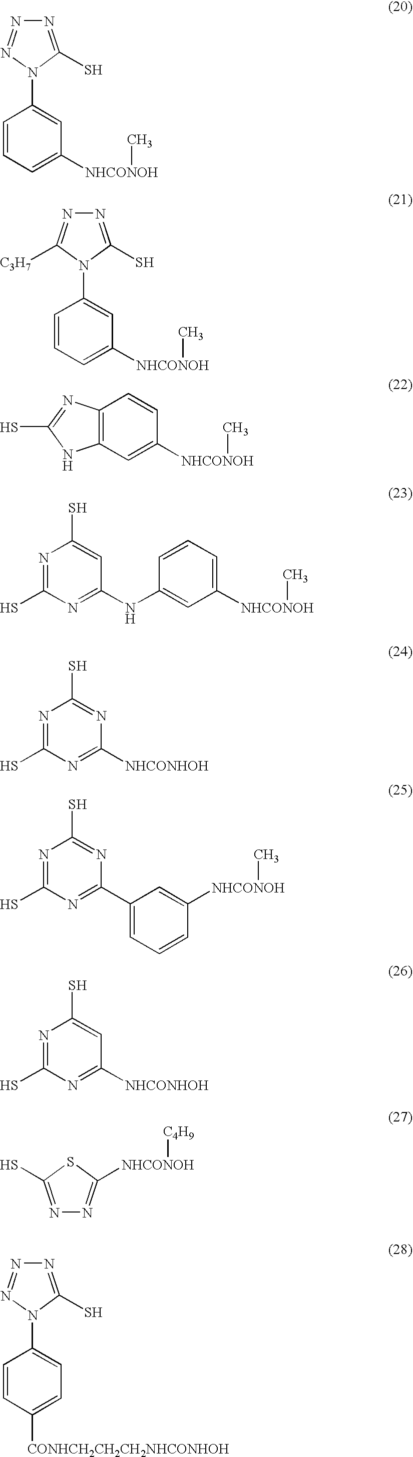

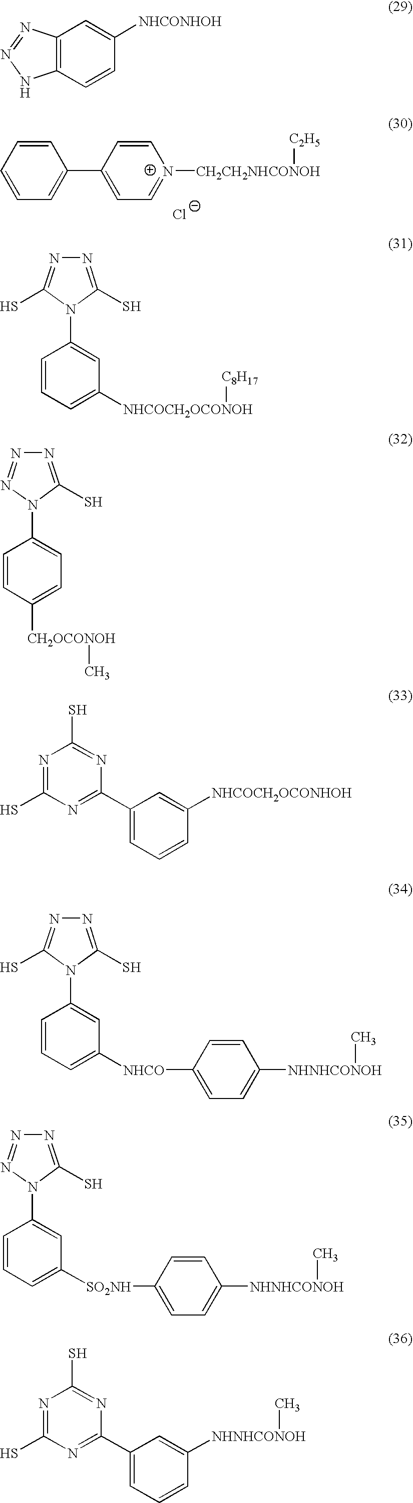

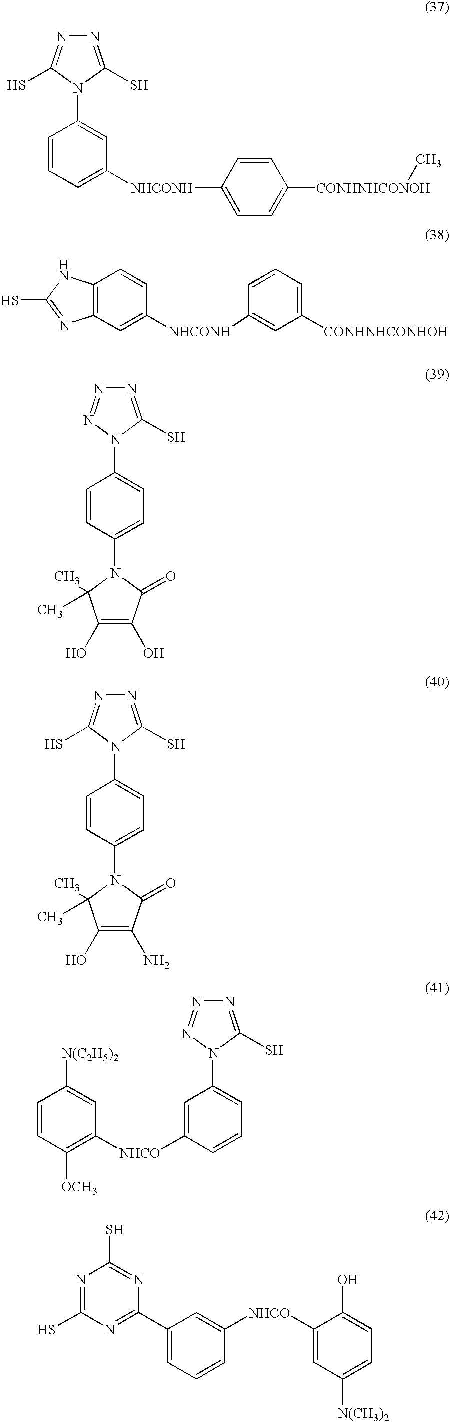

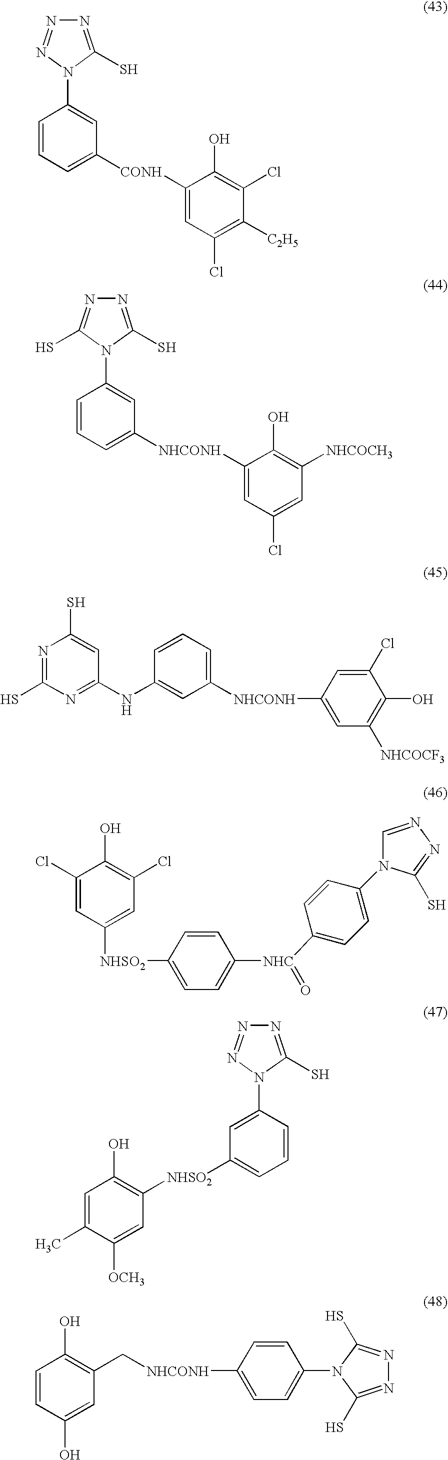

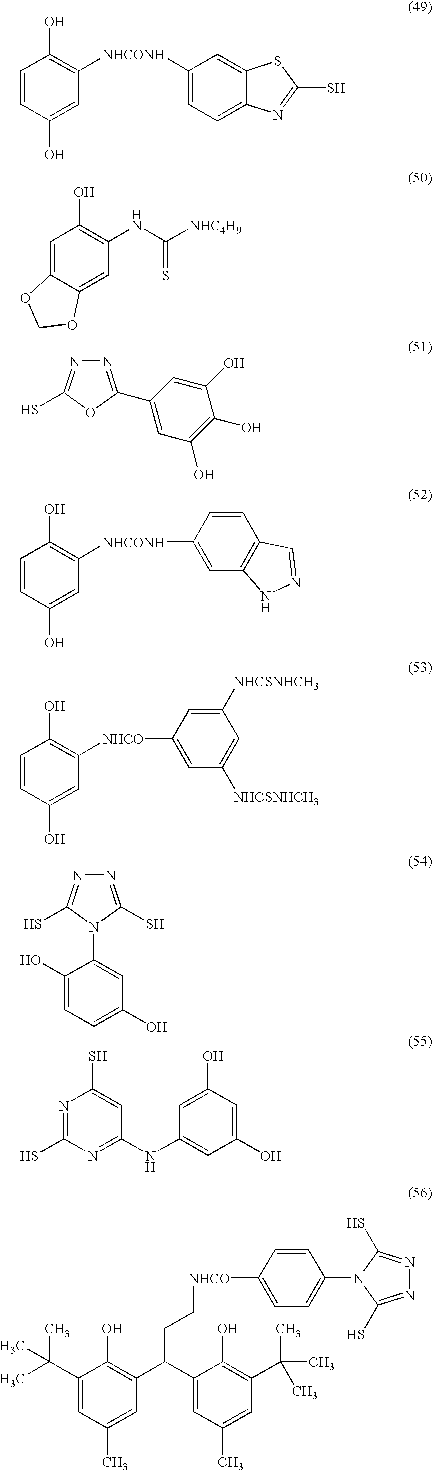

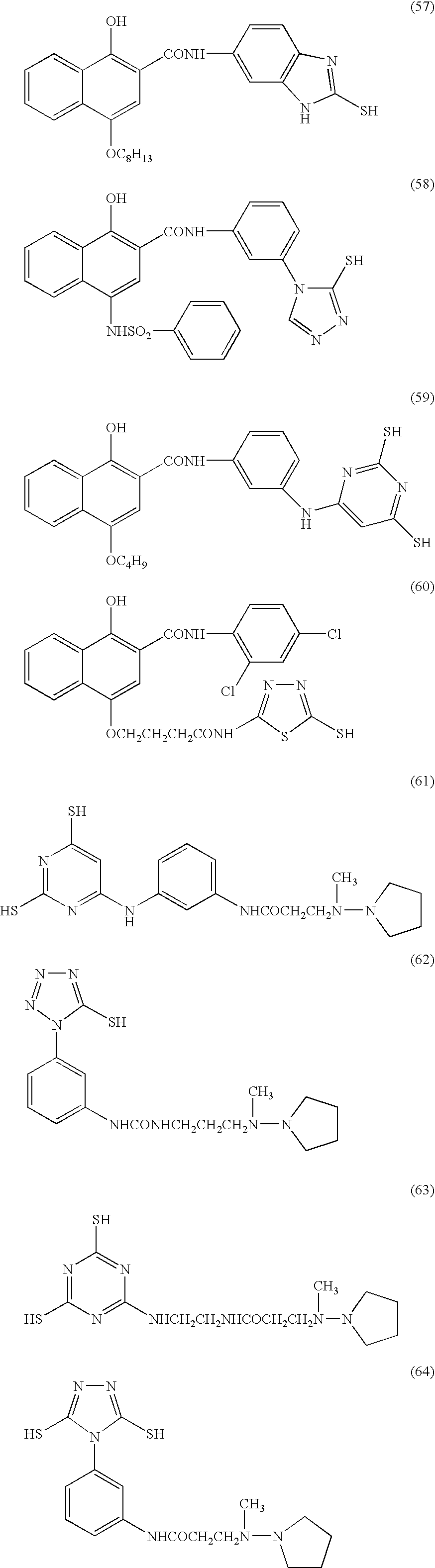

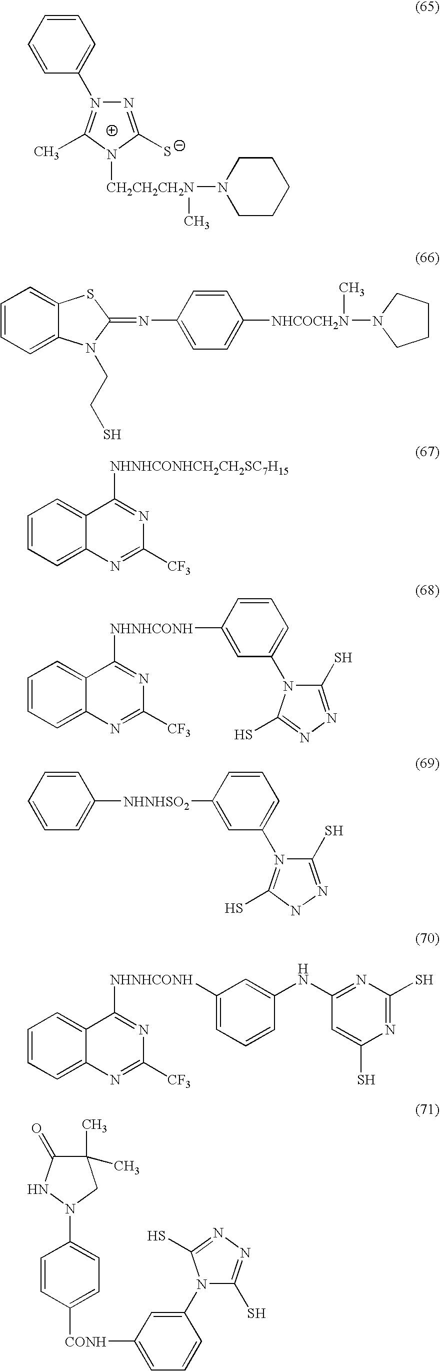

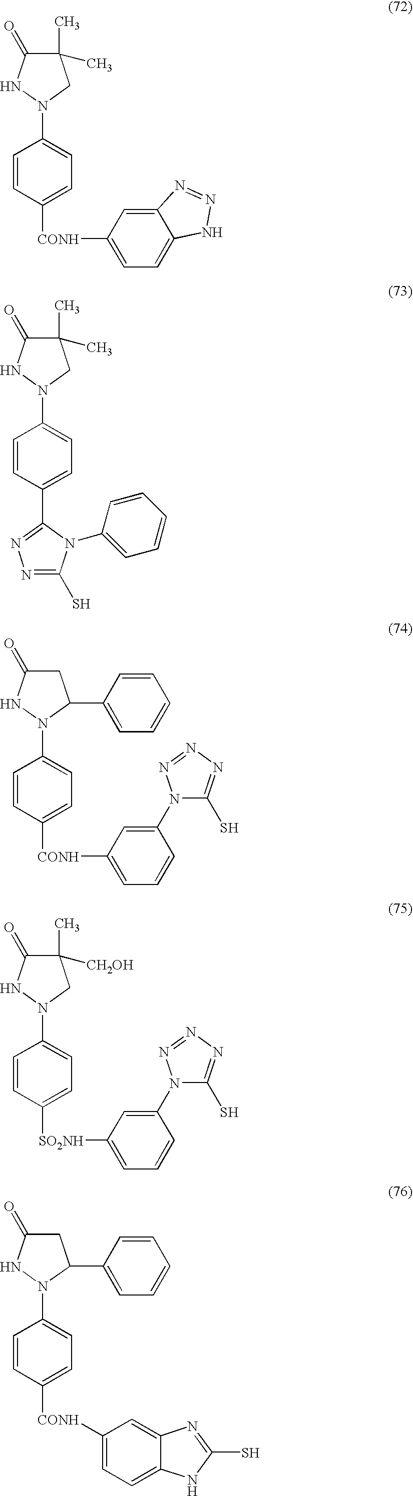

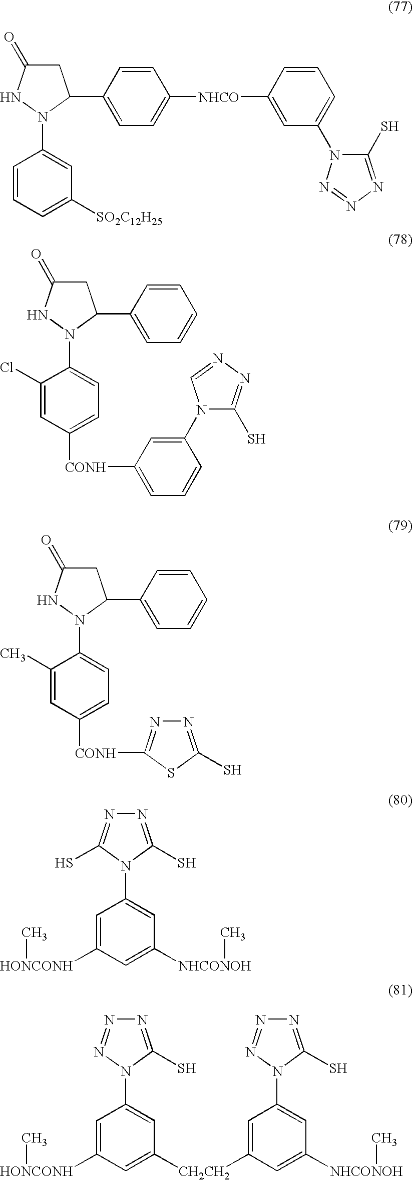

The compound of the invention can be easily synthesized according to known methods.

Though the compound of the formula (I) of the invention may be used singly, it is preferable that two or more kinds of the compound are used at the same time. In the case of using two or more kinds of the compound, they may be added to the same layer or a different layer from each other. Also, they may be added by a different addition method from each other.

The compound of the formula (I) of the invention is preferably added in a silver halide emulsion layer, and more preferably added upon preparation of emulsion. In the case of adding the compound upon preparation of emulsion, it is possible to add the compound at any stage during the steps. For example, the compound is added during the formation step of silver halide grains, before start of the desalting step, during the desalting step, before start of chemical ripening, during the chemical ripening step, or during the step before the preparation of completed emulsion. Also, the compound may be added dividedly during these steps. Also, though it is preferable to add the compound in the emulsion layer, the compound may be added in the emulsion layer and also in an adjacent protective layer or intermediate layer and diffused at the time of coating.

A preferred addition amount of the compound of the formula (I) of the invention largely relies upon the addition method and the compound species to be added but is generally from 1×10⁻⁶ to 1 mole, preferably from 1×10⁻⁵ to 5×10⁻¹ moles, and more preferably from 1×10⁻⁴ to 1×10⁻¹ moles per mole of the photosensitive silver halide.

The compound of the formula (I) of the invention is dissolved in water or a water-soluble solvent such as methanol and ethanol or a mixed solvent thereof and then added. During this, the pH may be properly adjusted by the addition of an acid or a base, and a surfactant may be present jointly. Further, the compound can be dissolved in a high-boiling organic solvent and then added as an emulsified dispersion. Also, the compound can be added as a solid dispersion.

8) Use of Plural Silver Halides Jointly:

In the photosensitive material to be used in the invention, the photosensitive silver halide emulsion may be used singly or in admixture of two or more thereof (for example, a combination of emulsions having a different mean grain size, a combination of emulsions having a different formulation, a combination of emulsions having a different crystal habit, and a combination of emulsions having a different chemical sensitization condition). By using plural kinds of photosensitive silver halides having a different sensitivity, it is possible to adjust the gradation. With respect to these technologies, JP-A Nos. 57-119341, 53-106125, 47-3929, 48-55730, 46-5187, 50-73627, and 57-150841 can be made hereof by reference. It is preferable to make the respective emulsions have a sensitivity difference of 0.2 log E or more.

9) Coating Amount of Silver Halide:

The addition amount of the photosensitive silver halide is preferably 0.03 to 0.6 g/m², more preferably 0.07 to 0.4 g/m², and most preferably 0.05 to 0.3 g/m² in terms of coating amount of silver per m² of the photographic material. The amount of the photosensitive silver halide is preferably 0.01 moles to 0.5 moles, more preferably 0.02 moles to 0.3 moles, and further preferably 0.03 to 0.2 moles per mole of the organic silver salt.

10) Mixing of Silver Halide and Organic Silver Salt:

With respect to the mixing method and mixing condition of the separately prepared photosensitive silver halide and organic silver salt, though a method in which silver halide grains and an organic silver salt which have been separately completed for preparation are mixed by a high-speed stirrer or in a ball mill, a sand mill, a colloid mill, a vibration mill, a homogenizer, etc. and a method in which a photosensitive silver halide which has been completed for preparation is mixed at any timing during the preparation of an organic silver salt to prepare an organic silver salt are employable, there are no particular limitations so far as the effects of the invention are thoroughly revealed. Also, it is a preferred method for adjusting photographic characteristics to mix two or more kinds of organic silver salt aqueous dispersions and two or more kinds of photosensitive silver salt aqueous dispersions upon mixing.

A preferred timing of adding the silver halide of the invention in a coating liquid for image forming layer is from 180 minutes before coating to just before coating, and preferably from 60 minutes before coating to ten seconds before coating. However, there are no particular limitations with respect to the mixing method and mixing condition so far as the effects of the invention are thoroughly revealed. As a specific mixing method, a method in which the both components are mixed such that an average residence time calculated from the addition flow rate and the liquid feed amount into a coater becomes a desired time and a method of using a static mixer as described in N. Harnby, M. F. Edwards, and A. W. Nienow, translated by Koji Takahashi, Ekitai Kongo Gijutsu (Liquid Mixing Technology), published by Nikkan Kogyo Shinbun, 1989. Chapter 8 are employable.

Binder

The binder of the organic silver salt-containing layer of the invention may be any polymer. The binder is suitably transparent or translucent and generally colorless. Examples of the binder include natural resins or polymers or copolymers thereof, synthetic resins or polymers or copolymers thereof, and other media for forming a film, such as gelatins, rubbers, poly(vinyl alcohol)s, hydroxyethyl celluloses, cellulose acetates, cellulose acetate butyrates, poly(vinylpyrrolidone)s, casein, starch, poly(acrylic acid)s, poly(methyl methacrylate)s, poly(vinyl chloride)s, poly(methacrylate)s, styrene-maleic anhydride copolymers, styrene-acrylonitrile copolymers, styrene-butadiene copolymers, poly(vinyl acetal)s (such as poly(vinyl formal) and poly(vinyl butyral)), poly(ester)s, poly(urethane)s, phenoxy resins, poly(vinylidene chloride)s, poly(epoxide)s, poly(carbonate)s, poly(vinyl acetate)s, poly(olefin)s, cellulose esters, and poly(amide)s. The binder may be formed upon coating from water or an organic solvent or an emulsion.

In the case where 60% by mass or more of the solvent of the organic silver salt-containing layer is water, it is preferable to use a polymer latex of styrene-butadiene copolymer as the binder, and in the case where 60% by mass or more of the solvent is an organic solvent, it is preferable to use polyvinyl butyral as the binder.

In the case where 60% by weight or more of the solvent of coating liquid of the photosensitive layer is water, it is preferable that 60% to 100% by weight of the binder is a polymer latex, and it is more preferable that 80% to 100% by weight of the binder is a polymer latex. It is preferable to use a styrene-butadiene copolymer latex as the polymer latex.

In the case where 60% by weight or more of the solvent of coating liquid of the photosensitive layer is an organic solvent, it is preferable that 60% to 100% by weight of the binder is polyvinyl butyral, and it is more preferable that 80% to 100% by weight of the binder is polyvinyl butyral.

In the invention, the binder of a layer containing the organic silver salt preferably has a glass transition temperature of −20° C. to 80° C., more preferably 0° C. to 70° C., and further preferably 10° C. to 65° C.

In this specification, Tg is calculated according to the following equation.

1/Tg=Σ(Xi/Tgi)

Here, in the polymer, it is considered that monomer components in the number of n of i=1 to i=n are copolymerized. Xi is a weight percentage of the i-th monomer (ΣXi=1), and Tgi is a glass transition temperature (absolute temperature) of a homopolymer of the i-th monomer. However, Σ is the sum of i=1 to i=n.

As the glass transition temperature value (Tgi) of a homopolymer of each monomer, those described in Polymer Handbook, 3rd Edition (written by J. Brandrup and E. H. Immergut, published by Wiley-Interscience, 1989) were employed.

The polymer as the binder may be used singly or in admixture of two or more thereof, if desired. Also, a combination of a polymer having a glass transition temperature of 20° C. or higher with a polymer having a glass transition temperature of lower than 20° C. may be used. In the case where a blend of two or more kinds of polymers having a different Tg is used, it is preferable that its weight average Tg falls within the foregoing range.

In the invention, in the case where the organic silver salt-containing layer is formed by coating a coating liquid in which 30% by mass or more of the solvent is water and then drying it, the performance is improved when the binder of the organic silver-containing layer is soluble or dispersible in an aqueous solvent, especially the binder is made of a latex of a polymer having an equilibrium water content at 25° C. and at 60% RH of not more than 2% by mass.

A most preferred embodiment is one prepared such that the ion conductivity is not more than 2.5 mS/cm. As the preparation method, there is employed a method in which a polymer after synthesis is subjected to purification processing using a separation-functional membrane.

The aqueous solvent in which the foregoing polymer is soluble or dispersible is water or a mixture of water and not more than 70% by mass of a waver-miscible organic solvent.

Examples of water-miscible organic solvents include alcohols such as methyl alcohol, ethyl alcohol, and propyl alcohol; cellosolves such as methyl cellosolve, ethyl cellosolve, and butyl cellosolve; ethyl acetate; and dimethylformamide.

Also, the “equilibrium water content at 25° C. and at 60% RH” can be expressed according to the following equation using a weight W1 of a polymer under moisture-conditioned equilibrium state in an atmosphere at 25° C. and at 60% RH and a weight W0 of a polymer under absolute dry state at 25° C.

[Equilibrium water content at 25° C. and at 60% RH]=[(W1−W0)/W0]×100 (% by mass)

With respect to the definition and measurement of the water content, for example, Kobunshi Kogaku Koza 14, Kobunshi Zairyo Shikenho (Course of Polymer Engineering 14, Test Methods of Polymers) (edited by The Society of Polymer Science, Japan, Chijinshokan) can be made hereof by reference.

The binder polymer of the invention preferably has an equilibrium water content at 25° C. and at 60% RH of not more than 2% by mass, more preferably 0.01% by mass to 1.5% by mass, and further preferably 0.02% by mass to 1% by mass.

As the binder of the invention, polymers that are dispersible in an aqueous solvent are especially preferable. As examples of the dispersion state, any of a latex in which fine grains of a water-insoluble hydrophobic polymer are dispersed and a dispersion in which a polymer molecule is present in the dispersed state or forms a micell are preferable. The dispersed grains preferably have a mean grain size in the range of about 1 to 50,000 nm, more preferably about 5 to 1,000 nm. With respect to the grain size distribution of the dispersed grains, there are no particular limitations, and those having a wide grain size distribution and those having a monodispersed grain size distribution may be employed.

In the invention, as preferred embodiments of polymers that are dispersible in an aqueous solvent, hydrophobic polymers such as acrylic polymers, poly(ester)s, rubbers (such as SBR resins), poly(urethane)s, poly(vinyl chloride)s, poly(vinyl acetate)s, poly(vinylidene chloride)s, and poly(olefin)s can be preferably used. These polymers may be a linear polymer or a branched polymer, or a crosslinked polymer. The polymers may be a so-called homopolymer in which a single monomer is polymerized, or a copolymer in which two or more kinds of monomers are polymerized. The copolymers may be a random copolymer or a block copolymer.

These polymers have a number average molecular weight of 5,000 to 1,000,000, and preferably 10,000 to 200,000. When the molecular weight is too low, the mechanical strength is insufficient, whereas when it is too high, the film forming properties are poor, and hence, such is not preferable.

Specific examples of preferred polymer latices will be given below. In the following, the latices are expressed in terms of starting monomers, the numeral values in the parentheses are % by mass, and the molecular weights are a number average molecular weight. In the case where polyfunctional monomers are used, since a crosslinking structure is formed, a concept of the molecular weight cannot be applied. Accordingly, such case is designated with “crosslinking”, and the designation of molecular weight is omitted. Tg means a glass transition temperature.

P-1: Latex of -MMA(70)-EA(27)-MAA(3)- (molecular weight: 37,000, Tg: 61° C.)

P-2: Latex of -MMA(70)-2EHA(20)-St(5)-AA(5)- (molecular weight: 40,000, Tg: 59° C.)

P-3: Latex of -St(50)-Bu(47)-MAA(3)- (crosslinking, Tg: −17° C.)

P-4: Latex of -St(68)-Bu(29)-AA(3)- (crosslinking, Tg: 17° C.)

P-5: Latex of -St(71)-Bu(26)-AA(3)- (crosslinking, Tg: 24° C.)

P-6: Latex of -St(70)-Bu(27)—IA(3)- (crosslinking)

P-7: Latex of -St(75)-Bu(24)-AA(1)- (crosslinking, Tg: 29° C.)

P-8: Latex of -St(60)-Bu(35)-DVB(3)-MAA(2)- (crosslinking)

P-9: Latex of -St(70)-Bu(25)-DVB(2)-AA(3)- (crosslinking)

P-10: Latex of -VC(50)-MMA(20)-EA(20)-AN(5)-AA(5)- (molecular weight: 80,000)

P-11: Latex of -VDC(85)-MMA(5)-EA(5)-MAA(5)- (molecular weight: 67,000)

P-12: Latex of -Et(90)-MAA(10)- (molecular weight: 12,000)

P-13: Latex of -St(70)-2EHA(27)-AA(3) (molecular weight: 130,000, Tg: 43° C.)

P-14: Latex of -MMA(63)-EA(35)-AA(2) (molecular weight: 33,000, Tg: 47° C.)

P-15: Latex of -St(70.5)-Bu(26.5)-AA(3)- (crosslinking, Tg: 23° C.)

P-16: Latex of -St(69.5)-Bu(27.5)-AA(3)- (crosslinking, Tg: 20.5° C.)

The abbreviations of the foregoing structures express the following monomers. MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, IA: itaconic acid

The foregoing polymer latices are also commercially available, and the following polymers can be utilized. Examples of acrylic polymers include CEVIAN A-4635, 4718 and 4601 (manufactured by Daicel Chemical Industries) and NIPOL Lx811, 814, 821, 820 and 857 (manufactured by Zeon Corporation); examples of poly(ester)s include FINETEX ES650, 611, 675 and 850 (manufactured by Dainippon Ink and Chemicals) and WD-SIZE and WMS (manufactured by Eastman Chemical); examples of poly(urethane)s include HYDRAN AP10, 20, 30 and 40 (manufactured by Dainippon Ink and Chemicals); examples of rubbers include LACSTAR 7310K, 3307B, 4700H and 7132C (manufactured by Dainippon Ink and Chemicals) and NIPOL Lx416, 410, 438C and 2507 (manufactured by Zeon Corporation); examples of poly(vinyl chloride)s include G351 and G576 (manufactured by Zeon Corporation); examples of poly(vinylidene chloride)s include L₅₀₂ and L₅₁₃ (manufactured by Asahi Kasei); and examples of poly(olefin)s include CHEMIPEARL S120 and SA100 (manufactured by Mitsui Chemicals).

These polymer latices may be used singly or in admixture of two or more thereof, if desired.

As the polymer latex to be used in the invention, a latex of styrene-butadiene copolymer is especially preferable. A weigh ratio of the styrene monomer unit to the butadiene monomer unit in the styrene-butadiene copolymer is preferably from 40/60 to 95/5. Also, it is preferable that the proportion of the styrene monomer unit and the butadiene monomer unit in the copolymer is 60 to 99% by mass. Preferred ranges of the molecular weight are the same as described previously.

Examples of the latex of styrene-butadiene copolymer that is preferably used in the invention include the foregoing P-3 to P-8, P-14 and P-15 and commercial products LACSTAR-3307B, 7132C and NIPOL Lx416.

In the organic silver salt-containing layer of the photographic material of the invention, hydrophilic polymers such as gelatin, polyvinyl alcohol, methyl cellulose, hydroxypropyl cellulose, and carboxymethyl cellulose may be added, if desired.

The addition amount of such a hydrophilic polymer is preferably not more than 30% by mass, and more preferably not more than 20% by mass based on the whole binder.

It is preferable that the organic silver salt-containing layer (i.e., the image forming layer) of the invention is formed of the polymer latex using the binder. The amount of the binder of the organic silver salt-containing layer is preferably in the range of 1/10 to 10/1, and more preferably 1/5 to 4/1 in terms of the weight ratio of the whole binder to the organic silver salt.

Also, the organic silver salt-containing layer is usually a photosensitive layer (emulsion layer) containing a photosensitive silver halide as the photosensitive silver salt. In that case, the weight ratio of the whole binder to the silver halide is preferably in the range of 400 to 5, and more preferably 200 to 10.

The amount of the whole binder of the image forming layer of the invention is preferably in the range of 0.2 to 30 g/m², and more preferably 1 to 15 g/m². In the image forming layer of the invention, a crosslinking agent for the purpose of crosslinking and a surfactant for the purpose of improving coatability may be added.

In the invention, the solvent of the coating liquid for organic silver salt-containing layer of the photosensitive material (a combination of solvent and dispersion medium will be hereinafter simply referred to as “solvent”) is preferably an aqueous solvent containing 30% by mass or more of water. As other components than water, arbitrary water-miscible organic solvents such as methyl alcohol, ethyl alcohol, isopropyl alcohol, methyl cellosolve, ethyl cellosolve, dimethylformamide, and ethyl acetate may be used. The water content of the solvent is more preferably 50% by mass or more, and further preferably 70% by mass or more.

Specific examples of preferred solvent formulations include not only water=100 but also water/methyl alcohol=90/10, water/methyl alcohol=70/30, water/methyl alcohol/dimethylformamide=80/15/5, water/methyl alcohol/ethyl cellosolve=85/10/5, and water/methyl alcohol/isopropyl alcohol=85/10/5 (numeral values are % by mass).

Antifoggant

The invention can contain a compound represented by the formula (H) as an antifoggant.

Q-(Y)ₙ—C(Z₁)(Z₂)X Formula (H)

In the formula (H), Q represents an alkyl group, an aryl group, or a heterocyclic group; Y represents a divalent connecting group; n is 0 or 1; Z₁ and Z₂ each represent a halogen atom; and X represents a hydrogen atom or an electron withdrawing group.

Q preferably represents a phenyl group substituted with an electron withdrawing group having a positive value in terms of a Hammett's substituent constant op. With respect to the Hammett's substituent constant, for example, Journal of Medicinal Chemistry, 1973, Vol. 16, No. 11, 1207-1216 can be made hereof by reference.

Examples of such electron withdrawing groups include a halogen atom (such as a fluorine atom (σp value: 0.06), a chlorine atom (σp value: 0.23), a bromine atom (σp value: 0.23), and an iodine atom (σp value: 0.18)); a trihalomethyl group (such as tribromomethyl (σp value: 0.29), trichloromethyl (σp value: 0.33), and trilfuoromethyl (σp value: 0.54)); a cyano group (σp value: 0.66), a nitro group (σp value: 0.78), an aliphatic, aryl or heterocyclic sulfonyl group (such as methanesulfonyl (σp value: 0.72)); an aliphatic, aryl or heterocyclic acyl group (such as acetyl (σp value: 0.50) and benzoyl (σp value: 0.43)); an alkynyl group (such as C≡CH (σp value: 0.23)); an aliphatic, aryl or heterocyclic oxycarbonyl group (such as methoxycarbonyl (σp value: 0.45) and phenoxycarbonyl (σp value: 0.44)); a carbamoyl group (σp value: 0.36); a sulfamoyl group (σp value: 0.57); a sulfoxide group; a heterocyclic group; and a phosphoryl group.

The σp value is preferably in the range of 0.2 to 2.0, and more preferably 0.4 to 1.0.

The electron withdrawing group is preferably a carbamoyl group, an alkoxycarbonyl group, an alkylsulfonyl group, an alkylphosphoryl group, a carboxyl group, an alkyl- or arylcarbonyl group, or an arylsulfonyl group; more preferably a carbamoyl group, an alkoxycarbonyl group, an alkylsulfonyl group, or an alkylphosphoryl group; and most preferably a carbamoyl group.

X is preferably an electron withdrawing group; more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group; and especially preferably a halogen atom.

Of the halogen atoms, a chlorine atom, a bromine atom, and an iodine atom are preferable; a chlorine atom and a bromine atom are more preferable; and a bromine atom is especially preferable.

Y preferably represents —C(═O)—, —SO—, or —SO₂—; more preferably —C(═O)— or —SO₂—; and especially preferably —SO₂—. n is 0 or 1, and preferably 1.

Specific examples of the compound represented by the formula (H) of the invention will be given below, but it should not be construed that the invention is limited thereto.

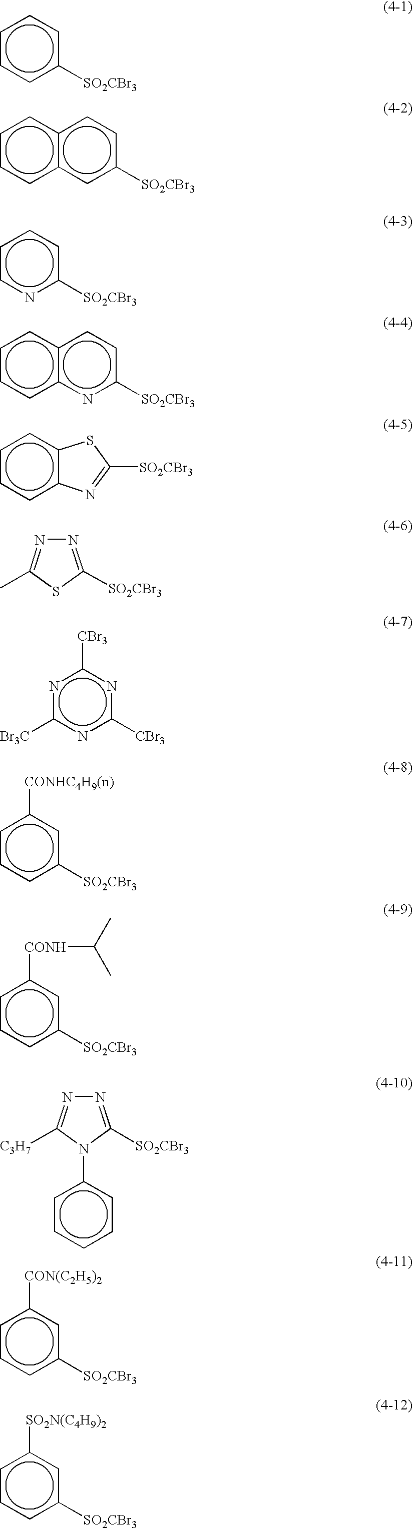

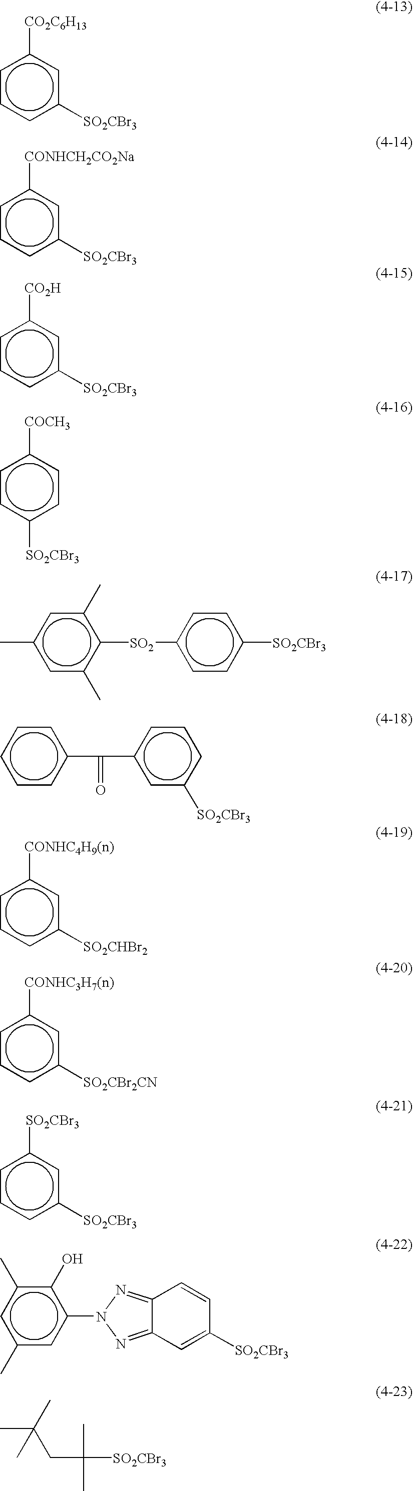

In the third aspect of the invention, the organic polyhalogen compound that is used together with the reducing agent represented by the formula (R-5) is especially preferably a heterocyclic compound represented by the formula (H) wherein Q contains a nitrogen atom as a ring-constituting atom but does not contain a sulfur atom.

In the first aspect of the invention, the compound represented by the formula (H) is preferably used in an amount of 10⁻⁵ to 0.5 moles, more preferably 10⁻⁴ to 0.3 moles, and further preferably 1×10⁻³ to 0.1 moles per mole of the non-photosensitive silver salt of the image forming layer.

In the second aspect and third aspect of the invention, the ratio in addition amount of the compound of the formula (H) to the reducing agent of the invention is the range described previously in the item of the reducing agent.

In the invention, as the method of containing the compound represented by the formula (H) in the photosensitive material, the method described previously in the containing method of the reducing agent is enumerated.

The compound represented by the formula (H) preferably has a melting point of not higher than 200° C., and more preferably not higher than 170° C.

As other organic polyhalogen compounds to be used in the invention, those disclosed in the patent documents described in paragraph Nos. 0111 to 0112 of JP-A No. 11-65021 are enumerated. Organic halogen compounds represented by the formula (P) of JP-A No. 2000-284399, organic polyhalogen compounds represented by the general formula (II) of JP-A No. 10-339934, and organic polyhalogen compounds described in JP-A No. 2001-033911 are especially preferable.

Other Antifoggants

Examples of other antifoggants include mercury(II) salts described in paragraph No. 0113 of JP-A No. 11-65021, benzoic acids described in paragraph No. 0114 of ibid., salicylic acid derivatives described in JP-A No. 2000-206642, formalin scavenger compounds represented by the formula (S) described in JP-A No. 2000-221634, triazine compounds according to claim 9 of JP-A No. 11-352624, and a compound, 4-hydroxy-6-methyl-1,3,3a,7-tetrazaindene represented by the general formula (III) described in JP-A No. 6-11791.

As the antifoggants, stabilizers and stabilizer precursors that can be used in the invention, compounds described in paragraph No. 0070 of JP-A No. 10-62899, compounds disclosed in the patent documents described at page 20, line 57 to page 21, line 7 of EP-A No. 0803764, and compounds described in JP-A Nos. 9-281637 and 9-329864 are enumerated.

In the invention, the photothermographic material may contain an azolium salt for the purpose of preventing fog. As the azolium salt, compounds represented by the general formula (XI) described in JP-A No. 59-193447, compounds described in JP-B No. 55-12581, and compounds represented by the general formula (II) described in JP-A No. 60-153039 are enumerated. Though the azolium salt may be added in any site of the photosensitive material, it is preferable to add the azolium salt to a layer having the photosensitive layer, and preferably to the organic silver salt-containing layer.

The azolium salt may be added in any step of the preparation of the coating liquid. In the case where the azolium salt is added to the organic silver salt-containing layer, though it may be added in an step from the time of preparation of the organic silver salt to the time of preparation of the coating liquid, it is preferable to add the azolium salt after the preparation of the organic silver salt but just before coating. The azolium salt may be added in any form of powder, solution, or fine grain dispersion. Also, the azolium salt may be added as a solution mixed with other additives such as a sensitizing dye, a reducing agent, and a color toning agent.

In the invention, though the azolium salt may be added in any addition amount, it is preferably added in an amount of 1×10⁻⁶ moles to 2 moles, and more preferably 1×10⁻³ moles to 0.5 moles per mole silver.

Other Additives

1) Mercapto Compounds, Disulfide Compounds, and Thione Compounds:

In the invention, for the purposes of retarding or promoting the development, improving the spectral sensitization efficiency and improving the storability before and after the development, mercapto compounds, disulfide compounds, and thione compounds can be contained, examples of which include compounds described in paragraph Nos. 0067 to 0069 of JP-A No. 10-62899, compound represented by the general formula (I) described in JP-A No. 10-186572 and specific examples thereof described in paragraph Nos. 0033 to 0052 of ibid., compounds described at page 20, lines 36 to 56 of EP-A No. 0803764, and compounds described in JP-A No. 2001-100358. Of these compounds, mercapto-substituted heteroaromatic compounds are preferable.

2) Color Toning Agent:

In the photothermographic material of the invention, addition of a color toning agent is preferable. The color toning agent is described in JP-A No. 10-62899, paragraph Nos. 0054 to 0055, EP-A No. 0803764, page 21, lines 23 to 48, and JP-A No. 2000-356317. Especially, phthalazinones (such as phthalazinone, phthalazinone derivatives, and metal salts thereof, including 4-(1-naphthyl)phthalazinone, 6-chlorophthalazinone, 5,7-dimethoxyphthalazinone, and 2,3-dihydro-1,4-phthalazinedione); combination of a phthalazinone with a phthalic acid (such as phthalic acid, 4-methylphthalic acid, 4-nitrophthalic acid, diammonium phthalate, sodium phthalate, potassium phthalate, and tetrachlorophthalic anhydride); and phthalazines (such as phthalazine, phthalazine derivatives, and metal salts thereof, including 4-(1-naphthyl)phthalazine, 6-isopropylphthalazine, 6-t-butylphthalazine, 6-hclorophthalazine, 5,7-dimethoxyphthalazine, and 2,3-dihydrophthalazine) are preferable. In the combination with a silver halide having a formulation of high silver iodide content, combinations of a phthalazine with a phthalic acid are especially preferable.

3) Plasticizer and Lubricant:

A plasticizer and a lubricant that can be used in the photosensitive layer of the invention are described in JP-A No. 11-65021, paragraph No. 0117. A sliding agent is described in JP-A No. 11-84573, paragraph Nos. 0061 to 0064.

4) Dye and Pigment:

In the photosensitive layer of the invention, from the viewpoints of improving color tone, preventing generation of an interference fringe upon laser exposure, and preventing irradiation, various dyes and pigments (such as C.I. Pigment Blue 60, C.I. Pigment Blue 64, and C.I. Pigment Blue 15:6) can be used. These are described in detail in WO 98/36322 and JP-A Nos. 10-268465 and 11-338098.

(Preparation and Coating of Coating Liquid)

The preparation temperature of the coating liquid for image forming layer of the invention is preferably 30° C. to 65° C., more preferably 35° C. to 60° C., and further preferably 35° C. to 55° C. Also, it is preferable that the temperature of the coating liquid for image forming layer immediately after the addition of the polymer latex is 30° C. to 65° C.

(Layer Structure)

The photothermographic material of the invention can have a non-photosensitive layer in addition to the image forming layer. The non-photosensitive layer can be classified into (a) a surface protective layer to be provided on the image forming layer (far side from a support), (b) an intermediate layer to be provided between plural image forming layers or between the image forming layer and a protective layer, (c) an undercoat layer to be provided between the image forming player and a support, and (d) a back layer to be provided in the opposite side to the image forming layer according to the configuration.

Also, though a layer functioning as an optical filter can be provided, it is provided as the layer (a) or layer (b). An anti-halation layer is provided as the layer (c) or layer (d) in the photosensitive material.

1) Surface Protective Layer:

In the invention, the photothermographic material can be provided with a surface protective layer for the purpose of preventing adhesion of the image forming layer, etc. The surface protective layer may be monolayered or multilayered. The surface protective layer is described in JP-A No. 11-65021, paragraph Nos. 0119 to 0120 and JP-A No. 2001-348546.

As a binder of the surface protective layer of the invention, though gelatin is preferable, it is also preferable to use polyvinyl alcohol (PVA) or use it jointly. As the gelatin, inert gelatin (such as NITTA GELATIN 750) and phthalated gelatin (such as NITTA GELATIN 801) can be used.

As PVA, those described in JP-A No. 2000-171936, paragraph Nos. 0009 to 0020 are enumerated. PVA-105 (manufactured by Kuraray Co., Ltd.) as a complete hydrolyzate, PVA-205 and PVA-335 (manufactured by Kuraray Co., Ltd.) as a partial hydrolyzate, and MP-203 (manufactured by Kuraray Co., Ltd.) as modified polyvinyl alcohol are preferably used.

The coating amount (per m² of support) of polyvinyl alcohol of the protective layer (per layer) is preferably 0.3 to 4.0 g/m², and more preferably 0.3 to 2.0 g/m².

Further, as the binder for the surface protective layer, technologies described in JP-A No. 2000-267226, paragraph Nos. 0021 to 0025, and technologies described in JP-A No. 2000-019678, paragraph Nos. 0023 to 0041 may be applied. The ratio of the polymer latex of the surface protective layer is preferably 10% to 90% by mass, and especially preferably 20% to 80% by mass based on the whole binder.

The coating amount (per m² of support) of the whole binder (including a water-soluble polymer and a latex polymer) of the protective layer (per layer) is preferably 0.3 to 5.0 g/m², and more preferably 0.3 to 2.0 g/m².

2) Anti-Halation Layer:

In the photothermographic material of the invention, an anti-halation layer can be provided. The anti-halation layer is described in JP-A No. 11-65021, paragraph Nos. 0123 to 0124 and JP-A Nos. 11-223898, 9-230531, 10-36695, 10-104779, 11-231457, 11-352625 and 11-352626.

The anti-halation layer contains an anti-halation dye having absorption in exposure wavelength. In the case where the exposure wavelength is present in the infrared region, infrared ray absorbing dyes may be employed. In that case, dyes not having absorption in visible region are preferable.

In the case where the halation is prevented using a dye having absorption in visible region, it is preferable that the color of the dye does not substantially remain after the image formation; it is preferable to employ a measure of causing decoloration by heat of heat development; and especially, it is preferable to add a heat decoloring dye and a base precursor to a non-photosensitive layer, thereby making it function as an anti-halation layer. These technologies are described in JP-A No. 11-231457, etc.

In the invention, in the case of exposure using a light source having a peak intensity in a region of 350 nm to 450 nm, it is desired to use near infrared to blue dyes having a maximum absorption wavelength in this wavelength region.

The addition amount of the decoloring dye is determined according to utilizations of the dye. In general, the decoloring dye is used in an amount such that when measured at the desired wavelength, an optical density (absorbance) exceeds 0.1. The optical density is preferably 0.2 to 2. For the sake of obtaining such an optical density, the amount of the dye to be used is in general about 0.001 to 1 g/m².

By decoloring the dye in this way, it is possible to reduce the optical density after the heat development to not more than 0.1. In the heat decoloration type recording material or photothermographic material, two or more kinds of decoloring dyes may be used jointly. Similarly, two or more kinds of base precursors may be used jointly.

In the heat decoloration using such decoloring dye and base precursor, what a substance capable of decreasing the melting point by 3° C. or more when mixed with the base precursor (such as diphenylsulfone and 4-chlorophenyl(phenyl)sulfone) as described in JP-A No. 11-352626 is used jointly is preferable from the standpoints of heat decoloring properties, etc.

In the invention, for the purpose of improving the silver color tone and change of image with time, a coloring agent having a maximum absorption at 300 to 450 nm can be added. The coloring agent is described in JP-A Nos. 62-210458, 63-104046, 63-103235, 63-208846, 63-306436, 63-314535, 01-61745 and 2001-100363.

The coloring agent is in general added in an amount of 0.1 mg/m² to 1 g/m². The coloring agent is preferably added to a back layer to be provided in the opposite side to the photosensitive layer.

3) Back Layer:

A back layer that can be used in the invention is described in JP-A No. 11-65021, paragraph Nos. 0128 to 0130.

4) Matting Agent:

In the invention, for the sake of improving conveyance, it is preferable to add a matting agent to the surface protective layer and the back layer. The matting agent is described in JP-A No. 11-65021, paragraph Nos. 0126 to 0127.

The coating amount of the matting agent is preferably 1 to 400 mg/m², and more preferably 5 to 300 mg/m² per m² of the photosensitive material.

Also, though the emulsion surface may have any matting degree so far as stardust damage does not occur, it preferably has a Bekk smoothness of 30 seconds to 2,000 seconds, and especially preferably 40 seconds to 1,500 seconds. The Bekk smoothness can be easily determined according to JIS (Japanese Industrial Standards) P8119 “Smoothness test method of paper and paperboard by a Bekk tester” and TAPPI Standards Method T479.

In the invention, as the matting degree of the back layer, the Bekk smoothness is preferably 10 seconds to 1,200 seconds, more preferably 20 seconds to 800 seconds, and further preferably 40 seconds to 500 seconds.

In the invention, it is preferable that the matting agent is contained in an outermost surface layer or a layer functioning as an outermost surface layer, or a layer near the outer surface. Also, it is preferable that the matting agent is contained in a layer functioning as a call-called protective layer.

5) Polymer Latex:

In the surface protective layer or back layer of the invention, a polymer latex can be added.

The polymer latex is described in Gosei Jushi Emarujon (Synthetic Resin Emulsions) (edited by Taira Okuda and Hiroshi Inagaki, published by Kobunshikankoukai (1978)), Gosei Ratekkusu No Oyo (Application of Synthetic Latices) (edited by Takaaki Sugimura, Yasuo Kataoka, Soichi Suzuki and Keiji Kasahara, published by Kobunshikankoukai (1993)), and Gosei Ratekkusu No Kagaku (Chemistry of Synthetic Latices) (Soichi Muroi, published by Kobunshikankoukai (1970)). Specific examples include a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of ethyl acrylate/methacrylic acid copolymer, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer, and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer.

6) Film Surface pH:

In the photothermographic material of the invention, the film surface pH before the heat development processing is preferably not more than 7.0, and more preferably not more than 6.6. Though the lower limit thereof is not particularly limited, it is about 3. The most preferred pH range is from 4 to 6.2.

In adjusting the film surface pH, it is preferable from the viewpoint of reducing the film surface pH to use an organic acid such as phthalic acid derivatives or a non-volatile acid such as sulfuric acid, or a volatile base such as ammonia. Especially, since ammonia is readily volatile and can be removed during the coating step or before the heat development, it is preferable in attaching low film surface pH.

Also, it is preferable to use ammonia together with a non-volatile base such as sodium hydroxide, potassium hydroxide, and lithium hydroxide. The measurement of the film surface pH is described in JP-A No. 2000-284399, paragraph No. 0123.

7) Film Hardener:

A film hardener may be used in each layer of the photosensitive layer, protective layer, back layer, etc. of the layer.

Examples of the film hardener are described in T. H. James, THE THEORY OF THE PHOTOGRAPHIC PROCESS FOURTH EDITION (published by Macmillan Publishing Co., Inc. (1977)), pages 77 to 87. As the film hardener, chromium alum, 2,4-dichloro-6-hydroxy-s-triazine sodium salt, N,N-ethylenebis(vinylsulfoneactamide), and N,N-propylenebis(vinylsulfoneacetamide), polyvalent metal ions described on page 78 of ibid., polyisocyanates described in U.S. Pat. No. 4,281,060 and JP-A No. 6-208193, epoxy compounds described in U.S. Pat. No. 4,791,042, and vinylsulfone based compounds described in JP-A No. 62-89048 are preferably used.

The film hardener is added as a solution thereof. This solution is added in the coating solution for protective layer from 180 minutes before coating to just before coating, and preferably from 60 minutes to 10 seconds before coating. There are no particular limitations with respect to the mixing method and mixing condition so far as the effects of the invention are thoroughly revealed.

As a specific mixing method, a method in which the both components are mixed such that an average residence time calculated from the addition flow rate and the liquid feed amount into a coater becomes a desired time and a method of using a static mixer as described in N. Harnby, M. F. Edwards, and A. W. Nienow, translated by Koji Takahashi, Ekitai Kongo Gijutsu (Liquid Mixing Technology), published by Nikkan Kogyo Shinbun, 1989. Chapter 8 are employable.

8) Surfactant:

The surfactant that can be applied in the invention is described in JP-A No. 11-65021, paragraph No. 0132.

In the invention, it is preferable to use a fluorine based surfactant. Specific examples of fluorine based surfactants include compounds described in JP-A Nos. 10-197985, 2000-19680 and 2000-214554. Also, high-molecular weight fluorine based surfactants described in JP-A No. 9-281636 are preferably used. In the photothermographic material of the invention, it is preferable to use fluorine based surfactants described in JP-A Nos. 2002-082411, 2003-57780 and 2003-149766. Especially, fluorine based surfactants described in JP-A Nos. 2003-57780 and 2003-149766 are preferable from the standpoints of electrification adjusting ability, stability of coated surface, and sliding properties in the case of coating and production using an aqueous coating liquid. Fluorine based surfactants described in JP-A 2003-149766 are most preferable because they have a high electrification adjusting ability so that their use amount may be made small.

In the invention, the fluorine based surfactant can be used in any of the emulsion surface or back surface and is preferably used in the both surfaces. Also, it is especially preferable to use the fluorine based surfactant in combination with a conductive layer containing the foregoing metal oxide. In that case, even when the amount of the fluorine based surface to be used in the surface having a conductive layer is reduced, or the fluorine based surfactant is eliminated, sufficient performance can be obtained.

The amount of the fluorine based surfactant to be used is preferably in the range of 0.1 mg/m² to 100 mg/m², more preferably 0.3 mg/m² to 30 mg/m², and further preferably 1 mg/m² to 10 mg/m² in each of the emulsion surface and the back surface. Especially, the fluorine based surfactants described in JP-A 2003-149766 are large in effect and are preferably used in an amount of 0.01 mg/m² to 10 mg/m², and more preferably 0.1 mg/m² to 5 mg/m².

9) Support:

As a transparent support, for the sake of relieving an internal strain remaining in the film during biaxial stretching and eliminating a heat shrinkage strain generated during the heat development processing, polyesters having been heat treated in the temperature range of 130 to 185° C., especially polyethylene terephthalate, are preferably used.

In the case of a photothermographic material for medical use, the transparent support may be colored blue with a blue dye (such as Dye-1 described in the working examples of JP-A No. 8-240877) or may be colorless.

Specific examples of the support are described in JP-A No. 11-65021, paragraph No. 0134.

For the support, it is preferable to apply undercoating technologies of water-soluble polyesters described in JP-A No. 11-84574, styrene-butadiene copolymers described in JP-A-10-186565, and vinylidene chloride copolymers described in JP-A No. 2000-39684.

Also, in the invention, antistatic layers containing various known metal oxides or conductive polymers may be contained. The antistatic layer may also serve as the foregoing undercoat layer or back layer protective layer, or may be provided separately. For the antistatic layer, technologies described in JP-A No. 11-65021, paragraph No. 0135, JP-A Nos. 56-143430, 56-143431, 58-62646 and 56-120519, JP-A No. 11-84573, paragraph Nos. 0040 to 0051, U.S. Pat. No. 5,575,957, and JP-A No. 11-223898, paragraph Nos. 0078 to 0084 can be applied.

10) Other Additives:

In the photothermographic material, antioxidants, stabilizers, plasticizers, ultraviolet ray absorbers, or coating aids may further be added. Solvents described in JP-A No. 11-65021, paragraph No. 0133 may also be added. Various additives are added either one of the photosensitive layer or the non-photosensitive layer. With respect to this matter, WO 98/36322, EP-A No. 803764, and JP-A Nos. 10-186567 and 10-18568 can be made hereof by reference.

11) Coating Mode:

In the invention, the photothermographic material may be coated in any method. Various coating operations including extrusion coating, slide coating, curtain coating, dip coating, knife coating, flow coating, and extrusion coating using a hopper described in U.S. Pat. No. 2,681,294 are employable. Of these, extrusion coating described on pages 399 to 536 of Stephen F. Kistler and Petert M. Schweizer, LIQUID FILM COATING (published by CHAPMAN & HALL, 1997) and slide coating are preferably used, and slide coating is especially preferably used.

Examples of the shape of a slide coater to be used in slide coating are described on page 427 and FIG. 11b.1 of ibid. Also, if desired, two or more layers can be coated at the same time by methods described pages 399 to 536 of ibid. or methods described in U.S. Pat. No. 2,761,791 and British Patent No. 837,095.

In the invention, it is preferable that the coating liquid for organic silver salt-containing layer is a so-called thixotropic fluid. With respect to this technology, JP-A No. 11-52509 can be made hereof by reference.

In the invention, the coating liquid for organic silver salt-containing layer preferably has a viscosity of 400 mPa·s to 100,000 mPa·s, and more preferably 500 mPa·s to 20,000 mPa·s at a shear rate of 0.1 S⁻¹.

Also, the viscosity is preferably 1 mPa·s to 200 mPa·s, and more preferably 5 mPa·s to 80 mPa·s at a shear rate of 1,000 S⁻¹.

12) Other Applicable Technologies:

Examples of technologies that can be used in the photothermographic material of the invention include EP-A Nos. 803764 and 883022, WO 98/36322, JP-A Nos. 56-62648, 56-62644, 9-43766, 9-281637,9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864 and 2001-348546.

With respect to the structure of multicolor photosensitive photothermographic material, a combination of two layers may be containing for each color. Also, all components may be contained in a single layer as described in U.S. Pat. No. 4,708,928.

In the case of a multiple dye multicolor photothermographic material, the respective emulsion layers are distinguished from each other and held by using a functional or non-functional barrier layer between the respective photosensitive layers as described in U.S. Pat. No. 4,460,681.

2. Image Forming Method:

2-1. Exposure:

Though the photosensitive material of the invention may be exposed by any method, laser light is preferably used as an exposure source. As the laser light according to the invention, gas laser, YAG laser, dye laser, and semiconductor laser are preferable. Also, a semiconductor laser and a second harmonic generation element can be used.

Especially, in exposure of the photothermographic recording material of the invention, it is preferable to use a laser output unit of short wavelength region utilizing blue semiconductor laser. The blue semiconductor laser has extremely excellent characteristics such that it can reveal image recording with high definition, is increased with respect to recording density, has a long life, and can obtain stable outputs.

The exposure wavelength is preferably 350 nm to 450 nm, more preferably 370 nm to 430 nm, and especially 390 nm to 420 nm.

2-2. Heat Development:

Though the photothermographic material of the invention may be developed by any method, in general, the imagewise exposed photothermographic material is heated and developed. The development temperature is preferably 80 to 250° C., and more preferably 100 to 140° C.

The development time is preferably 1 to 60 seconds, more preferably 3 to 30 seconds, further preferably 5 to 20 seconds, and most preferably 10 to 15 seconds.

As the heat development mode, a plate heater mode is preferable. The heat development mode by a plate heater mode is preferably the method described in JP-A No. 11-133572, which is concerned with a heat development unit in which a photothermographic material having a latent image formed therein is brought into contact with a heating measure in the heat development section to obtain a visible image. The heating measure is constructed of a plate heater, a plurality of presser rolls are oppositely aligned along one surface of the plate heater, and the photothermographic material is passed between the presser rolls and the plate heater to conduct heat development. It is preferable that the plate heater is divided into from two to six stages and that the temperature of the tip portion is made low by about 1 to 10° C.

This method is described in JP-A No. 54-30032. The water content and organic solvent contained in the photothermographic material can be removed out the system. Also, it is possible to suppress the change in shape of the support of the photothermographic material, which is likely caused upon rapid heating of the photothermographic material.

2-3. System:

As a laser imager for medical use, which is provided with an exposure section and a heat development section, a FUJI MEDICAL DRY LASER IMAGER FM-DPL can be enumerated. FM-DPL is described in Fuji Medical Review, No. 8, pages 39 to 55, and needless to say, these technologies can be applied as the laser imager of the photothermographic material of the invention. Also, as a network system adaptive to the DICOM Standards, FM-DPL can be applied as a photothermographic material for laser imager in the “AD network” proposed by Fuji Film Medical Co., Ltd.

3. Utilizations of the Invention:

It is preferable that according to the invention, black-and-white image is formed as a silver image to use the photothermographic material as a photothermographic material for medical diagnosis, a photothermographic material for industrial photography, a photothermographic material for printing, or a photothermographic material for COM. Especially, it is preferable to use the photothermographic material of the invention as a photothermographic material for medical diagnosis.

Embodiments of the invention will be given below.

A first embodiment of the invention provides a photothermographic material comprising a photosensitive silver halide, a non-photosensitive organic silver salt, a reducing agent, and a binder on at least one surface of a support, wherein silver iodide is contained in the photosensitive silver halide in an amount of 40% to 100% by mole, and the reducing agent contains a compound represented by the following formula (R-1).

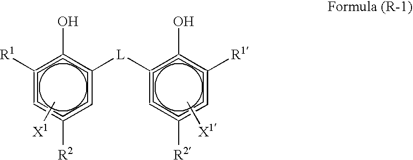

In formula (R-1), R¹ and R^{1′} each independently represent an alkyl group having 3 to 20 carbon atoms, in which a carbon atom bonding to the benzene ring is secondary or tertiary; R² and R^{2′} each represent a methyl group; L represents an —S— group or a —CHR³— group, in which R³ represents a hydrogen atom or an alkyl group having 1 to 20 carbon atoms; and X¹ and X^{1′} each independently represent a hydrogen atom or a group capable of being substituted on the benzene ring.

A second embodiment of the invention provides the photothermographic material of the first embodiment, further comprising a compound represented by the following formula (H).

Q-(Y)ₙ—C(Z₁)(Z₂)X Formula (H)

In formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group.

A third embodiment of the invention provides the photothermographic material of the first or second embodiment, wherein the silver iodide is contained in the photosensitive silver halide in an amount of 90% to 100% by mole.

A fourth embodiment of the invention provides the photothermographic material of any one of the first to third embodiments, wherein the photosensitive silver halide has a mean grain size of 5 nm to 80 nm.

A fifth embodiment of the invention provides the photothermographic material of any one of the first to third embodiments, wherein the photosensitive silver halide has a mean grain size of 5 nm to 40 nm.

A sixth embodiment of the invention provides the photothermographic material of any one of the first to fifth embodiments, further comprising a compound represented by the following formula (R-2) as the reducing agent.

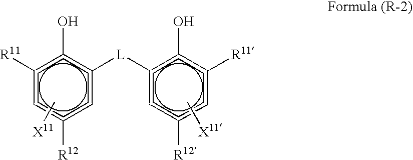

In formula (R-2), R¹¹ and R^{11′} each independently represent an alkyl group having 3 to 20 carbon atoms, in which the carbon atom bonding to the benzene ring is secondary or tertiary; R¹² and R^{12′} each represent an alkyl group having 2 to 20 carbon atoms; L represents an —S— group or a —CHR¹³— group, in which R¹³ represents a hydrogen atom or an alkyl group having 1 to 20 carbon atoms; and X¹¹ and X^{11′} each independently represent a hydrogen atom or a group capable of being substituted on the benzene ring.

A seventh embodiment of the invention provides the photothermographic material of any one of the first to sixth embodiments, wherein the reducing agent further contains a compound represented by the following formula (R-3).

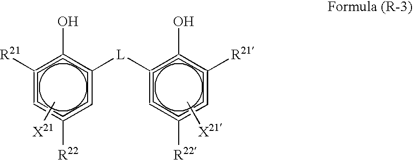

In formula (R-3), R²¹ and R^{21′} each independently represent a methyl group or an alkyl group having 2 to 20 carbon atoms, in which a carbon atom bonding to the benzene ring is primary; R²² and R^{22′} each independently represent an alkyl group having 1 to 20 carbon atoms; L represents an —S— group or a —CHR²³— group, in which R²³ represents a hydrogen atom or an alkyl group having 1 to 20 carbon atoms; and X²¹ and X^{21′} each independently represent a hydrogen atom or a group capable of being substituted on the benzene ring.

An eighth embodiment of the invention provides the photothermographic material of any one of the first to seventh embodiments, which is exposed with laser light.

A ninth embodiment of the invention provides the photothermographic material of the eighth embodiment, wherein the laser light has a light emission peak intensity in a range of 390 nm to 430 nm.

A tenth embodiment of the invention provides the photothermographic material of any one of the first to ninth embodiments, wherein a characteristic curve of the photothermographic material has a gamma in a range of 2 to 5.

An eleventh embodiment of the invention provides a photothermographic material comprising at least one photosensitive silver halide, a non-photosensitive organic silver salt, a reducing agent, and a binder on at least one surface of a support, wherein silver iodide is contained in the photosensitive silver halide in an amount of 40% to 100% by mole, the reducing agent contains a compound represented by the following formula (R-4), and a compound represented by the following formula (H) is contained in the photothermographic material with a molar ratio of the compound represented by formula (H) to the compound represented by formula (R-4) being 0.2 or greater.

Q-(Y)ₙ—C(Z₁)(Z₂)X Formula (H)

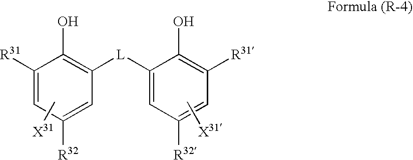

In formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group.

In formula (R-4), R³¹ and R^{31′} each independently represent an alkyl group having 1 to 20 carbon atoms; R³² and R³² each independently represent an alkyl group having 2 to 20 carbon atoms; L represents an —S— group or a —CHR³³— group, in which R³³ represents a hydrogen atom or an alkyl group having 1 to 20 carbon atoms; and X³¹ and X^{31′} each independently represent a hydrogen atom or a group capable of being substituted on the benzene ring.

A twelfth embodiment of the invention provides a photothermographic material comprising at least one photosensitive silver halide, a non-photosensitive organic silver salt, a reducing agent, and a binder on at least one surface of a support, wherein silver iodide is contained in the photosensitive silver halide in an amount of 40% to 100% by mole, the reducing agent contains a compound represented by the following formula (R-5), and a compound represented by the following formula (H) is contained in the photothermographic material with a molar ratio of the compound represented by formula (H) to the compound represented by formula (R-5) being 0.15 or greater.

Q-(Y)ₙ—C(Z₁)(Z₂)X Formula (H)

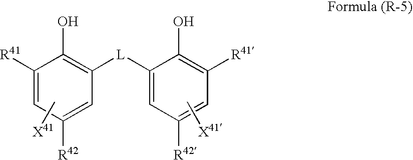

In formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group.

In formula (R-5), R⁴¹ and R^{41′} each independently represent a methyl group or an alkyl group having 2 to 20 carbon atoms, in which a carbon atom bonding to the benzene ring is primary (a non-branched carbon); R⁴² and R^{42′} each independently represent a hydrogen atom or a group capable of being substituted on the benzene ring; L represents an —S— group or a —CHR⁴³— group, in which R⁴³ represents a hydrogen atom or an alkyl group having 1 to 20 carbon atoms; and X⁴¹ and X^{41′} each independently represent a hydrogen atom or a group capable of being substituted on the benzene ring.

A thirteenth embodiment of the invention provides the photothermographic material of the eleventh embodiment, wherein in formula (R-4), R³¹ and R^{31′} each represent a secondary or tertiary alkyl group having 3 to 15 carbon atoms.

A fourteenth embodiment of the invention provides the photothermographic material of the twelfth embodiment, wherein in formula (H), Q represents a heterocyclic group containing a nitrogen atom as a ring-constituting atom and not containing a sulfur atom.

A fifteenth embodiment of the invention provides the photothermographic material of the eleventh to fourteenth embodiments, wherein an average content of the silver iodide in the photosensitive silver halide is 90% to 100% by mole.

A sixteenth embodiment of the invention provides the photothermographic material of any one of the eleventh to fifteenth embodiments, further comprising a development accelerator.

A seventeenth embodiment of the invention provides the photothermographic material of any one of the eleventh to sixteenth embodiments, which is exposed with light having a peak intensity in a range of 350 nm to 450 nm at an intensity of illumination of 1 mW/mm² or more.

An eighteenth embodiment of the invention provides the photothermographic material of any one of the eleventh to seventeenth embodiments, which is exposed by semiconductor laser having a light emission peak intensity in a range of 390 nm to 430 nm.

A nineteenth embodiment of the invention provides the photothermographic material of any one of the eleventh to seventeenth embodiments, wherein a characteristic curve of the photothermographic material has a gamma in a range of 2 to 5.

### EXAMPLES

The present invention will be specifically described below, but it should not be construed that the invention is limited thereto.

### Example 1

1. Preparation of PET Support and Undercoating:

1) Film Formation:

Using terephthalic acid and ethylene glycol, PET having an intrinsic viscosity IV=0.66 (measured at 25° C. in phenol/tetrachloroethane=6/4 (weight ratio)) was obtained according to the usual method. This PET was pelletized, dried at 130° C. for 4 hours, melted at 300° C., and then extruded from a T-die for quenching, to prepare an unstretched film having a film thickness of 175 μm after heat fixing.

This film was stretched 3.3 times in the longitudinal direction using rolls having a different circumferential speed and then stretched 5 times in the transverse direction using a tenter. At that time, the temperature was 110° C. and 130° C., respectively. Thereafter, the resulting stretched film was heat fixed at 240° C. for 20 seconds and then relieved by 4% in the transverse direction at the same temperature. Thereafter, a chuck portion of the tenter was slit, the both ends of which were then knurled, and the film was wound up at 4 kg/cm² to obtain a roll having a thickness of 175 μm.

2) Surface Corona Treatment:

The both surfaces of the support were treated at room temperature at 20 m/sec using a solid state corona treating machine 6 KVA Model manufactured by Pillar. It was noted from the read values of current and voltage that the support had been subjected to treatment with 0.375 kV·A min/m². At that time, the treatment frequency was 9.6 kHz, and the gap clearance between an electrode and a dielectric roll was 1.6 mm.

3) Undercoating:

3-1) Preparation of coating liquid for undercoat layer:

| Formulation (1) (for undercoat layer | | |
|---|---|---|
| in the photosensitive layer side): | | |
| PES RESIN A-520 (manufactured by of Takamatsu Oil & | 59 | g |
| Fat) (30% by mass solution): | | |
| 10% by mass solution of polyethylene glycol | 5.4 | g |
| monononylphenyl ether (average ethylene | | |
| oxide number = 8.5): | | |
| MP-1000 (manufactured by of Soken Chemical & | 0.91 | g |
| Engineering) (polymer fine grains, | | |
| mean grain size: 0.4 μm): | | |
| Distilled water: | 935 | mL |
| Formulation (2) (for first layer in the back surface side): | | |
| Styrene-butadiene copolymer latex (solids content: 40% by | 158 | g |
| mass, styrene/butadiene weight ratio = 68/32): | | |
| 8% by mass aqueous solution of 2,4-dichloro-6-hydroxy- | 20 | g |
| S-triazine sodium salt: | | |
| 1% by mass aqueous solution of sodium | 10 | mL |
| laurylbenzenesulfonate: | | |
| Distilled water: | 854 | mL |
| Formulation (3) (for second layer in the back surface side): | | |
| SnO₂/SbO (9/1 mass ratio, mean grain size: 0.038 μm, | 84 | g |
| 17% by mass dispersion): | | |
| Gelatin (10% by mass aqueous solution): | 89.2 | g |
| METOLOSE TC-5 (manufactured by of Shin-Etsu | 8.6 | g |
| Chemical) (2% by mass aqueous solution): | | |
| MP-1000 (manufactured by of Soken Chemical & | 0.01 | g |
| Engineering): | | |
| 1% by mass aqueous solution of sodium dodecylbenzene- | 10 | mL |
| sulfonate: | | |
| NaOH (1% by mass): | 6 | mL |
| Proxcel (manufactured by ICI) | 1 | mL |
| Distilled water: | 805 | mL |

3-2) Undercoating:

After subjecting the both surfaces of the biaxially stretched polyethylene terephthalate support having a thickness of 175 μn to corona discharge treatment, the foregoing coating liquid formulation (1) for undercoating was coated on one surface (photosensitive layer surface) in a wet coating amount of 6.6 mL/m² (per surface) using a wire bar and dried at 180° C. for 5 minutes. Thereafter, the foregoing coating liquid formulation (2) for undercoating was coated on the back surface in a wet coating amount of 5.7 mL/m² using a wire bar and dried at 180° C. for 5 minutes. Further, the foregoing coating liquid formulation (3) for undercoating on the resulting back surface in a wet coating amount of 7.7 mL/m² using a wire bar and dried at 180° C. for 6 minutes.

2. Back Layer:

2-1) Preparation of Coating Liquid for Back Layer:

(Preparation of Coating Liquid for Anti-Halation Layer)

Sixty grams of gelatin, 24.5 g of polyacrylamide, 2.2 g of 1 mole/L sodium hydroxide, 2.4 g of mono-dispersed polymethyl methacrylate fine grains (mean grain size: 8 μm, grain size standard deviation: 0.4), 0.08 g of benzoisothiazolinone, 0.3 g of poly(sodium styrenesulfonate), 0.21 of a blue dye compound-1, 0.15 g of a yellow dye compound-1, and 8.3 g of an acrylic acid/ethyl acrylate copolymer latex (copolymerization ratio: 5/95) were mixed, to which was then added water to make the whole to 818 mL. There was thus prepared a coating liquid for anti-halation layer.

(Preparation of Coating Liquid for Back Surface Protective Layer):

In a vessel kept at 40° C., 40 g of gelatin, a liquid paraffin emulsion in an amount of 1.5 g as liquid paraffin, 35 mg of benzoisothiazolinone, 6.8 g of 1 mole/L sodium hydroxide, 0.5 g of sodium t-octylphenoxyethoxyethanesulfonate, 0.27 g of poly(sodium styrenesulfonate), 5.4 mL of a 2% aqueous solution of a fluorine based surfactant (F-1), 6.0 g of an acrylic acid/ethyl acrylate copolymer (copolymerization weight ratio: 5/95), and 2.0 g of N,N-ethylene bis(vinylsulfoneacetamide) were mixed, to which was then added water to make the whole to 1,000 mL. There was thus prepared a coating liquid for back surface protective layer.

2-2) Coating of Back Layer:

In the back surface side of the undercoated support, the coating liquid for anti-halation layer and the coating liquid for back surface protective layer were subjected to simultaneous double-layer coating in a gelatin coating amount of 0.88 g/m² and 1.2 g/m², respectively and then dried to prepare a back layer.

3. Image Forming Layer, Intermediate Layer, and Surface Protective Layer:

3-1. Preparation of Coating Material:

1) Preparation of Silver Halide Emulsion:

(Preparation of Silver Halide Emulsion 1)

To 1,420 mL of distilled water, 4.3 mL of a 1% by mass potassium iodide solution was added, and 3.5 mL of sulfuric acid having a concentration of 0.5 moles/L and 36.7 g of phthalated gelatin were further added. This solution was kept at a liquid temperature of 42° C. in a stainless steel-made reaction pot, to which were added the whole amounts of a solution A of 22.22 g of silver nitrate diluted with distilled water to a volume of 195.6 mL and a solution B of 21.8 g of potassium iodide diluted with distilled water to a volume of 218 mL while stirring at constant flow rates over 9 minutes. Thereafter, 10 mL of a 3.5% by mass hydrogen peroxide aqueous solution was added to the reaction mixture, to which was then added 10.8 mL of an aqueous solution containing benzoimidazole in an amount of 10% by mass.

Further, a solution C of 51.86 g of silver nitrate diluted with distilled water to a volume of 317.5 mL and a solution D of 60 g of potassium iodide diluted with distilled water to a volume of 600 mL were added thereto in such a manner that the whole amount of the solution C was added at a constant flow rate over 120 minutes and that the solution D was added by the controlled double jet method while keeping the pAg at 8.1. Ten minutes after start of the addition of the solution C and the solution D, the whole amount of potassium hexachloroiridate(III) was added in an amount of 1×10⁻⁴ moles per mole of silver. Also, five seconds after completion of the addition of the solution C, the whole amount of a potassium iron(II) hexacyanide aqueous solution was added in an amount of 3×10⁻⁴ moles per mole of silver. The pH was adjusted to 3.8 using sulfuric acid having a concentration of 0.5 moles/L, and the stirring was stopped, thereby conducting sedimentation/desalting/water washing steps. The pH wad adjusted to 5.9 using sodium hydroxide having a concentration of 1 mole/L. There was thus prepared a silver halide dispersion having pAg of 8.0.

The resulting silver halide dispersion was kept at 38° C. while stirring, to which was then 5 mL of a solution of 0.34% by mass 1,2-benzoisothiazolin-3-one in methanol, and the temperature was raised to 47° C. Twenty minutes after raising the temperature, a solution of sodium benzenethiosulfonate in methanol was added in an amount of 7.6×10⁻⁵ moles per mole of silver, and five minutes after the addition, a solution of a tellurium sensitizer B in methanol was added in an amount of 2.9×10⁻⁴ moles per mole of silver, followed by ripening for 91 minutes.

To the ripened mixture, 1.3 mL of a solution of 0.8% by mass N,N′-dihydroxy-N″-diethylmelamine in methanol was added, and four minutes after the addition, a solution of 5-methyl-2-mercaptobenzoimidazole in methanol and a solution of 1-phenyl-2-heptyl-5-mercapto-1,3,4-triazole in methanol were added in amounts of 4.8×10⁻³ moles per mole silver and 5.4×10⁻³ moles per mole silver, respectively. There was thus prepared a silver halide emulsion 1.

Grains in the thus prepared silver halide emulsion were pure silver iodide grains having a mean sphere-corresponding grain size of 0.040 μm and a coefficient of variation of sphere-corresponding size of 18%. The grain size and the like were determined from average values of 1,000 grains using an electron microscope.

(Preparation of Silver Halide Emulsion 2)

A silver halide emulsion 2 was prepared in the manner exactly the same as in the preparation of the silver halide emulsion 1, except that the temperature of the reaction mixture was changed to 65° C. and that 5 mL of a 5% methanol solution of 2,2′-(ethylenedithio)diethanol was added after the addition of the solutions A and B.

Grains in the thus prepared silver halide emulsion were pure silver iodide grains having a mean sphere-corresponding grain size of 0.075 μm and a coefficient of variation of sphere-corresponding size of 23%. The grain size and the like were determined from average values of 1,000 grains using an electron microscope.

(Preparation of Silver Halide Emulsion 3)

A silver halide emulsion 3 was prepared in the manner exactly the same as in the preparation of the silver halide emulsion 1, except that the temperature of the reaction mixture was changed to 27° C.

Grains in the thus prepared silver halide emulsion were pure silver iodide grains having a mean sphere-corresponding grain size of 0.022 μm and a coefficient of variation of sphere-corresponding size of 17%. The grain size and the like were determined from average values of 1,000 grains using an electron microscope.

(Preparation of Mixed Emulsion A for Coating Liquid)

The silver halide emulsion 1, the silver halide emulsion 2, and the silver halide emulsion 3 were dissolved in such a manner that the silver molar ratio was 5:2:3, and a 1% by mass benzothiazolium iodide aqueous solution was added in an amount of 7×10⁻³ moles per mole of silver. Further, water was added in such a manner that the content of the silver halide became 38.2 g as silver per kg of the mixed emulsion for coating liquid. Also, 1-(3-methylureido)-5-mercaptotetrazole sodium salt was added in an amount of 0.34 g per kg of the mixed emulsion for coating liquid.

Moreover, as the “compound in which a one electron oxidant formed upon one electron oxidation can further release one or more electrons”, each of compounds 2, 20 and 26 was added in an amount of 2×10⁻³ moles per mole of silver of the silver halide.

2) Preparation of Fatty Acid Silver Dispersion:

<Preparation of Recrystallized Behenic Acid>

One hundred kilograms of behenic acid manufactured by Henkel (a trade name; EDENOR C22-85R) was mixed with 1,200 kg of isopropyl alcohol, and the mixture was dissolved at 50° C. After filtering by a 10-μm filter, the filtrate was cooled to 30° C. and recrystallized. During the recrystallization, the cooling speed was controlled at 3° C./hr. The resulting crystals were subjected to centrifugal filtration and washed with 100 kg of isopropyl alcohol, followed by drying. The resulting crystals were esterified and subjected to GC-FID measurement. As a result, the crystals had a behenic acid content of 96% by mole and also contained 2% by mole of lignoceric acid, 2% by mole of arachidic acid, and 0.001% by mole of erucic aicd.

<Preparation of Fatty Acid Silver Dispersion>

Eighty-eight kilograms of recrystallized behenic acid, 422 L of distilled water, 49.2 L of an NaOH aqueous solution having a concentration of 5 moles/L, and 120 L of t-butyl alcohol were mixed, and the mixture was reacted with stirring at 75° C. for one hour to obtain a sodium behenate solution B. Separately, 206.2 L of an aqueous solution of 40.4 kg of silver nitrate (pH 4.0) was prepared and kept at 10° C. A reactor charged with 635 L of distilled water and 30 L of t-butyl alcohol was kept at 30° C., to which were then added the whole amount of the foregoing sodium behenate solution and the whole amount of the silver nitrate aqueous solution at constant flow rates over 93 minutes 15 seconds and 90 minutes, respectively while thoroughly stirring. At that time, only the silver nitrate aqueous solution was added for a period of time of 11 minutes after start of the addition of the silver nitrate aqueous solution; the addition of the sodium behenate solution was then started; and only the sodium behenate solution was added for a period of time of 14 minutes 15 seconds after completion of the addition of the silver nitrate aqueous solution. At that time, the temperature within the reactor was controlled at 30° C., and the external temperature was controlled such that the liquid temperature became constant. Also, the conduit of the addition system of the sodium behenate solution was kept warm by circulating warm water in the outer side of double tube, and the liquid temperature of the outlet in the tip of addition nozzle was controlled at 75° C. Also, the conduit of the addition system of the silver nitrate aqueous solution was kept constant while circulating cold water into the outer side of the double tube. The addition position of the sodium behenate solution and the addition position of the silver nitrate aqueous solution were symmetrically aligned with respect to a stirring axis as a center, the heights of which were adjusted such that they did not come into contact with the reaction mixture.

After completion of the addition of the sodium behenate solution, the reaction mixture was allowed to stand with stirring for 20 minutes while keeping the temperature, and the temperature was then raised to 35° C. over 30 minutes. Thereafter, the reaction mixture was ripened for 210 minutes. Immediately after completion of ripening, the solid was filtered off by centrifugal filtration and then washed with water until the filtrates had a conductivity of 30 μS/cm. There was thus obtained a fatty acid silver salt. The resulting solid was stored as a wet cake without being dried.

The morphology of the resulting silver behenate grains was evaluated by electron micrographic photography. As a result, it was revealed that the grains are a crystal of a=0.21 μm, b=0.4 μm and c=0.4 μm in terms of average values and having an average aspect ratio of 2.1 and a coefficient of variation of sphere-corresponding size of 11% (a, b and c being defined in the specification).

To the wet cake corresponding to a dry solids content of 260 kg, 19.3 kg of polyvinyl alcohol (a trade name: PVA-217) and water were added to make the whole to 1,000 kg, and the mixture was formed into a slurry by a dissolver blade and further preliminarily dispersed by a pipeline mixer (PM-10 Model, manufactured by Mizuho Industrial Co., Ltd.).

Next, the stock solution having been preliminarily dispersed was treated three times in a dispersion mixer (a trade name: MICROFLUIDIZER M-610, manufactured by Microfluidics International Corporation, using a Z-type interaction chamber) while adjusting a pressure at 1,150 kg/cm², to obtain a silver behenate dispersion. The cooling operation was carried out by installing a coiled heat exchanger in front and behind the interaction chamber and setting the dispersion temperature at 18° C. by adjusting the temperature of a coolant.

3) Preparation of Reducing Agent Dispersion:

Ten kilograms of water was added to 10 kg of a reducing agent (the kind of which is shown in Table 1) and 16 kg of an aqueous solution containing modified polyvinyl alcohol (POVAL MP203, manufactured by Kuraray Co., Ltd.) in an amount of 10% by mass, and the mixture was well mixed to form a slurry. This slurry was delivered by a diaphragm pump and dispersed for 3 hours by a horizontal sand mill (UVM-2, manufactured by Imex Co., Ltd.) charged with zirconia beads having a mean diameter of 0.5 mm, to which were then added 0.2 g of benzoisothiazolinone sodium salt and water, thereby adjusting the concentration of the reducing agent at 25% by mass. The resulting dispersion was heat treated at 80° C. for 5 hours as a standard time to obtain a reducing agent dispersion. The heating time was adjusted such that the reducing agent grains had a median size of 0.40 μm. The reducing agent grains contained in the thus obtained reducing agent dispersion had a median size of 0.40 μm and a maximum grain size of not larger than 1.4 μm. The resulting reducing agent dispersion was filtered by a polypropylene-made filter having a pore size of 3.0 μm and after removing foreign matters such as dusts, was stored.

The median size and maximum grain size of the reducing agent grains were measured using LA-920 manufactured by Horiba, Ltd.

The median size and maximum grain size of other dispersions were measured in the same manner.

4) Preparation of Hydrogen Bond-Forming Compound Dispersion:

Ten kilograms of water was added to 10 kg of a hydrogen bond-forming compound-1 (tri(4-t-butylphenyl)phosphine oxide) and 16 kg of an aqueous solution containing modified polyvinyl alcohol (POVAL MP203, manufactured by Kuraray Co., Ltd.) in an amount of 10% by mass, and the mixture was well mixed to form a slurry. This slurry was delivered by a diaphragm pump and dispersed for 4 hours by a horizontal sand mill (UVM-2, manufactured by Imex Co., Ltd.) charged with zirconia beads having a mean diameter of 0.5 mm, to which were then added 0.2 g of benzoisothiazolinone sodium salt and water, thereby adjusting the concentration of the hydrogen bond-forming compound at 25% by mass. The resulting dispersion was heat treated at 40° C. for one hour and subsequently heated at 80° C. for one hour to obtain a hydrogen bond-forming compound-1 dispersion. The hydrogen bond-forming compound grains contained in the thus obtained hydrogen bond-forming compound dispersion had a median size of 0.45 μm and a maximum grain size of not larger than 1.3 μm. The resulting hydrogen bond-forming compound dispersion was filtered by a polypropylene-made filter having a pore size of 3.0 μm and after removing foreign matters such as dusts, was stored.

5) Preparation of Development Accelerator and Color Toning Agent Dispersion:

(Preparation of Development Accelerator-1 Dispersion)

Ten kilograms of water was added to 10 kg of a development accelerator-1 and 20 kg of an aqueous solution containing modified polyvinyl alcohol (POVAL MP203, manufactured by Kuraray Co., Ltd.) in an amount of 10% by mass, and the mixture was well mixed to form a slurry. This slurry was delivered by a diaphragm pump and dispersed for 3 hours 30 minutes by a horizontal sand mill (UVM-2, manufactured by Imex Co., Ltd.) charged with zirconia beads having a mean diameter of 0.5 mm, to which were then added 0.2 g of benzoisothiazolinone sodium salt and water, thereby adjusting the concentration of the development accelerator at 20% by mass, to obtain a development aceelerator-1 dispersion. The development accelerator grains contained in the thus obtained development accelerator dispersion had a median size of 0.48 μm and a maximum grain size of not larger than 1.4 μm. The resulting development accelerator dispersion was filtered by a polypropylene-made filter having a pore size of 3.0 μm and after removing foreign matters such as dusts, was stored.

(Preparation of Solid Dispersions of Development Accelerator-2 and Color Toning Agent-1)

With respect to solid dispersions of a development accelerator-2 and a color toning agent-1, dispersion was carried out in the same manner as in the preparation of the development accelerator-1 dispersion. There were thus obtained dispersions of 20% by mass and 15% by mass, respectively.

6) Preparation of Polyhalogen Compound Dispersion:

(Preparation of Organic Polyhalogen Compound-1 Dispersion)

Ten kilograms of an organic polyhalogen compound-1 (tribromomethanesulfonylbenzene), 10 kg of an aqueous solution containing modified polyvinyl alcohol (POVAL MP203, manufactured by Kuraray Co., Ltd.) in an amount of 20% by mass, 0.4 kg of an aqueous solution containing sodium triisopropylnaphthalenesulfonate in an amount of 20% by mass, and 14 g of water were added and well mixed to form a slurry. This slurry was delivered by a diaphragm pump and dispersed for 5 hours by a horizontal sand mill (UVM-2, manufactured by Imex Co., Ltd.) charged with zirconia beads having a mean diameter of 0.5 mm, to which were then added 0.2 g of benzoisothiazolinone sodium salt and water, thereby adjusting the concentration of the organic polyhalogen compound at 30% by mass, to obtain an organic polyhalogen compound-1 dispersion. The organic polyhalogen compound grains contained in the thus obtained polyhalogen compound dispersion had a median size of 0.41 μm and a maximum grain size of not larger than 2.0 μm. The resulting organic polyhalogen compound dispersion was filtered by a polypropylene-made filter having a pore size of 10.0 μm and after removing foreign matters such as dusts, was stored.

(Preparation of Organic Polyhalogen Compound-2 Dispersion)

Ten kilograms of an organic polyhalogen compound-2 (N-butyl-3-tribromomethanesulfonylbenzamide), 20 kg of an aqueous solution containing modified polyvinyl alcohol (POVAL MP203, manufactured by Kuraray Co., Ltd.) in an amount of 10% by mass, and 0.4 kg of an aqueous solution containing sodium triisopropylnaphthalenesulfonate in an amount of 20% by mass were added and well mixed to form a slurry. This slurry was delivered by a diaphragm pump and dispersed for 5 hours by a horizontal sand mill (UVM-2, manufactured by Imex Co., Ltd.) charged with zirconia beads having a mean diameter of 0.5 mm, to which were then added 0.2 g of benzoisothiazolinone sodium salt and water, thereby adjusting the concentration of the organic polyhalogen compound at 30% by mass. This dispersion was heated at 40° C. for 5 hours to obtain an organic polyhalogen compound-2 dispersion. The organic polyhalogen compound grains contained in the thus obtained polyhalogen compound dispersion had a median size of 0.40 μm and a maximum grain size of not larger than 1.3 μm. The resulting organic polyhalogen compound dispersion was filtered by a polypropylene-made filter having a pore size of 3.0 μm and after removing foreign matters such as dusts, was stored.

7) Preparation of Phthalazine Compound Solution:

Eight kilograms of modified polyvinyl alcohol MP203 manufactured by Kuraray Co., Ltd. was dissolved in 174.57 kg of water, to which were then added 3.15 kg of an aqueous solution containing sodium triisopropylnaphthalenesulfonate in an amount of 20% by mass and 14.28 kg of an aqueous solution containing phthalazine compound-1 (6-isopropylphthalazine) in an amount of 70% by mass, to prepare a 5 wt % solution of the phthalazine compound-1.

8) Preparation of Mercapto Compound-1:

Twenty grams of a mercapto compound-1 (1-(methylureido)-5-mercaptotetrazole sodium salt) was dissolved in 980 g of water to prepare a 2.0 wt % aqueous solution.

9) Preparation of Pigment-1 Dispersion:

Two hundreds and fifty grams of water was added to 64 g of C.I. Pigment Blue 60 and 6.4 g of DEMOL N manufactured by Kao Corporation, and the mixture was well mixed to form a slurry. Eight hundreds grams of zirconia beads having a mean diameter of 0.5 mm were prepared and charged in a vessel together with the slurry. The mixture was dispersed for 25 hours in a dispersion mixer (a 1/4 G sand grinder mill, manufactured by Imex Co., Ltd.), to which was then added water, thereby adjusting the concentration of the pigment at 5% by mass, to obtain a pigment-1 dispersion. The pigment grains contained in the thus obtained pigment dispersion had a mean grain size of 0.21 μm.

10) Preparation of SBR Latex Liquid:

An SBR latex was prepared in the following manner.

In a kettle of a gas monomer reaction unit (TAS-2J Model, manufactured by Taiatsu Techno Corporation), 287 g of distilled water, 7.73 g of a surfactant (PIONIN A-43-S (manufactured by Takemoto Oil & Fat), solids content: 48.5%), 14.06 mL of 1 mole/L NaOH, 0.15 g of tetrasodium ethylenediaminetetraacetate, 255 g of styrene, 11.25 g of acrylic acid, and 3.0 g of tert-dodecylmercaptane, and after sealing the reactor, the mixture was stirred at a stirring rate of 200 rpm. After deaeration using a vacuum pump, nitrogen gas displacement was repeated several times, and 108.75 g of 1,3-butadiene was fed under pressure, followed by raising the internal temperature to 60° C. A solution of 1.875 g of ammonium persulfate dissolved in 50 mL of water was added thereto, and the mixture was stirred for 5 hours as it was.

Further, the temperature was raised to 90° C., and stirring was continued for 3 hours. After completion of the reaction, the temperature was reduced such that the internal temperature became room temperature, and the reaction mixture was treated by addition of 1 mole/L NaOH and NH₄OH such that the molar ratio of Na⁺ ion to NH₄⁺ ion became 1:5.3, thereby adjusting the pH at 8.4. Thereafter, the resulting latex was filtered by a polypropylene-made filter having a pore size of 1.0 μm and after removing foreign matters such as dusts, was stored, thereby obtaining 774.7 g of SBR latex. As a result of measuring halogen ions by ion chromatography, the latex had a chloride ion concentration of 3 ppm. As a result of high-performance liquid chromatography, the latex had a chelating agent concentration of 145 ppm.

The latex had a mean grain size of 90 nm, a Tg of 17° C., a solids content of 44% by mass, an equilibrium water content at 25° C. and at 60% RH of 0.6% by mass, an ion conductivity of 4.80 mS/cm (the measurement of ion conductivity was carried out at 25° C. with respect to the latex stock solution (44% by mass) using a conductivity analyzer CM-30S manufactured by DKK-TOA Corporation), and pH of 8.4.

3-2. Preparation of Coating Liquid:

1) Preparation of Coating Liquid for Image Forming Layer:

To 1,000 g of the above-obtained fatty acid silver dispersion and 276 mL of water, the pigment-1 dispersion, the organic polyhalogen compound-1 dispersion (the amount of which is described in Table 1), the organic polyhalogen compound-2 dispersion (the amount of which is described in Table 1), the phthalazine compound-1 solution, the SBR latex (Tg: 17° C.) liquid, the reducing agent dispersion (the amount and kind of which are described in Table 1), the hydrogen bond-forming compound-1 dispersion, the development acclerator-1 dispersion, the development accelerator-2 dispersion, the color toning agent-1 dispersion, and the mercapto compound-1 aqueous solution were successively added. Immediately before coating, the silver halide mixed emulsion A was added, and the mixture was well mixed. The thus obtained coating liquid for image forming layer was delivered into a coating die as it was and then coated.

The viscosity of the coating liquid for image forming layer of the photographic material used in Experiment No. 1 in Table 1 was measured by a B type viscometer of TOKIMEC INC. and found to be 28 [mPa·s] at 40° C. (No. 1 rotor at 60 rpm).

The viscosity of the coating liquid as measured at 25° C. using an RFS fluid spectrometer manufactured by Rheometrics Fareast Ltd. was 242, 63, 48, 28 and 21 [mPa·s] at a shear rate of 0.1, 1, 10, 100 and 1,000 [1/sec], respectively.

The zirconium amount in the coating liquid was 0.38 mg per gram of silver.

2) Preparation of Coating Liquid for Intermediate Layer:

To 1,000 g of polyvinyl alcohol PVA-205 (manufactured by Kuraray Co., Ltd.), 272 g of the pigment-1 dispersion, and 4,200 mL of a 19% by mass liquid of a methyl methacrylate/styrene/butyl acrylate/hydroxyethyl methacrylate/acrylic acid copolymer (copolymerization weight ratio: 64/9/20/5/2) latex, 27 mL of an aqueous solution containing AEROSOL OT (manufactured by American Cyanamid Company) in an amount of 5% by mass, 135 mL of an aqueous solution containing diammonium phthalate salt in an amount of 20% by mass, and water were added such that the total amount became 10,000 g. The pH of the mixture was adjusted at 7.5 with NaOH to prepare a coating liquid for intermediate layer, which was then delivered in an amount of 9.1 mL/m² into a coating die.

The viscosity of the coating liquid of the photographic material used in Experiment No. 1 in Table 1 was measured by a B type viscometer and found to be 62 [mPa·s] at 40° C. (No. 1 rotor at 60 rpm).

3) Preparation of Coating Liquid for First Layer of Surface Protective Layer:

Sixty-four grams of inert gelatin was dissolved in water, to which were then added 112 g of a 19.0% by mass liquid of a methyl meth-acrylate/styrene/butyl acrylate/hydroxyethyl methacrylate/acrylic acid copolymer (copolymerization weight ratio: 64/9/20/5/2) latex, 30 mL of a 15% by mass methanol solution of phthalic acid, 23 mL of an aqueous solution containing 4-methylphthalic acid in an amount of 10% by mass, 28 mL of sulfuric acid having a concentration of 0.5 moles/L, 5 mL of an aqueous solution containing AEROSOL OT (manufactured by American Cyanamid Company) in an amount of 5% by mass, 0.5 g of phenoxyethanol, and 0.1 g of benzoisothiazolinone, and water was further added to make the total amount to 750 g, thereby preparing a coating liquid. Immediately before coating, the coating liquid was mixed with 26 mL of 4% by mass chromium alum by a static mixer and then delivered in an amount of 18.6 mL/m² into a coating die.

The viscosity of the coating liquid of the photographic material used in Experiment No. 1 in Table 1 was measured by a B type viscometer and found to be 22 [mPa·s] at 40° C. (No. 1 rotor at 60 rpm).

4) Preparation of Coating Liquid for Second Layer of Surface Protective Layer:

Eighty grams of inert gelatin was dissolved in water, to which were then added 102 g of a 27.5% by mass liquid of a methyl meth-acrylate/styrene/butyl acrylate/hydroxyethyl methacrylate/acrylic acid copolymer (copolymerization weight ratio: 64/9/20/5/2) latex, 5.4 mL of a 2% by mass solution of a fluorine based surfactant (F-1), 5.4 mL of an aqueous solution containing a fluorine based surfactant (F-2) in an amount of 2% by mass, 23 mL of an aqueous solution containing AEROSOL OT (manufactured by American Cyanamid Company) in an amount of 5% by mass, 4 g of polymethyl methacrylate fine grains (mean grain size: 0.7 μm), 21 g of polymethyl methacrylate fine grains (mean grain size: 4.5 μm), 1.6 g of 4-methylphthalic acid, 4.8 g of phthalic acid, 44 mL of sulfuric acid having a concentration of 0.5 moles/L, and 10 mg of benzoisothiazolinone, and water was further added to make the total amount to 650 g. Immediately before coating, the mixture was mixed with 445 mL of an aqueous solution containing 4% by mass chromium alum and 0.67% by mass phthalic acid by a static mixer to prepare a coating liquid for surface protective layer, which was then delivered in an amount of 8.3 mL/m² into a coating die.

The viscosity of the coating liquid of the photographic material used in Experiment No. 1 in Table 1 was measured by a B type viscometer and found to be 20 [mPa·s] at 40° C. (No. 1 rotor at 60 rpm).

3-3. Preparation of Photothermographic Material:

On the opposite surface to the back surface, an image forming layer, an intermediate layer, a first layer of surface protective layer, and a second layer of surface protective layer were subjected to simultaneous double-layer coating in that order from the undercoat layer in a slide bead coating mode. There was thus prepared a sample of photothermographic material. At that time, the temperature was controlled at 31° C. for the image forming layer and the intermediate layer, 36° C. for the first layer of surface protective layer, and 37° C. for the second layer of surface protective layer, respectively.

The coating amount (g/m²) of each of the compounds of the image forming layer is as follows.

| | |
|---|---|
| Silver Behenate: | 5.27 |
| Pigment (C.I. Pigment Blue 60): | 0.036 |
| Polyhalogen compound-1: | Amount set forth in Table 1 |
| Polyhalogen compound-2: | Amount set forth in Table 1 |
| Phthalazine compound-1: | 0.18 |
| SBR latex: | 9.43 |
| Reducing agent: | Amount and kind set forth in |
| | Table 1 |
| Hydrogen bond-forming compound-1: | 0.28 |
| Development accelerator-1: | 0.025 |
| Development accelerator-2: | 0.020 |
| Color toning agent-1: | 0.008 |
| Mercapto compound-1: | 0.006 |
| Silver halide (as Ag): | 0.046 |

The coating and drying conditions are as follows.

The support was destaticized with ion air before coating, and coating was carried out at a speed of 160 m/min. With respect to the coating and drying conditions, each sample was adjusted in the following range and set to conditions under which the most stable surface properties were obtained.

A gap between the tip of the coating die and the support was 0.10 to 0.30 mm.

A pressure of a vacuum chamber was set at 196 to 882 Pa lower than atmospheric pressure.

In a next chilling zone, the coating liquid was cooled with air having a dry-bulb temperature of 10 to 20° C.

The sample was delivered in a non-contact manner and dried with dry air having a dry-bulb temperature of 23 to 45° C. and a wet-bulb temperature of 15 to 21° C. in a helical non-contact type drying unit.

After drying, the sample was air-conditioned at 25° C. and at a humidity of 40 to 60% RH.

Subsequently, the film surface was heated at 70 to 90° C., and after drying, the film surface was cooled to 25° C.

The matting degree of the thus prepared photothermographic material was 550 seconds in the image forming layer side and 130 seconds in the back surface, respectively in terms of Bekk smoothness. Also, the pH of the film surface in the image forming layer side was measured and found to be 6.0.

The chemical structures of the compounds used in the Example are shown below.

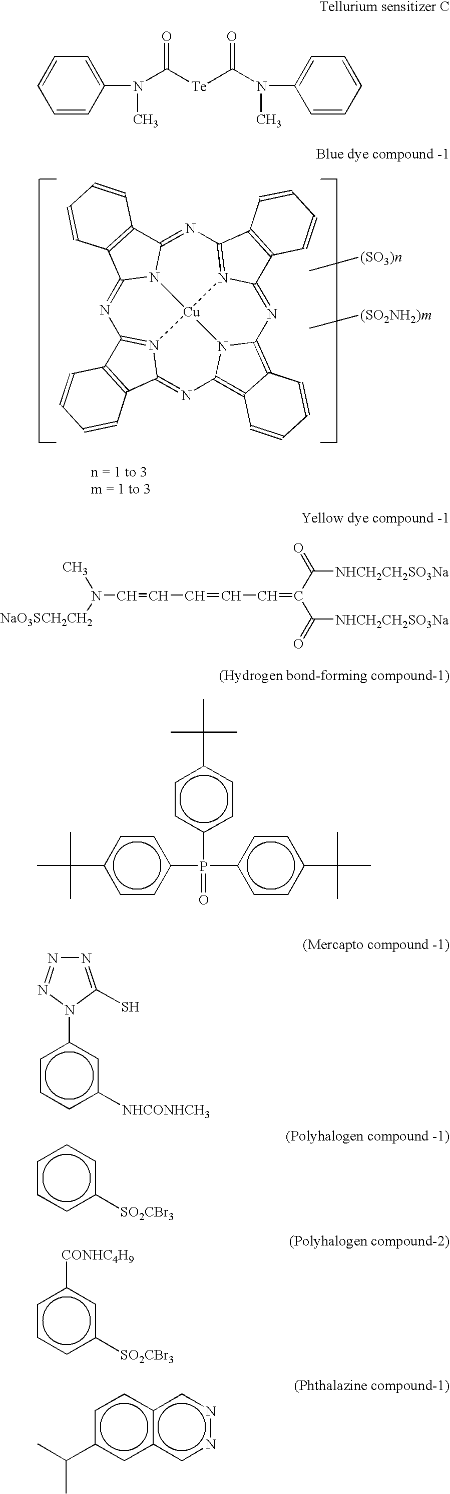

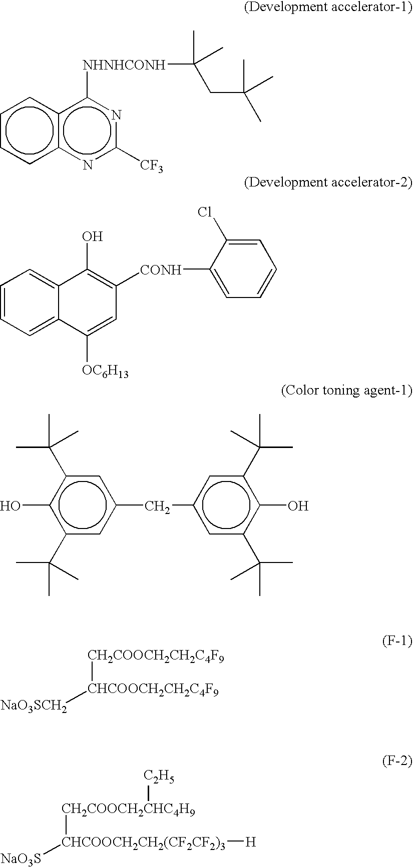

4. Evaluation:

(Evaluation of Photographic Performance)

The resulting sample was cut into a hangiri size (356 mm×432 mm), wrapped by a wrapping material in an environment at 25° C. and at 50% RH, stored at room temperature for 2 weeks, and then evaluated in the following manners.

(Wrapping Material)

PET 10 μm/PE 12 μm/aluminum foil 9 μm/Ny 15 μm/3% carbon-containing polyethylene 50 μm

Oxygen permeability: 0.02 mL/atm·m²·25° C.·day

Water permeability: 0.10 g/atm·m²·25° C.·day

The sample was exposed with NLHV3000E semiconductor laser of Nichia Chemical Industries, Ltd. mounted as a semiconductor laser source in an exposure section of FUJI MEDICAL DRY LASER IMAGER FM-DPL. At that time, the beam diameter was set to 100 μm, the intensity of illumination of the laser on the photosensitive material surface was set to 0 mW/mm² and also changed between 1 and 1,000 mW/mm², and the exposure time was 10⁻⁶ seconds. The laser had an oscillation wavelength of 405 nm. The heat development was carried out using four panel heaters set at 112° C.-118° C.-120° C.-120° C., respectively, and the delivery rate was expedited such that the total time was 14 seconds. The resulting image was evaluated using a densitometer.

(Sensitivity and Gradation)

The density of the resulting image was measured using a densitometer, and a characteristic curve of the density against a logarithm of the exposure amount was prepared. The optical density of an unexposed area was defined as fog, and an inverse of the exposure amount at which the optical density of 3.0 was obtained was defined as sensitivity. The sensitivity was expressed as a relative value while taking the sensitivity of the photosensitive material 1 as 100.

An average contrast of the optical density of 2 and the optical density of 0.25 was calculated according to the following gamma.

$$\begin{matrix}Gamma = [ ( optical density of 2.0 ) - ( optical density of 0.25 ) ] / \\ \{ logarithm [ ( fog density ) + ( exposure amount giving \\ an optical density of 2.0 ) ] - logarithm [ ( fog density ) + \\ ( exposure amount giving an optical density of 0.25 ) ] \}\end{matrix}$$

(Test of Photothermographic Image Storability)

After heat development, the sample was exposed with 1,000 lux under a fluorescent lamp in an environment at 25° C. and at 60% RH. After standing for one week, the Dmin change was measured. The sample in which the Dmin change is small is a sample excellent in photothermographic image storability.

(Fresh Color Tone)

With respect to the sample immediately after heat development, the image color tone was evaluated. It is preferable that the silver image is of a pure black tone. Organoleptic evaluation was carried out in such a manner that a sample that becomes yellowish is given a minus point, whereas a sample that becomes bluish is given a plus point. The evaluation point was given as follows. It is preferable that the evaluation point is 0 point, whereas it is not preferable from the standpoint of fresh color tone that the evaluation point is far from the 0 point.

| | |
|---|---|
| +2 point: | Considerably bluish |
| +1 point: | Slightly bluish |
| 0 point: | Good balance in color tone, and pure black tone |
| −1 point: | Slightly yellowish |
| −2 point: | Considerably yellowish |

The results are shown in Table 1.

TABLE 1

| | | | | | Organic | Organic | | | | | | |
|---|---|---|---|---|---|---|---|---|---|---|---|---|
| | Reducing | | Reducing | | polyhalogen | polyhalogen | | | | | | |
| | agent-1 | | agent-2 | | compound-1 | compound-2 | Fresh photographic performance | | | | Photothermographic | |
| Experiment | | Amount | | Amount | Amount | Amount | | Sensi- | Grada- | Color | storability | |
| No. | Kind | (mole/m²) | Kind | (mole/m²) | (mole/m²) | (mole/m²) | Dmin | tivity | tion | tone | ΔDmin | Remarks |
| 1 | 1-9 | 2.0 × 10⁻³ | — | — | 3.8 × 10⁻⁴ | 5.8 × 10⁻⁴ | 0.16 | 100 | 2.8 | 0 | 0.00 | Invention |
| 2 | 3-3 | 2.0 × 10⁻³ | — | — | 3.8 × 10⁻⁴ | 5.8 × 10⁻⁴ | 0.16 | 98 | 2.8 | +2 | 0.00 | Comparison |
| 3 | 3-1 | 2.0 × 10⁻³ | — | — | 3.8 × 10⁻⁴ | 5.8 × 10⁻⁴ | 0.16 | 97 | 2.8 | +2 | 0.00 | Comparison |
| 4 | 1-9 | 2.0 × 10⁻³ | — | — | 1.9 × 10⁻⁴ | 2.9 × 10⁻⁴ | 0.16 | 115 | 3.2 | +1 | 0.00 | Invention |
| 5 | 1-9 | 1.0 × 10⁻³ | 3-3 | 1.0 × 10⁻³ | 1.9 × 10⁻⁴ | 2.9 × 10⁻⁴ | 0.16 | 113 | 2.8 | 0 | 0.00 | Invention |
| 6 | 1-9 | 1.0 × 10⁻³ | 2-3 | 1.0 × 10⁻³ | 1.9 × 10⁻⁴ | 2.9 × 10⁻⁴ | 0.16 | 115 | 2.8 | 0 | 0.00 | Invention |
| 7 | 1-1 | 2.0 × 10⁻³ | — | — | 3.8 × 10⁻⁴ | 5.8 × 10⁻⁴ | 0.16 | 103 | 2.8 | 0 | 0.00 | Invention |
| 8 | 1-1 | 1.0 × 10⁻³ | 3-3 | 1.0 × 10⁻³ | 1.9 × 10⁻⁴ | 2.9 × 10⁻⁴ | 0.16 | 116 | 2.8 | 0 | 0.00 | Invention |
| 9 | 1-1 | 1.0 × 10⁻³ | 2-3 | 1.0 × 10⁻³ | 1.9 × 10⁻⁴ | 2.9 × 10⁻⁴ | 0.16 | 115 | 2.8 | 0 | 0.00 | Invention |
| 10 | 3-3 | 2.0 × 10⁻³ | — | — | — | — | 0.85 | — | — | — | — | Comparison |
| 11 | 1-9 | 2.0 × 10⁻³ | — | — | — | — | 0.98 | — | — | — | — | Comparison |

The samples of the invention were practically good in color tone and excellent in image storability.

Hitherto, when a high silver iodide emulsion is used as the photosensitive silver halide, it was difficult to adjust the image color tone because of strong development retardation. However, by using the reducing agent of the invention, a preferred neutral silver color tone could be obtained. It was an unexpected effect that the silver color tone could be adjusted in silver iodide systems by selecting the reducing agent in such manner. Further, by jointly using the selected reducing agent of the invention, it was found that even by reducing the quantity of the polyhalogen, a preferred silver color tone could be obtained, and high sensitivity could be attained.

### Example 2

1. Preparation of PET Support and Undercoating:

The film formation, surface corona treatment and undercoating were carried out in the same manners as in Example 1.

2. Back Layer:

The preparation of a coating liquid for back layer and coating of the back layer were carried out in the same manners as in Example 1.

3. Image Forming Layer, Intermediate Layer and Surface Protective Layer:

3-1. Preparation of Coating Material:

1) Preparation of Silver Halide Emulsion:

The preparation of a silver halide emulsion 1, the preparation of a silver halide emulsion 2, the preparation of a silver halide emulsion 3, and the preparation of a mixed emulsion A for coating liquid were carried out in the same manners as in Example 1.

2) Preparation of Fatty Acid Silver Dispersion:

The preparation of recrystallized silver behenate and the preparation of a fatty acid silver dispersion were carried out in the same manners as in Example 1.

3) Preparation of Reducing Agent Dispersion:

The preparation of a reducing agent dispersion was carried out in the same manner as in Example 1.

4) Preparation of Hydrogen Bond-Forming Compound Dispersion:

The preparation of a hydrogen bond-forming compound dispersion was carried out in the same manner as in Example 1.

5) Preparation of Development Accelerator Dispersion and color toning Agent dispersion:

The preparation of a development accelerator-1 dispersion and the preparation of solid dispersions of a development accelerator-2 and a color toning agent-1 were carried out in the same manners as in Example 1.

6) Preparation of Polyhalogen Compound Dispersion:

The preparation of an organic polyhalogen compound-1 dispersion and the preparation of an organic polyhalogen compound-2 dispersion were carried out in the same manners as in Example 1.

7) Preparation of Phthalazine Compound Solution:

The preparation of a phthalazine compound solution was carried out in the same manner as in Example 1.

8) Preparation of Mercapto Compound-1:

The preparation of a mercapto compound-1 was carried out in the same manner as in Example 1.

9) Preparation of Pigment-1 Dispersion:

The preparation of a pigment-1 dispersion was carried out in the same manner as in Example 1.

10) Preparation of SBR Latex Liquid:

The preparation of an SBR latex liquid was carried out in the same manner as in Example 1.

3-2. Preparation of Coating Liquid:

1) Preparation of Coating Liquid For Image Forming Layer:

To 1,000 g of the above-obtained fatty acid silver dispersion and 276 mL of water, the pigment-1 dispersion, the organic polyhalogen compound-1 dispersion (the amount of which is described in Table 2), the organic polyhalogen compound-2 dispersion (the amount of which is described in Table 2), the phthalazine compound-1 solution, the SBR latex (Tg: 17° C.) liquid, the reducing agent dispersion (the amount and kind of which are described in Table 2), the hydrogen bond-forming compound-1 dispersion, the development acclerator-1 dispersion, the development accelerator-2 dispersion, the color toning agent-1 dispersion, and the mercapto compound-1 aqueous solution were successively added. Immediately before coating, the silver halide mixed emulsion A was added, and the mixture was well mixed. The thus obtained coating liquid for image forming layer was delivered into a coating die as it was and then coated.

The viscosity of the coating liquid for image forming layer of the photographic material used in Experiment No. 1 in Table 2 was measured by a B type viscometer of TOKIMEC INC. and found to be 28 [mPa·s] at 40° C. (No. 1 rotor at 60 rpm).

The viscosity of the coating liquid as measured at 25° C. using an RFS fluid spectrometer manufactured by Rheometrics Fareast Ltd. was 242, 63, 48, 28 and 21 [mPa.s] at a shear rate of 0.1, 1, 10, 100 and 1,000 [1/sec], respectively.

The zirconium amount in the coating liquid was 0.38 mg per gram of silver.

2) Preparation of Coating Liquid for Intermediate Layer:

To 1,000 g of polyvinyl alcohol PVA-205 (manufactured by Kuraray Co., Ltd.), 272 g of the pigment-1 dispersion, and 4,200 mL of a 19% by mass liquid of a methyl methacrylate/styrene/butyl acrylate/hydroxyethyl methacrylate/acrylic acid copolymer (copolymerization weight ratio: 64/9/20/5/2) latex, 27 mL of an aqueous solution containing AEROSOL OT (manufactured by American Cyanamid Company) in an amount of 5% by mass, 135 mL of an aqueous solution containing diammonium phthalate salt in an amount of 20% by mass, and water were added such that the total amount became 10,000 g. The pH of the mixture was adjusted at 7.5 with NaOH to prepare a coating liquid for intermediate layer, which was then delivered in an amount of 9.1 mL/m² into a coating die.

The viscosity of the coating liquid of the photographic material used in Experiment No. 1 in Table 2 was measured by a B type viscometer and found to be 62 [mPa·s] at 40° C. (No. 1 rotor at 60 rpm).

3) Preparation of Coating Liquid for First Layer of Surface Protective Layer:

Sixty-four grams of inert gelatin was dissolved in water, to which were then added 112 g of a 19.0% by mass liquid of a methyl meth-acrylate/styrene/butyl acrylate/hydroxyethyl methacrylate/acrylic acid copolymer (copolymerization weight ratio: 64/9/20/5/2) latex, 30 mL of a 15% by mass methanol solution of phthalic acid, 23 mL of an aqueous solution containing 4-methylphthalic acid in an amount of 10% by mass, 28 mL of sulfuric acid having a concentration of 0.5 moles/L, 5 mL of an aqueous solution containing AEROSOL OT (manufactured by American Cyanamid Company) in an amount of 5% by mass, 0.5 g of phenoxyethanol, and 0.1 g of benzisothiazolinone, and water was further added to make the total amount to 750 g, thereby preparing a coating liquid. Immediately before coating, the coating liquid was mixed with 26 mL of 4% by mass chromium alum by a static mixer and then delivered in an amount of 18.6 mL/m² into a coating die.

The viscosity of the coating liquid of the photographic material used in Experiment No. 1 in Table 2 was measured by a B type viscometer and found to be 22 [mPa·s] at 40° C. (No. 1 rotor at 60 rpm).

4) Preparation of Coating Liquid for Second Layer of Surface Protective Layer:

Eighty grams of inert gelatin was dissolved in water, to which were then added 102 g of a 27.5% by mass liquid of a methyl methacrylate/styrene/butyl acrylate/hydroxyethyl methacrylate/acrylic acid copolymer (copolymerization weight ratio: 64/9/20/5/2) latex, 5.4 mL of a 2% by mass solution of a fluorine based surfactant (F-1), 5.4 mL of a 2% by mass aqueous solution of a fluorine based surfactant (F-2), 23 mL of an aqueous solution containing AEROSOL OT (manufactured by American Cyanamid Company) in an amount of 5% by mass, 4 g of polymethyl methacrylate fine grains (mean grain size: 0.7 μm), 21 g of polymethyl methacrylate fine grains (mean grain size: 4.5 μm), 1.6 g of 4-methylphthalic acid, 4.8 g of phthalic acid, 44 mL of sulfuric acid having a concentration of 0.5 moles/L, and 10 mg of benzoisothiazolinone, and water was further added to make the total amount to 650 g. Immediately before coating, the mixture was mixed with 445 mL of an aqueous solution containing 4% by mass chromium alum and 0.67% by mass phthalic acid by a static mixer to prepare a coating liquid for surface protective layer, which was then delivered in an amount of 8.3 mL/m² into a coating die.

The viscosity of the coating liquid of the photographic material used in Experiment No. 1 in Table 2 was measured by a B type viscometer and found to be 20 [mPa·s] at 40° C. (No. 1 rotor at 60 rpm).

3-3. Preparation of Photothermographic Material:

On the opposite surface to the back surface, an image forming layer, an intermediate layer, a first layer of surface protective layer, and a second layer of surface protective layer were subjected to simultaneous double-layer coating in that order from the undercoat layer in a slide bead coating mode. There was thus prepared a sample of photothermographic material. At that time, the temperature was controlled at 31° C. for the image forming layer and the intermediate layer, 36° C. for the first layer of surface protective layer, and 37° C. for the second layer of surface protective layer, respectively.

The coating amount (g/m²) of each of the compounds of the image forming layer is as follows.

| | |
|---|---|
| Silver Behenate: | 5.27 |
| Pigment (C.I. Pigment Blue 60): | 0.036 |
| Polyhalogen compound-1: | Amount set forth in Table 2 |
| Polyhalogen compound-2: | Amount set forth in Table 2 |
| Phthalazine compound-1: | 0.18 |
| SBR latex: | 9.43 |
| Reducing agent: | Amount and kind set forth in |
| | Table 2 |
| Hydrogen bond-forming compound-1: | 0.28 |
| Development accelerator-1: | 0.025 |
| Development accelerator-2: | 0.020 |
| Color toning agent-1: | 0.008 |
| Mercapto compound-1: | 0.006 |
| Silver halide (as Ag): | 0.046 |

The coating and drying conditions are as follows.

The support was destaticized with ion air before coating, and coating was carried out at a speed of 160 m/min. With respect to the coating and drying conditions, each sample was adjusted in the following range and set to conditions under which the most stable surface properties were obtained.

A gap between the tip of the coating die and the support was 0.10 to 0.30 mm.

A pressure of a vacuum chamber was set at 196 to 882 Pa lower than the atmospheric pressure.

In a next chilling zone, the coating liquid was cooled with air having a dry-bulb temperature of 10 to 20° C.

The sample was delivered in a non-contact manner and dried with dry air having a dry-bulb temperature of 23 to 45° C. and a wet-bulb temperature of 15 to 21° C. in a helical non-contact type drying unit.

After drying, the sample was air-conditioned at 25° C. and at a humidity of 40 to 60% RH.

Subsequently, the film surface was heated at 70 to 90° C., and after drying, the film surface was cooled to 25° C.

The matting degree of the thus prepared photothermographic material was 550 seconds in the image forming layer side and 130 seconds in the back surface, respectively in terms of Bekk smoothness. Also, the pH of the film surface in the image forming layer side was measured and found to be 6.0.

The chemical structures of the compounds used in Example 2 are the same as in Example 1.

4. Evaluation:

(Evaluation of Photographic Performance)

The resulting sample was cut into a hangiri size (356 mm×432 mm), wrapped by a wrapping material in an environment at 25° C. and at 50% RH, stored at room temperature for 2 weeks, and then evaluated in the following manners.

(Wrapping Material)

PET 10 μm/PE 12 μm/aluminum foil 9 μm/Ny 15 μm/3% carbon-containing polyethylene 50 μm

Oxygen permeability: 0.02 mL/atm·m²·25° C. day

Water permeability: 0.10 g/atm·m²·25° C.·day

The sample was exposed with NLHV3000E semiconductor laser of Nichia Chemical Industries, Ltd. mounted as a semiconductor laser source in an exposure section of FUJI MEDICAL DRY LASER IMAGER FM-DPL. At that time, the beam diameter was set to 100 μm, the intensity of illumination of the laser on the photosensitive material surface was set to 0 mW/mm² and also changed between 1 and 1,000 mW/mm², and the exposure time was 10⁻⁶ seconds. The laser had an oscillation wavelength of 405 nm. The heat development was carried out using four panel heaters set at 112° C.-118° C.-121° C.-121° C., respectively, and the delivery rate was expedited such that the total time was 12 seconds. The resulting image was evaluated using a densitometer.

(Sensitivity and Gradation)

The density of the resulting image was measured using a densitometer, and a characteristic curve of the density against a logarithm of the exposure amount was prepared. The optical density of an unexposed area was defined as fog, and an inverse of the exposure amount at which the optical density of 3.0 was obtained was defined as sensitivity. The sensitivity was expressed as a relative value while taking the sensitivity of the photosensitive material 1 as 100.

An average contrast of the optical density of 2 and the optical density of 0.25 was calculated according to the following gamma.

$$\begin{matrix}Gamma = [ ( optical density of 2.0 ) - ( optical density of 0.25 ) ] / \\ \{ logarithm [ ( fog density ) + ( exposure amount giving \\ an optical density of 2.0 ) ] - logarithm [ ( fog density ) + \\ ( exposure amount giving an optical density of 0.25 ) ] \}\end{matrix}$$

(Test of Unprocessed Stock Storability)

After storing the sample before exposure for 30 days in an environment at 40° C. and at 40% RH, a difference in fog density between the sample having been exposed and heat treated and the sample having been stored in a chilled state, exposed and heat treated was measured, the value of which was expressed in terms of ΔDmin. It is meant that the smaller the ΔDmin value, the more excellent the storage stability is.

(Test of Photothermographic Image Storability)

After heat development, the sample was exposed with 1,000 lux under a fluorescent lamp in an environment at 30° C. and at 70% RH. After standing for one week, the Dmin change was measured. The sample in which the Dmin change is small is a sample excellent in photothermographic image storability.

The results are shown in Table 2. The samples of the invention had gradation sufficient as an image for medical use, had high sensitivity and excellent image storability, and exhibited good unprocessed stock storability.

Hitherto, when a silver iodide emulsion is used as the photosensitive silver halide, it was difficult to keep good balance among practical sensitivity, gradation and storability because of strong development retardation. However, it is quite unexpected that by selecting a specific ratio of the polyhalogen compound of the invention to the selected reducing agent, the difficult problems in the silver iodide system can be solved. It has been obtained for the first time by elucidation of the special action and effects of silver iodide emulsions in photothermographic material and investigation the kinds and amounts of a number of materials.

TABLE 2

| | | | Organic | Organic | Molar | | | | | Un- | | |
|---|---|---|---|---|---|---|---|---|---|---|---|---|
| | | | polyhalogen | polyhalogen | ratio | | Fresh photographic | | | processed | Photo- | |
| Experi- | Reducing agent-1 | | compound-1 | compound-2 | of formula | α | performance | | | stock | thermographic | |
| ment | | Amount | Amount | Amount | (H)/ | com- | | Sensi- | Grada- | storability | storability | |
| No. | Kind | (mole/m²) | (mole/m²) | (mole/m²) | (R-1 or R-2) | pound | Dmin | tivity | tion | ΔDmin | ΔDmin | Remarks |
| 1 | 1-3 | 2.0 × 10⁻³ | 3.8 × 10⁻⁴ | 5.8 × 10⁻⁴ | 0.48 | 2 | 0.16 | 100 | 2.8 | 0.02 | 0.00 | Preferred |
| | | | | | | | | | | | | invention |
| 2 | 1-3 | 2.0 × 10⁻³ | 3.8 × 10⁻⁴ | 5.8 × 10⁻⁴ | 0.48 | — | 0.14 | 43 | 1.8 | 0.01 | 0.00 | Invention |
| 3 | 2-1 | 3.0 × 10⁻³ | 3.8 × 10⁻⁴ | 5.8 × 10⁻⁴ | 0.32 | 20 | 0.16 | 97 | 2.8 | 0.02 | 0.00 | Preferred |
| | | | | | | | | | | | | invention |
| 4 | 2-1 | 3.0 × 10⁻³ | 1.9 × 10⁻⁴ | 2.9 × 10⁻⁴ | 0.18 | 20 | 0.16 | 105 | 2.8 | 0.03 | 0.00 | Preferred |
| | | | | | | | | | | | | invention |
| 5 | 2-1 | 3.0 × 10⁻³ | 0.6 × 10⁻⁴ | 1.0 × 10⁻⁴ | 0.05 | 20 | 0.16 | 107 | 2.9 | 0.09 | 0.00 | Comparison |
| 6 | 1-3 | 2.0 × 10⁻³ | 0.6 × 10⁻⁴ | 1.0 × 10⁻⁴ | 0.08 | 2 | 0.16 | 107 | 2.9 | 0.15 | 0.00 | Comparison |
| 7 | 2-2 | 3.0 × 10⁻³ | 1.9 × 10⁻⁴ | 2.9 × 10⁻⁴ | 0.18 | 26 | 0.16 | 104 | 2.9 | 0.01 | 0.00 | Preferred |
| | | | | | | | | | | | | invention |
| 8 | 2-2 | 1.0 × 10⁻³ | 0.6 × 10⁻⁴ | 1.0 × 10⁻⁴ | 0.05 | 26 | 0.16 | 106 | 2.9 | 0.1 | 0.00 | Comparison |
| 9 | 1-9 | 2.0 × 10⁻³ | 1.9 × 10⁻⁴ | 2.9 × 10⁻⁴ | 0.24 | 2 | 0.16 | 103 | 2.8 | 0.02 | 0.00 | Preferred |
| | | | | | | | | | | | | invention |

α compound: Compound in which a one electron oxidant formed upon one electron oxidation can further release one or more electrons (amount: 2 × 10⁻³ moles per silver halide)

According to the invention, a photothermographic material that is suitable for application to medical image and from which an image having high sensitivity and excellent gradation and color tone is obtained upon exposure with laser light of 350 nm to 450 nm and heat development is provided.

What is claimed is:

1. A photothermographic material comprising a photosensitive silver halide, a non-photosensitive organic silver salt, a reducing agent, and a binder on at least one surface of a support, wherein silver iodide is contained in the photosensitive silver halide in an amount of 40% to 100% by mole, and the reducing agent contains a compound represented by the following formula (R-1): 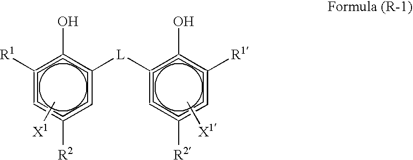
wherein R¹ and R¹ each independently represent an alkyl group having 3 to 20 carbon atoms, in which a carbon atom bonding to the benzene ring is secondary or tertiary; R² and R^{2′} each represent a methyl group; L represents an —S— group or a —CHR³— group, in which R³ represents a hydrogen atom or an alkyl group having 1 to 20 carbon atoms; and X¹ and X^{1′} each independently represent a hydrogen atom or a group capable of being substituted on the benzene ring.

2. The photothermographic material of claim 1, further comprising a compound represented by the following formula (H):
Q-(Y)ₙ—C(Z₁)(Z₂)X Formula (H)
wherin Q represents an alkyl group, an aryl group, or a heterocyclic group;
Y represents a divalent connecting group; n represents 0 or 1; Z₁ and Z₂ each represent a halogen atom; and X represents a hydrogen atom or an electron withdrawing group.

3. The photothermographic material of claim 1, wherein the silver iodide is contained in the photosensitive silver halide in an amount of 90% to 100% by mole.

4. The photothermographic material of claim 1, wherein the photosensitive silver halide has a mean grain size of 5 nm to 80 nm.

5. The photothermographic material of claim 1, wherein the photosensitive silver halide has a mean grain size of 5 nm to 40 nm.

6. The photothermographic material of claim 1, wherein the reducing agent further contains a compound represented by the following formula (R-2): 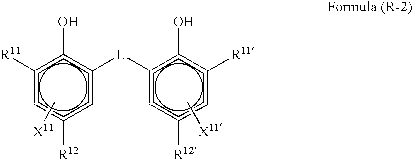
wherein R¹¹ and R^{11′} each independently represent an alkyl group having 3 to 20 carbon atoms, in which a carbon atom bonding to the benzene ring is secondary or tertiary; R¹² and R^{12′} each independently represent an alkyl group having 2 to 20 carbon atoms; L represents an —S— group or a —CHR¹¹³-group, in which R¹³ represents a hydrogen atom or an alkyl group having 1 to 20 carbon atoms; and X¹¹ and X^{11′} each independently represent a hydrogen atom or a group capable of being substituted on the benzene ring.

7. The photothermographic material of claim 1, wherein the reducing agent further contains a compound represented by the following formula (R-3): 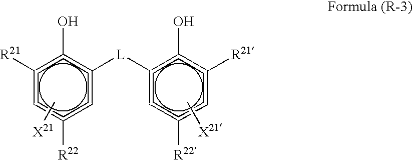
wherein R²¹ and R^{21′} each independently represent a methyl group or an alkyl group having 2 to 20 carbon atoms, in which a carbon atom bonding to the benzene ring is primary; R²² and R^{22′} each independently represent an alkyl group having 1 to 20 carbon atoms; L represents an —S— group or a —CHR²³— group, in which R²³ represents a hydrogen atom or an alkyl group having 1 to 20 carbon atoms; and X²¹ and X^{21′} each independently represent a hydrogen atom or a group capable of being substituted on the benzene ring.

8. The photothermographic material of claim 1, which is exposed with laser light.

9. The photothermographic material of claim 8, wherein the laser light has a light emission peak intensity in a range of 390 nm to 430 nm.

10. The photothermographic material of claim 1, wherein a characteristic curve of the photothermographic material has a gamma in a range of 2 to 5.

11. A photothermographic material comprising at least one photosensitive silver halide, a non-photosensitive organic silver salt, a reducing agent, and a binder on a surface of a support, wherein silver iodide is contained in the photosensitive silver halide in an amount of 40% to 100% by mole, the reducing agent contains a compound represented by the following formula (R-4), and a compound represented by the following formula (H) is contained in the photothermographic material with a molar ratio of the compound represented by formula (H) to the compound represented by formula (R-4) being 0.2 or greater:
Q-(Y)ₙ—C(Z₁)(Z₂)X Formula (H) 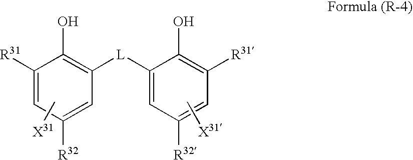
wherein, in formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group, and wherein, in formula (R-4), R³¹ and R^{31′} each independently represent an alkyl group having 1 to 20 carbon atoms; R³² and R^{32′} each independently represent an alkyl group having 2 to 20 carbon atoms; L represents an —S— group or a —CHR³³— group, in which R³³ represents a hydrogen atom or an alkyl group having 1 to 20 carbon atoms; and X³¹ and X^{31′} each independently represent a hydrogen atom or a group capable of being substituted on the benzene ring.

12. A photothermographic material comprising at least one photosensitive silver halide, a non-photosensitive organic silver salt, a reducing agent, and a binder on a surface of a support, wherein silver iodide is contained in the photosensitive silver halide in an amount of 40% to 100% by mole, the reducing agent contains a compound represented by the following formula (R-5), and a compound represented by the following formula (H) is contained in the photothermographic material with a molar ratio of the compound represented by formula (H) to the compound represented by formula (R-5) being 0.15 or greater:
Q-(Y)ₙ—C(Z₁)(Z₂)X Formula (H) 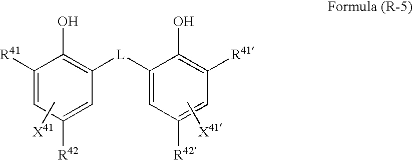
wherein, in formula (H), Q represents an alkyl group, an aryl group, or a heterocyclic group; Y represents a divalent connecting group; n represents 0 or 1; Z₁ and Z₂ each represent a halogen atom; and X represents a hydrogen atom or an electron withdrawing group, and wherein, in formula (R-5), R⁴¹ and R^{41′} each independently represent a methyl group or an alkyl group having 2 to 20 carbon atoms, in which a carbon atom bonding to the benzene ring is primary; R⁴² and R^{42′} each independently represent a hydrogen atom or a group capable of being substituted on the benzene ring; L represents an —S— group or a —CHR⁴³-group, in which R⁴³ represents a hydrogen atom or an alkyl group having 1 to 20 carbon atoms; and X⁴¹ and X^{41′} each independently represent a hydrogen atom or a group capable of being substituted on the benzene ring.

13. The photothermographic material of claim 11, wherein in formula (R-4), R³¹ and R^{31′} each represent a secondary or tertiary alkyl group having 3 to 15 carbon atoms.

14. The photothermographic material of claim 12, wherein in formula (H), Q represents a heterocyclic group containing a nitrogen atom as a ring-constituting atom and not containing a sulfur atom.

15. The photothermographic material of claim 11, wherein an average content of the silver iodide in the photosensitive silver halide is 90% to 100% by mole.

16. The photothermographic material of claim 11, further comprising a development accelerator.

17. The photothermographic material of claim 11, which is exposed with light having a peak intensity in a range of 350 nm to 450 nm at an intensity of illumination of 1 mW/mm² or more.

18. The photothermographic material of claim 11, which is exposed by a semiconductor laser having a light emission peak intensity in a range of 390 nm to 430 nm.

19. The photothermographic material of claim 11, wherein a characteristic curve of the photothermographic material has a gamma in a range of 2 to 5.
